(19) United States
(12) Patent Application Publication
(10) Pub. No.: US 2015/0257383 A1
(43) Pub. Date: Sep. 17, 2015

(54) METHOD FOR COMBATING PHYTOPATHOGENIC HARMFUL MICROBES ON CULTIVATED PLANTS OR PLANT PROPAGATION MATERIAL

(71) Applicant: BASF SE, Ludwigshafen (DE)

(72) Inventors: Ted Deisenroth, Brookfield, CT (US); Markus Pompejus, White Plains, NY (US); Sam Anas, Cary, NC (US); Zhiqiang Song, Newtown, CT (US); Jurith Montag, Ludwigshafen (DE); Erica May Wilson Lauterwasser, Mannheim (DE); Bernd Mueller, Frankenthal (DE); Richard Riggs, Mannheim (DE); Claudia Rosenbaum, Einhausen (DE); Isabella Siepe, Dossenheim (DE); Rupert Konradi, Ladenburg (DE); Jean-Pierre Berkan Lindner, Mannheim (DE)

(21) Appl. No.: 14/434,565

(22) PCT Filed: Oct. 2, 2013
(86) PCT No.: PCT/EP2013/070565

§ 371 Date: Apr. 9, 2015

Related U.S. Application Data
(60) Provisional application No. 61/712,847, filed on Oct. 12, 2012.

(30) Foreign Application Priority Data
Oct. 25, 2012 (EP) 12189862.1

(51) Int. Cl. A01N 37/12

(52) U.S. Cl. CPC A01N 37/12

(57) ABSTRACT

The present invention relates to a method for combating phytopathogenic harmful microbes on cultivated plants or plant propagation material comprising applying an oligomer formed by polymerizing aminoalkyl (meth)acrylate or aminoalkyl (meth)acrylamide monomers or its agrochemically acceptable salts. According to another aspect the present invention relates to a post-harvest treatment method for the suppression of biological infestation in harvested produce comprising applying an oligomer according to the invention to the harvested produce.

The present invention also relates to mixtures comprising, as active components an oligomer according to the invention and at least one further pesticide as well as compositions comprising said mixtures. The invention furthermore relates to a method for controlling phytopathogenic harmful fungi using mixtures or compositions of an oligomer according to the invention and at least one pesticide II and to the use of an oligomer according to the invention and pesticides II for preparing such mixtures, and to compositions comprising these mixtures and seed comprising these mixtures or coated with this mixture.

The present invention relates to a method for combating phytopathogenic harmful microbes on cultivated plants or plant propagation material comprising applying an oligomer formed by polymerizing aminoalkyl (meth)acrylate or aminoalkyl (meth)acrylamide monomers or its agrochemically acceptable salts. The present invention also relates to the use of such an oligomer for combating phytopathogenic harmful microbes on cultivated plants or plant propagation material. In addition the invention relates to an agrochemical composition comprising such oligomer for combating phytopathogenic microbes on cultivated plants. According to another aspect the present invention relates to a post-harvest treatment method for the suppression of biological infestation in harvested produce comprising applying an oligomer according to the invention to the harvested produce. Moreover, the invention relates also to a use of the postharvest treatment methods defined herein to lengthen the post-harvest shelf-life of the stored harvested produce.

The present invention also relates to mixtures comprising, as active components an oligomer according to the invention and at least one further pesticide as well as compositions comprising said mixtures. The invention furthermore relates to a method for controlling phytopathogenic harmful fungi using mixtures or compositions of an oligomer according to the invention and at least one pesticide II and to the use of an oligomer according to the invention and pesticides II for preparing such mixtures, and to compositions comprising these mixtures and seed comprising these mixtures or coated with this mixture.

U.S. Pat. No. 6,096,800 A relates to a process for the preparation of antimicrobial plastics. The use of water-soluble aminoalkyl (meth)acrylates or aminoalkyl (meth)acrylamides as biocides is described in WO 02/017724 A1, which relates to depot formulations, and in WO 02/017725 A1 describing antimicrobial oligomers and polymer formulations thereof. The subject-matter in both documents is based on the allegation that the claimed oligomers are water-soluble and thus confer a microbicidal depot efficacy in a conterminal solution. Neither document provides evidence of the formation of said aminoalkyl (meth)acrylates or aminoalkyl (meth)acrylamides or information as to the nature of the water-soluble oligomers obtained according to the described process of preparation.

However, experimental data presented herein demonstrate, that the water-soluble and antimicrobially active components contained in polymers, which were obtained following the process of preparation as described in said documents, have a different chemical constitution with different physical properties when compared with the oligomers that are the subject-matter of this invention.

WO 05/018325 and WO 05/018326 describe a method for combating phytopathogenic diseases on plants using acrylic polymers. The working examples in this reference make use of commercially available AMINA T 100® and LIMAGO T 100®. It is known in the art that the molecular weight of these materials is in the range of 100.000 to 500.000 g/mol (B. Kossmann et al., Sustainable Chemistry—Integrated Management of Chemicals, Products and Processes, Workshop 27.-29.01.2004, Dessau, Germany). EP 331528 A1 relates to copolymers comprising 40 to 95% by weight of ethylene and 5 to 60% by weight of dialkylaminoalkylacrylamide which are active against phytopathogenic microorganisms.

DE 102009047589 A1 describes antimicrobial coatings on the basis of polyvinylacetals comprising acrylic or methacrylic polymers. WO 2005/104845 describes hydrophilic coatings of a water-swellable hydrophilic matrix and an anti-microbial polymer which may be formed by polymerizing aminoalkyl (meth)acrylate or aminoalkyl (meth)acrylamide monomers. These coatings find use in the application with substrates such as medical devices.

U.S. Pat. No. 6,790,910 relates to antimicrobial additives which are prepared by polymerizing aminoalkyl (meth)acrylate or aminoalkyl (meth)acrylamide monomers. These antimicrobilas are used for producing hygiene items or items for medical technology.

The method according to the present invention differs from the abovementioned references inasmuch as it relates to oligomers that have a considerably lower average molecular weight and in that the oligomers have a molecular weight polydispersity index of 1.0 to 3.0. There is no mentioning in the prior art about a method comprising applying such oligomers or agrochemical compositions comprising them on cultivated plants or plant propagation material.

In many cases, in particular at low application rates, the microbicidal activity of the known polymeric acrylates and acrylamides is unsatisfactory. Based on this, it was an object of the present invention to provide material having improved activity and/or a broader activity spectrum against phytopathogenic harmful microbes on cultivated plants while at the same time providing material which is not water-soluble to minimize the leaching potential of the oligomer in agro-ecosystems.

This object is achieved by using oligomers formed by polymerizing aminoalkyl (meth)acrylate or aminoalkyl (meth)acrylamide monomer(s) as defined herein, having improved activity against plant diseases caused by phytopathogenic harmful microbes. The oligomers according to the invention are not water-soluble.

Accordingly, the present invention relates to a method for combating phytopathogenic harmful microbes on cultivated plants or plant propagation material comprising applying an oligomer formed from a monomer of formula I

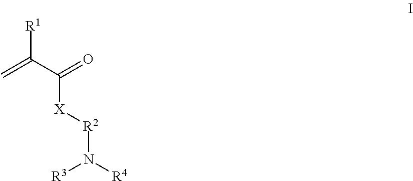

wherein

### R¹ is H or CH₃,

R² is a divalent C₁-C₅ alkylene group,
X is a divalent radical of —O—, —NH— or —NR⁵, wherein R⁵ is C₁-C₆-alkyl,
R³ and R⁴ independently of each other are H or C₁-C₅ alkyl radical which can be linear or branched,
or its agrochemically acceptable salts, wherein the oligomer has a weight average molecular weight (M_{w}) of 400 to 20,000 g/mole and a number average molecular weight (Mₙ) from 400 to 10,000 g/mole, molecular weight being determined according to gel permeation chromatography calibrated with poly methyl methacrylate narrow molecular weight standards, characterized in that the oligomer has a molecular weight polydispersity index of 1.0 to 3.0.

Another aspect of the present invention is that the oligomer formed from a monomer of formula I is not water-soluble.

Another aspect of the present invention is the use of an oligomer according to the invention for combating phytopathogenic harmful microbes on cultivated plants or plant propagation material.

The invention also relates to a method for improving plant health comprising applying an effective amount of an oligomer or an agrochemical compositions thereof according to the invention to a cultivated plant or its propagation material.

Suitable alkylaminoalkyl (meth)acrylate and alkylaminoalkyl (meth)acrylamide monomers are represented by general formula I. As regards the microbicidal activity of the oligomers formed from a monomer of formula I, preference is given to those wherein the substituents and variables (e.g. R¹, R², R³, R⁴ and X) have independently of each other or more preferably in combination the following meanings:

A preferred embodiment of the invention relates to oligomers of formula I wherein R¹ is CH₃.

Another preferred embodiment of the invention relates to oligomers of formula I wherein R¹ is H.

A preferred embodiment of the invention relates to oligomers formed from a monomer of formula I wherein R² is a divalent C₁-C₃-alkylene group.

A preferred embodiment of the invention relates to oligomers of formula I wherein R² is —CH₂—.

A preferred embodiment of the invention relates to oligomers formed from a monomer of formula I wherein R² is —CH₂CH₂—.

A preferred embodiment of the invention relates to oligomers formed from a monomer of formula I wherein R² is —CH₂CH₂CH₂—.

A preferred embodiment of the invention relates to oligomers formed from a monomer of formula I wherein X is —O—.

A preferred embodiment of the invention relates to oligomers formed from a monomer of formula I wherein X is —NH—.

A preferred embodiment of the invention relates to oligomers formed from a monomer of formula I wherein X is —NCH₃—.

A preferred embodiment of the invention relates to oligomers formed from a monomer of formula I wherein NR³R⁴ is tert-butylamino, dimethylamino or diethylamino.

A preferred embodiment of the invention relates to oligomers formed from a monomer of formula I wherein NR³R⁴ is tert-butylamino.

Preferred monomers of formula I are

2-tert-butylaminoethyl (meth)acrylate (I.1) (tBAEMA),
2-dimethylaminoethyl (meth)acrylate (I.2),
2-diethylaminoethyl (meth)acrylate (I.3),
3-dimethylaminopropyl (meth)acrylate (I.4),
N-3-dimethylaminopropyl(meth)acrylamide (I.5),
N-3-diethylaminopropyl (meth)acrylamide (I.6).

The oligomers are formed from a monomer meeting the description of formula I only or are formed from additional monomers to form a co-oligomer. For example, the oligomer is formed from one or more monomers of formula I selected from the group consisting of tert-butylaminoethyl (meth)acrylate (tBAEMA), 2-dimethylaminoethyl (meth)acrylate, 2-diethylaminoethyl (meth)acrylate, 3-dimethylaminopropyl (meth)acrylate, N-3-dimethylaminopropyl (meth)acrylamide, and N-3-diethylaminopropyl (meth)acrylamide.

Alternatively, the oligomer is formed from the monomers of formula I and additional monomers not meeting the definition of formula I.

However, preferably the oligomer is formed only from monomers meeting the definition of formula I. While the oligomer can be a co-oligomer it is preferable that the oligomer is a homo-oligomer.

The most preferred oligomers of the present invention are obtained from t-butylaminoethyl methacrylate (tBAEMA) and are represented by formula II,

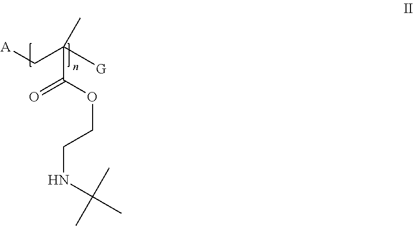

where n represents the degree of polymerization. According to the invention n is from 2 to 100, and A and G are residual groups derived from initiator and optionally a chain transfer agent used in polymerization. Preferably n is from 5 to 60, and most preferably from 10 to 40.

According to one embodiment of the invention it is most preferable that the oligomer is a homo-oligomer and formed from tBAEMA (I.1) only.

Preferably, A and G are initiator radicals. The initiator radicals are derived from free radical initiators such as well known azo initiators or peroxide initiators.

A and G are typically derived from an alkyl halide initiator used for atom transfer radical polymerization (ATRP) polymerization. In the case of ATRP, A may be an alkyl 2-isobutyrate radical and G a halide which can be obtained by using an alkyl 2-haloisobutyrate ATRP initiator. Most especially in the case of ATRP, G is a bromide or an iodide, which presumably contribute to enhance antimicrobial activity of the oligomers of the present invention.

The weight contribution of A and G will normally be higher than typical medium and high molecular weight polymers of formula II as high concentrations of initiators favor low molecular weight polymers. Thus the oligomers of formula II will on the average be shorter chains with A+G (the terminating groups formed from the initiator) making a larger weight percent contribution to the oligomer.

The molar contribution of A+G can be expressed as a ratio of A+G to degree of polymerization n of the monomer or as mole percent of the oligomer. As the degree of polymerization decreases the molar percent contribution of A+G increase.

For example, if the degree of polymerization of the oligomer ranges from n=2 to 100, then the molar contribution of A+G will range from 1:2 to 1:100. For n ranging from 5 to 60, then the molar contribution of A+G will range from 1:5 to 1:60. For n ranging from 10 to 40, the molar contribution of A+G will range from 1:10 to 1:40.

Accordingly the mole % of A+G based on the total moles of initiator terminal groups and moles of monomer units (degree of polymerization n) for n=2 to 100, n=5 to 60 and n=10 to 40 would range from about 1 to about 30, preferably about 1.5 to about 17, most preferably about 2.4 to about 9 mole percent respectively.

Alternatively this could be expressed in weight percent contribution of the A and G residual groups. This of course will depend on the molecular weight of A and G however the weight contribution of the A and G residual groups would normally range from about 0.5 to about 40 wt. %, preferably about 0.5 to about 35 wt. %, most preferably about 0.5 to about 5 wt. %.

Thus the oligomer of formula II according to the invention is preferably defined as

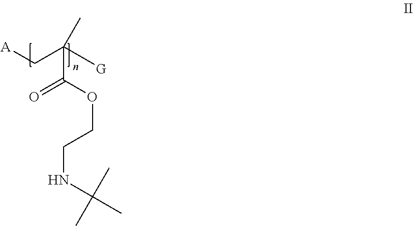

where n is from 2 to 100, preferably n is from 5 to 60, and most preferably from 10 to 40 and A and G are residual groups derived from an initiator and optionally a chain transfer agent used in polymerization, wherein the mole percent of A+G ranges from about 1 to about 30, preferably about 1.5 to about 17, most preferably about 2.4 to about 9 mole percent based on the total moles of A+G and monomer units.

According to one aspect of the invention the molecular weights of oligomers formed from formula I or those represented by formula II are measured by gel permeation chromatography (GPC) using poly(methyl methacrylate) narrow molecular weight standards as described herein. The oligomers according to the invention have a weight average molecular weight (M_{w}) ranging from 400 to 20,000 g/mole, preferably from 1,000 to 10,000 g/mole, more preferably from 2,000 to 8,000 g/mole.

In another aspect the weight average molecular weight (M_{w}) of the oligomers according to the invention ranges from 400 to 20,000 g/mole and a number average molecular weight (Mₙ) from 400 to 10,000 g/mole.

In a further aspect the weight average molecular weight (M_{w}) of the oligomers according to the invention ranges from 400 to 15,000 g/mole and a number average molecular weight (Mₙ) from 400 to 15,000 g/mole.

In still another aspect of the invention the weight average molecular weight (M_{w}) of the oligomers according to the invention ranges from 400 to 10,000 g/mole and a number average molecular weight (Mₙ) from 400 to 10,000 g/mole.

The oligomers formed from monomers of formula I or oligomers of formula II according to the invention preferably have a narrow molecular weight distribution with a polydispersity index (PDI=M_{w}/Mₙ) of 1.0 to 3.0.

More preferably, the oligomers formed from monomers of formula I or oligomers of formula II according to the invention have M_{w} ranging from 1,000 to 10,000 with a PDI ranging from 1.0 to 2.0.

Most preferably, the oligomers formed from monomers of formula I or oligomers of formula II according to the invention have M_{w} ranging from 2,000 to 8,000 with a PDI ranging from 1.0 to 2.0.

According to the invention the oligomers formed from monomers of formula I are not water-soluble. In a preferred embodiment the oligomers have a water-solubility of less than 0.1 ug/L. In another preferred embodiment the oligomers have a water-solubility of less than 0.05 ug/L. In still a further preferred embodiment the oligomers have a water-solubility of less than 0.01 ug/L.

The oligomers formed from monomers of formula I or oligomers of formula II according to the invention may have virtually any architecture, that is they may be grafted, linear, block, star, hyperbranched, random and brush architecture. Preferably, the architecture of formula I is linear or block.

The oligomers according to the invention can be present in different crystal modifications whose biological activity may differ. They are likewise subject matter of the present invention.

The microbicidal oligomers are made by polymerizing an alkylaminoalkyl (meth)acrylate or an alkylaminoalkyl (meth)acrylamide monomer in a way to achieve low molecular weight.

The oligomers of the present invention can be prepared by conventional random radical polymerization, controlled radical polymerization (CRP), anionic polymerization and cationic polymerization with reaction conditions aimed for low molecular weight polymers. The preparation of the oligomers can be carried out using various polymerization techniques such as solution, emulsion, microemulsion, inverse emulsion, and/or bulk polymerizations, as well as other technologies that are available to those who are skilled in the art.

The free radical polymerization is preferably carried out in solution or in bulk using azo or peroxide compounds as radical initiator.

Molecular weights of polymers synthesized by radical polymerization, anionic polymerization and cationic polymerization can be controlled by varying reaction conditions such as initiator type and concentration, monomer concentration, reaction temperature, chain transfer agent type and concentration. Generally, high concentration of initiator, low concentration of monomer, high reaction temperature and addition of a chain transfer agent are used to achieve low molecular weights for the antifungal oligomers.

Conventional random radical polymerization provides a simple way to make the oligomers. The source of free radicals required to initiate the polymerization of the radically polymerizable monomers is a free radical initiator. The free radicals may be formed by thermal or photoinduced decomposition of the initiator or by a redox reaction with the initiator.

Typical free radical initiators include, but are not limited to, azo and peroxide compounds.

Typical azo initiators include azobis(isobutyronitrile) (AIBN), dimethyl 2,2′-azobisisobutyrate (MAIB), 1,1′-azobis(1-cylcohexanenitrile), 2,2′-azobis(2,4,4-trimethylpentane), and azobis-2,4-dimethylvaleronitrile, polymeric or oligomeric materials comprising azo, —N═N—, groups. Water soluble azo initiator may be used in emulsion polymerization and selected from the group consisting of 2,2-azobis-(N,N′-dimethylene-isobutyramidine)dihydrochloride, 2,2′-azobis-(2-amidinopropane)dihydrochloride, 4,4′-azobis-(4-cyanopentane-carboxylic acid); 2,2′-Azobis[2-(5-methyl-2-imidazolin-2-yl)propane]dihydrochloride; 2,2′-Azobis[N-(2-carboxyethyl)-2-methylpropionamidine]tetrahydrate; 2,2′-Azobis[2-(3,4,5,6-tetrahydropyrimidin-2-yl)propane]dihydrochloride; and 2,2′-Azobis(2-methyl-N-[2-(1-hydroxybuthyl)]propionamide.

Typical peroxide radical initiator may include acyl and diacyl peroxides, alkyl peroxides, dialkyl peroxydicarbonates, hydroperoxides such as tert.-butylhydroperoxide, peresters, and inorganic peroxides such as hydrogen peroxide, ammonium persulfate, potassium persulfate and sodium persulfate, benzoyl peroxide (BPO) or a peroxy acid such as peroxyacetic acid or peroxybenzoic acid. The redox initiator in combination with reducing agents is selected from the group consisting of, for example, an acyl peroxides with tertairyamine such as triethylamine, and tert.-butylhydroperoxide or persulfate with iron(II)-ammonium sulfate, ascorbic acid, sodium methyl sulfinate, disodium disulfite, sodium hydrogen sulfite, sodium phosphite, potassium phosphate, hydrogen phosphite, sodium hypophosphite or potassium hypophosphite.

Azo initiators such as AIBN is preferably used at high concentration from 1% to 20% based on monomer to achieve low molecular weight using radical polymerization to prepare the antifungal oligomers. Lower concentration of initiator may be used in combination with an effective chain transfer agent to obtain low molecular weight. Suitable chain transfer agents may include mercaptans such as dodecyl mercaptan, octyl mercaptan, hexyl mercaptan and ethanolmercaptan and halogen-containing compounds such as carbon tetrabromide.

Controlled living polymerization methods may be used for preparing the antimicrobial oligomers. Living polymerization techniques have been traditionally used for the synthesis of well-defined polymers where polymerization proceeds in the absence of irreversible chain transfer and chain termination, i.e. nearly ideally in anionic polymerization and less ideally in cationic polymerization. Anionic living polymerization is initiated by nucleophilic addition to the double bond of the monomer using an organo-metallic initiator such as an alkyl lithium or Grignard reagent. An alternative means of initiation is electron transfer which occurs when alkali metals or similar species are the initiators. Cationic polymerization, on the other hand, is initiated by electrophilic agents such as a protonic acid and a Lewis acid. Examples of Lewis acid initiators include AICl₃, SnCl4, BF₃, TiCl4, AgClO₄, and I₂ in combination with a co-initiator such as H₂O or an organic halogen compound.

Although most of the ionic living polymerization techniques are not tolerant towards primary and secondary amino functional groups in the monomers to be polymerized, anionic polymerization of t-butylaminoethyl methacrylate is possible because of its relatively low basicity. The low molecular weight antifungal tBAEMA oligomers of the present invention can be prepared by anionic polymerization method described in “Living anionic homo- and block copolymerization of 2-(tert-butylamino)ethyl methacrylate” by Serge Creutz, Philippe Teyssie and Robert Jerome, J. Polymer Science (part A), vol 35 (10), 1997, 2035-2040 using a monomer to initiator molar ratio of from 5 to 100. Preferred initiators are diphenylmethyllithium with lithium chloride. According to one preferred embodiment of the present invention the oligomers with low molecular weight which provide broad-spectrum antimicrobial activity are prepared using ionic living polymerization.

Controlled radical polymerizations are also suitable to prepare the antifungal oligomers. Controlled radical polymerization is provided by recent methods such as atom transfer radical polymerization (ATRP), nitroxide-mediated radical polymerization (NMP), reversible addition-fragmentation chain transfer polymerization (RAFT) and other related processes involving a degenerative transfer, such as macromolecular design via interchange of xanthates (hereinafter referred as MADIX).

According to one prefered embodiment of the present invention the oligomers with low molecular weight which provide broad-spectrum antimicrobial activity are prepared using atom transfer radical polymerization (ATRP).

ATRP is normally initiated by the redox reaction between an initiator comprising a transferable atom or group and catalyst comprising a transition metal complex in a lower oxidation state. The transferable atom or group (G) can be homolytically cleaved from the initiator by the catalyst, thereby oxidizing the catalyst to a high oxidation state and forming a radical thereby activating the initiator residual (A) for monomer addition. After the initiation, the ATRP process is mediated by the catalyst in a fast dynamic equilibrium between activating and deactivating the polymer chains via a similar homolytic atom or group transfer through the redox reaction.

Any transition metal complex capable of maintaining the dynamic equilibrium with the polymer chain may be used as the redox catalyst in ATRP. Suitable catalysts may be transition metal complexes of copper, ruthenium, iron, rhodium, nickel and palladium, molybdenum, and osmium. Preferred transition metal catalysts are copper complexes such as copper (I) halides with a ligand. The metal catalyst can be reduced form (e.g., Cu+), in oxide form (e.g., Cu+2), in atom form (e.g. Cu(0)) or mixture of all the metal forms in different valence. A particular ATRP process called “single electron transfer” (SET) living radical polymerization (LRP) uses only metal copper (Cu(0)) as initial catalyst, but the other valence forms of copper (Cu+ and Cu+2) are also generated in-situ and present during the polymerization process. In the so called reverse ATRP process, only metal in oxide form (e.g., Cu+2) is added initially, but metal in the reduced form (Cu+) is generated in-situ to make atom transfer radical polymerization work.

Suitable ligands for ATRP catalyst include but are not limit to bipyridine compounds, polydentate amines, terpyridyl and quadridentate amine bearing pyridine. Examples of pyridine compounds are 2,2′-bipyridine, 4,4′substituted 2,2′-bipyridine (such as 4,4′-di(5-nonyl)-2,2′-bipyridine and 4,4′-diheptyl-2,2′-bipyridine), BIS(2-PYRIDINAL)ETHYLENEDIIMINE, tris-(2-pyridylmethyl)amine (TPMA). Examples of dentate amine ligands are hexa-N,N-substituted tris[2-(amino)ethyl]amine (TREN) such as tris[2-(N,N-dimethylamino)ethyl]amine (Me6TREN), 1,1,4,7,10,10-hexamethyitriethylenetetramine (HMTEA), and penta methyl diethylene triamine (Me5DETA). Preferred ligands for ATRP catalyst are Me6TREN, TPMA, and HMTEA. Tetradentated branched ligands such as Me6TREN and TPMA form highly active catalysts with copper halids such as CuBr and are the most suitable for the preparation of low molecular weight antifungal tBAEMA oligomers at low temperature and low degrees of polymerization.

Suitable ATRP initiators include, but not limited to, halogenated alkanes, benzylic halides, α-haloesters, a-haloketones, alkyl and aryl suffonyl chlorides. Preferred initiators are α-haloesters and α-haloketones, More preferred initiators are α-haloesters such as 2-haloisobutyrates and 2-halobutyrates. Examples of α-haloester initiators are ethyl 2-bromoisobutyrate (EBiB) and ethyl 2-bromobutyrate.

The preferred ATRP initiators may be represented by formula III

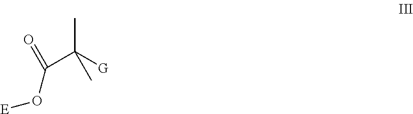

where G is the transferable atom or group which may be homolytically cleaved from the initiator by the catalyst for ATRP process and E is an alkyl or a functional group which, desirably, may impart antifungal activity in addition to the antifungal activity originated from the tBAEMA main oligomer chain. Example functional groups for E may include haloalkyl such as bromoethyl, hydroxyalkyl such as hydroxyethyl, halobenzyl such as bromobenzyl, and propargyl, a polyene radical with multicinjugated double bonds and group containing imidazole, triazole, or thiazole entity which are known to have antimicrobial or antifungal activity.

When low molecular weight antifungal tBAEMA oligomer represented by formula II is obtained by ATRP using an initiator from formula II, the A group may be represented by formula (IV).

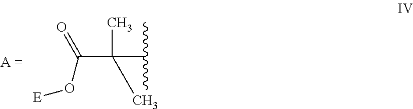

While not limiting the scope of the invention, it is believed that the added antimicrobial activity against multicellular microorganism of the tBAEMA oligomers appears to result from low molecular size. Reduced molecular size of the tBAEMA oligomer may make the antimicrobial agent easier to penetrate and/or attach to multicellular structure of mold fungi for killing. Homopolymers of tBAEMA has been previously shown to act as an antimicrobial peptide mimic with facially amphiphilic structure. See G. J. Gabriel et al., Materials Science and Engineering R57 (2007), page 28-64 and C. J. Hewitt et al., Biotechnology Letters 26: pages 549-557, 2004.

The oligomeric broad-spectrum antifungal agent may be made by ATRP process using a halo-initiator such as α-haloesters and a-haloketones. More preferred ATRP initiator is selected from α-bromoesters such as 2-bromoisobutyrates and α-iodoesters such as 2-iodoisobutyrates.

When the antimicrobial oligomers are made by the ATRP process, the initiator to monomer ratio may range from to 0.001 to 1, preferably from 0.01 to 0.5, and more preferably from 0.02 to 0.2 by mole.

The ratio of transition metal to the initiator may range from 0.01 to 1. The reaction temperature may range from 0 to 200° C. and preferably from 20 to 100° C.

The term “oligomer” for purposes of this application means a repeating unit ranging from 2 to 100, preferably from 5 to 60, and most preferably from 10 to 40. Depending upon the formula weight of the repeat unit this will translate into a weight average molecular weight (M_{w}) between 400 to 20,000 g/mole or a number average molecular weight (Mₙ) of from 400 to 10,000 g/mole. The term “oligomers” in the context of this application means the antimicrobial oligomers.

Low molecular weight and oligomer are synonymous or exchangeable terms for purposes of this application. However, when the term molecular weight is used this will normally indicate a weight average molecular weight (M_{w}) unless otherwise indicated. Degree of polymerization means the number of repeat monomer units making up a polymer. For example, if the degree of polymerization is 100 then 100 monomer units are incorporated into the polymer.

(Meth)acrylate means methacrylate or acrylate and likewise (meth)acrylamide means methacrylamide or acrylamide.

In the definitions of the variables given above, collective terms are used which are generally representative for the substituents in question. The term “Cₙ—Cₘ” indicates the number of carbon atoms possible in each case in the substituent or substituent moiety in question.

The term “halogen” refers to fluorine, chlorine, bromine and iodine.

The term “C₁-C₆-alkyl” refers to a straight-chained or branched saturated hydrocarbon group having 1 to 6 carbon atoms, for example methyl, ethyl, propyl, 1-methylethyl, butyl, 1-methylpropyl, 2-methylpropyl, and 1,1-dimethylethyl

The term “divalent C₁-C₅-alkylene” refers to a group inserted in between two residual parts of a molecule such as, for example, —CH₂—, —CH₂CH₂— or —CH₂CH₂CH₂—.

The term “microbes” is to be understood to denote a microscopic organism that comprises either a single cell (unicellular), cell clusters, or multicellular organisms; they include fungi, oomycetes, bacteria, viruses, viroids, virus-like organisms, phytoplasmas and protozoa.

A preferred embodiment of the invention relates to oligomers of formula I for combating fungi.

Another preferred embodiment of the invention relates to oligomers of formula I for combating bacteria.

The oligomers, mixtures comprising them and their compositions according to the invention are particularly important in the control of a multitude of phytopathogenic microbes on various cultivated plants, such as cereals, e. g. wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or goose-berries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, aspa [symbol] ragus, cabbages, carrots, onions, tomatoes, potatoes, cucurbits or paprika; laura [symbol] ceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; sweet leaf (also called Stevia); natural rubber plants or ornamental and forestry plants, such as flowers, shrubs, broad-leaved trees or evergreens, e. g. conifers; and on the plant propagation material, such as seeds, and the crop material of these plants. Preferably oligomers, mixtures comprising them and their compositions according to the invention are used for controlling a multitude of microbes on field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

Most preferably oligomers, mixtures comprising them and their compositions according to the invention are used for controlling a multitude of microbes on field crops such as wheat, rye, barley, oats and rice.

Agriculturally acceptable salts of the oligomers according to the invention encompass especially the salts of those cations or the acid addition salts of those acids whose cations and anions, respectively, have no adverse effect on the microbicidal action of the oligomers. Suitable cations are thus in particular the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry one to four C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium. Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting an oligomer according to the invention with an acid of the corresponding anion, preferably of hydrochloric acid, hydrobromic acid, sulfuric acid, phosphoric acid or nitric acid.

The oligomers, mixtures comprising them and their compositions according to the invention are suitable as fungicides. They are distinguished by an outstanding effectiveness against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). They can be used in crop protection as foliar fungicides, fungicides for seed dressing and soil fungicides. Moreover, they are suitable for controlling harmful fungi, which inter alia occur in wood or roots of plants.

The oligomers, mixtures comprising them and their compositions according to the invention are particularly suitable for controlling the following plant diseases:

Albugo spp. (white rust) on ornamentals, vegetables (e. g. A. candida) and sunflowers (e. g. A. tragopogonis); Alemaria spp. (Alternaria leaf spot) on vegetables, rape (A. brasscola or brassicae), sugar beets (A. tenuis), fruits, rice, soybeans, potatoes (e. g. A. solani or A. altemata), tomatoes (e. g. A. solani or A. altemata) and wheat; Aphanomyces spp. on sugar beets and vegetables; Ascochyta spp. on cereals and vegetables, e. g. A. tritici(anthracnose) on wheat and A. hordei on barley; Bipolaris and Drechslera spp. (teleomorph: Cochiobolus spp.), e. g. Southern leaf blight (D. maydis) or Northern leaf blight (B. zeicola) on corn, e. g. spot blotch (B. sorokiniana) on cereals and e.g. B. oryzae on rice and turfs; Blumeria (formerly Erysiphe) graminis (powdery mildew) on cereals (e. g. on wheat or barley); Botrytis cinerea (teleomorph: Botryotinia fuckeliana. grey mold) on fruits and berries (e. g. strawberries), vegetables (e. g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e. g. C. ulmi(Dutch elm disease) on elms; Cercospora spp. (Cercospora leaf spots) on corn (e.g. Gray leaf spot: C. zeae-maydis), rice, sugar beets (e. g. C. beticola), sugar cane, vegetables, coffee, soybeans (e. g. C. sojina or C. kikuchi) and rice; Cladosporium spp. on tomatoes (e. g. C. fulvum leaf mold) and cereals, e. g. C. herbarum (black ear) on wheat; Claviceps purpurea (ergot) on cereals; Cochliobolus (anamorph: Helminthosporium of Bipolans) spp. (leaf spots) on corn (C. carbonum), cereals (e. g. C. sativus, anamorph: B. sorokiniana) and rice (e. g. C. miyabeanus, anamorph: H. oryzae); Colletotrichum (teleomorph: Glomerella) spp. (anthracnose) on cotton (e. g. C. gossypi), corn (e. g. C. graminicola: Anthracnose stalk rot), soft fruits, potatoes (e. g. C. coccodes black dot), beans (e. g. C. lindemuthianum) and soybeans (e. g. C. truncatum or C. gloeosponiides); Corcidum spp., e. g. C. sasaki (sheath blight) on rice; Corynespora cassicola (leaf spots) on soybeans and ornamentals; Cycloconium spp., e. g. C. oleaginum on olive trees; Cylindrocarpon spp. (e. g. fruit tree canker or young vine decline, teleomorph: Nectria or Neonectria spp.) on fruit trees, vines (e. g. C. liniodendri, teleomorph: Neonectria liriodendri Black Foot Disease) and ornmentals; Dematophora (teleomorph: Rosellinia) necatrix (root and stem rot) on soybeans; Diaporthe spp., e. g. D. phaseolorum (damping off) on soybeans; Drechslera (syn. Helminthosporiium, teleomorph: Pyrenophora) spp. on corn, cereals, such as barley (e. g. D. teres, net blotch) and wheat (e. g. D. tritici-repentis tan spot), rice and turf; Esca (dieback, apoplexy) on vines, caused by Formitiporia (syn. Phellinus) punctata, F. mediterranea, Phaeomoniella chlamydospora (earlier Phaeo-acremonium chlamydosporum), Phaeoacremonium aleophilum and/or Botyosphaeria obtusa Elsinoe spp. on pome fruits (E. pyri), soft fruits (E. veneta anthracnose) and vines (E. ampelina anthracnose); Entyloma oryzae (leaf smut) on rice; Epicoccum spp. (black mold) on wheat; Erysiphe spp. (powdery mildew) on sugar beets (E. betae), vegetables (e. g. E. pisi), such as cucurbits (e. g. E. cichoracearum), cabbages, rape (e. g. E. cruciferarum); Eutypa late (Eutypa canker or dieback, anamorph: Cytosporina lata, syn. Libertella blepharis) on fruit trees, vines and ornamental woods; Exserohilum (syn. Helminthosponium) spp. on corn (e. g. E. turcicum); Fusarium (teleomorph: Gibberella) spp. (wilt, root or stem rot) on various plants, such as F. graminearum or F. culmorum (root rot, scab or head blight) on cereals (e. g. wheat or barley), F. oxy-sporum on tomatoes, F. solani on soybeans and F. verticilloides on corn; Gaeumanno-myces graminis (take-all) on cereals (e. g. wheat or barley) and corn; Gibberella spp. on cereals (e. g. G. zeae) and rice (e. g. G. fujikuroi Bakanae disease); Glomerella cingulata on vines, pome fruits and other plants and G. gossypii on cotton; Grain-staining complex on rice; Guignardia bidwellii(black rot) on vines; Gymnosporangium spp. on rosaceous plants and junipers, e. g. G. sabinae (rust) on pears; Helmintho-sporium spp. (syn. Drechslera, teleomorph: Cochliobolus) on corn, cereals and rice; Hemileia spp., e. g. H. vastatrix (coffee leaf rust) on coffee; Isariopsis davispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e. g. wheat or barley); Microsphaera diffusa (powdery mildew) on soybeans; Monilinia spp., e. g. M. laxa, M. fructicola and M. fictigena (bloom and twig blight, brown rot) on stone fruits and other rosaceous plants; Mycosphaerella spp. on cereals, bananas, soft fruits and ground nuts, such as e. g. M. graminicola (anamorph: Septoria titrici, Septoria blotch) on wheat or M. fijiensis (black Sigatoka disease) on bananas; Peronospora spp. (downy mildew) on cabbage (e. g. P. brassicae), rape (e. g. P. parasitica), onions (e. g. P. destructor), tobacco (P. tabacina) and soybeans (e. g. P. manshurica); Phakopsora pachyrhizi and P. meibomiae (soybean rust) on soybeans; Phialophora spp. e. g. on vines (e. g. P. tracheiphila and P. tetraspora) and soybeans (e. g. P. gregata. stem rot); Phoma lingam (root and stem rot) on rape and cabbage and P. betae (root rot, leaf spot and damping-off) on sugar beets; Phomopsis spp. on sunflowers, vines (e. g. P. viticola can and leaf spot) and soybeans (e. g. stem rot: P. phaseoli teleomorph: Diaporthe phaseolorum); Physoderma maydis (brown spots) on corn; Phytophthora spp. (wilt, root, leaf, fruit and stem root) on various plants, such as paprika and cucurbits (e. g. P. capsici), soybeans (e. g. P. megaspernna, syn. P. sojae), potatoes and tomatoes (e. g. P. infestans late blight) and broad-leaved trees (e. g. P. ramorum sudden oak death); Plasmodiophora brassicae (club root) on cabbage, rape, radish and other plants; Plasmopara spp., e. g. P. viticola (grapevine downy mildew) on vines and P. halstedii on sunflowers; Podosphaera spp. (powdery mildew) on rosaceous plants, hop, pome and soft fruits, e. g. P. leucotricha on apples; Polymyxa spp., e. g. on cereals, such as barley and wheat (P. graminis) and sugar beets (P. betae) and thereby transmitted viral diseases; Pseudocerosporella herpotrichoides (eyespot, teleomorph: Tapesia yallundae) on cereals, e. g. wheat or barley; Pseudoperonospora (downy mildew) on various plants, e. g. P. cubensis on cucurbits or P. humili on hop; Pseudopezicula tracheiphila (red fire disease or ‘rotbrenner’, anamorph: Phialophora) on vines; Puccinia spp. (rusts) on various plants, e. g. P. triticina (brown or leaf rust), P. striiformis (stripe or yellow rust), P. hordei(dwarf rust), P. graminis (stem or black rust) or P. recondita (brown or leaf rust) on cereals, such as e. g. wheat, barley or rye, P. kuehnii(orange rust) on sugar cane and P. asparagi on asparagus; Pyrenophora (anamorph: Drechslera) tritici-repentis (tan spot) on wheat or P. teres (net blotch) on barley; Pyricularia spp., e. g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e. g. P. ultimum or P. aphanidermatum); Ramularia spp., e. g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e. g. R. solani (root and stem rot) on soybeans, R. solani (sheath blight) on rice or R. cerealis (Rhizoctonia spring blight) on wheat or barley; Rhizopus stolonifer(black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e. g. S. sclerotiorum) and soybeans (e. g. S. rolfsii or S. sclerotiorum); Septoria spp. on various plants, e. g. S. glycines (brown spot) on soybeans, S. tritici(Septoria blotch) on wheat and S. (syn. Stagonospora) nodorum (Stagonospora blotch) on cereals; Uncinula (syn. Erysiphe) necator(powdery mildew, anamorph: Oidium tuckeri) on vines; Setospaeria spp. (leaf blight) on corn (e. g. S. turcicum, syn. Helminthosporium turcicum) and turf; Sphacelotheca spp. (smut) on corn, (e. g. S. reliana head smut), sorghum und sugar cane; Sphaerotheca fuliginea (powdery mildew) on cucurbits; Spongospora subterranea (powdery scab) on potatoes and thereby transmitted viral diseases; Stagonospora spp. on cereals, e. g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e. g. T. deformans (leaf curl disease) on peaches and T. pruni(plum pocket) on plums; Thielaviopsis spp. (black root rot) on tobacco, pome fruits, vegetables, soybeans and cotton, e. g. T. basicola (syn. Chalara elegans); Tileltia spp. (common bunt or stinking smut) on cereals, such as e. g. T. tritici(syn. T. caries, wheat bunt) and T. controversa (dwarf bunt) on wheat; Typhula incarnata (grey snow mold) on barley or wheat; Urocystis spp., e. g. U. occulta (stem smut) on rye; Uromyces spp. (rust) on vegetables, such as beans (e. g. U. appendiculatus, syn. U. phaseoli) and sugar beets (e. g. U. betae); Ustilago spp. (loose smut) on cereals (e. g. U. nuda and U. avaenae), corn (e. g. U. maydis, corn smut) and sugar cane; Venturia spp. (scab) on apples (e. g. V. inaequalis) and pears; and Verticillium spp. (wilt) on various plants, such as fruits and ornamentals, vines, soft fruits, vegetables and field crops, e. g. V. dahliae on strawberries, rape, potatoes and tomatoes.

According to a further embodiment of the invention the oligomers, mixtures comprising them and their compositions according to the invention are particularly suitable for controlling on wheat plants the plant diseases caused by phytopathogenic fungi selected from Blumeria graminis (powdery mildew), Claviceps purpurea (ergot), Drechslera (syn. Helminthosporium, teleomorph: Pyrenophora) teres tritici-repentis (tan-spot), Fusarium graminearium and culmorum (root rot, scab or head blight), Gaeumannomyces graminis (take-all), Helminthosporium spp. (syn. Drechslera, teleomorph: Cochliobolus), Fusarium nivale (pink snow mold), Mycosphaerella graminicola (anamorph: Septoria tritici, Septoria blotch), Pseudocercosporella herpotrichoides (eyespot, teleomorph: Tapesia yallundae), Puccinia triticina (brown or leaf rust), P. striiformis (stripe or yellow rust), P. graminis (stem or black rust), P. recondita (brown or leaf rust), Septoria (syn. Stagonospora) nodorum (Stagonospora blotch), Leptosphaeria [syn. Phaeosphaeria] nodorum, and Tilletia tritici (syn. T. caries, wheat bunt).

According to a further embodiment of the invention the oligomers, mixtures comprising them and their compositions according to the invention are particularly suitable for controlling on barley plants the phytopathogenic fungi selected from Blumeria graminis (powdery mildew), Claviceps purpurea (ergot), Drechslera (syn. Helminthosporium, teleomorph: Pyrenophora) teres (net blotch), Fusarium graminearum and culmorum (root rot, scab or head blight), Gaeumannomyces graminis (take-all), Puccinia hordei (dwarf or leaf rust), P. graminis (stem rust), P. striiformis (stripe or yellow rust), Ramularia collo-cygni (Ramularia leaf spots, Physiological leaf spots) and Rhynchosporium secalis (scald).

According to a further embodiment of the invention the oligomers, mixtures comprising them and their compositions according to the invention are partuclarly suitable for controlling on corn plants the phytopathogenic fungi selected from Cercospora zeae-maydis, Colleotichum graminicola, Bipolaris zeicola, Drechslera maydis, Fusarium verticillioides, Gaeumannomyces graminis (take-all), Gibberella zeae and Ustilago maydis (corn smut).

According to a further embodiment of the invention the oligomers, mixtures comprising them and their compositions according to the invention are particularly suitable for controlling on soybean plants the phytopathogenic fungi selected from Cercospora sojina and kikuchii Colleotricum gloeosparioides, Corynespora cassiicola (leaf spots), Dematophora (teleomorph: Rosellinia) necatrix (root and stem rot), Diaporthe spp., e. g. D. phaseolorum (damping off), Fusarium solani, Microsphaera diffusa (powdery mildew), Peronospora manshurica (downy mildew), Phakopsora pachyrhizi and P. meibomiae (soybean rust), Phytophthora megasperma (syn. P. sojae), Rhizoctonia solani (root and stem rot), Septoria glycines (brown spot) and Thielaviopsis spp. (black root rot).

According to a further embodiment of the invention the oligomers, mixtures comprising them and their compositions according to the invention are particularly suitable for controlling on rice plants the phytopathogenic fungi selected from Cochliobolus miyabeanus, Cercospora sojina and C. kikuchi Corticium sasakii (sheath blight), Giberella fujikuroi (Bakanae disease), Pyricularia oryzae (teleomorph: Magnaporthe grisea, rice blast) and R. solani(sheath blight).

According to a further embodiment of the invention the oligomers, mixtures comprising them and their compositions according to the invention are particularly suitable for controlling on cotton plants the phytopathogenic fungi selected from Colletotrichum gossypii, Glomerella gossypii, Rhizoctonia spp. and Thielaviopsis spp. (black root rot).

According to a further embodiment of the invention the oligomers, mixtures comprising them and their compositions according to the invention are particularly suitable for controlling on oil seed rape plants the phytopathogenic fungi selected from Alternaria brassicola, Botrytis cinerea, Erysiphe cruciferarum (powdery mildew) and Peronospora parasitica (downy mildew).

According to a further embodiment of the invention the oligomers, mixtures comprising them and their compositions according to the invention are particularly suitable for controlling on potatoe plants the phytopathogenic fungi selected from Alternaria solani (early blight), Colleotrichum coccodes (black dot), Phytophthora infestans (late blight) and Rhizoctonia spp.

According to a further embodiment of the invention the oligomers, mixtures comprising them and their compositions according to the invention are particularly suitable for controlling on tomatoe plants the phytopathogenic fungi selected from Alternaria solani (early blight) and Phytophthora infestans (late blight).

According to a further embodiment of the invention the oligomers, mixtures comprising them and their compositions according to the invention are particularly suitable for controlling on bean plants the phytopathogenic fungi selected from Colletotrichum lindemuthianum and Uromyces appendiculatus (rust).

According to a further embodiment of the invention the oligomers, mixtures comprising them and their compositions according to the invention are particularly suitable for controlling on sugar beets the phytopathogenic fungi selected from Cercospora beticola, Erysiphe betae (powdery mildew), Ramularia beticola and Uromyces betae (rust).

According to a further embodiment of the invention the oligomers, mixtures comprising them and their compositions according to the invention are particularly suitable for controlling on vines (table grapes, wine grapes) the phytopathogenic fungi selected from Botrytis cinerea; Esca (dieback, apoplexy) caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtuse; and Plasmopara viticola (grapevine downy mildew); and Uncinula (syn. Erysiphe) necator (powdery mildew, anamorph: Oidium tuckeri).

According to a further embodiment of the invention the oligomers, mixtures comprising them and their compositions according to the invention are particularly suitable for controlling on strawberry plants Botrytis cineria.

According to a further embodiment of the invention the oligomers, mixtures comprising them and their compositions according to the invention are particularly suitable for controlling on coffee plants Hemileia vastatrix (leaf rust).

According to a further embodiment of the invention the oligomers, mixtures comprising them and their compositions according to the invention are particularly suitable for controlling on apple trees the phytopathogenic fungi selected from Podosphaera leucotricha (powdery mildew) and Venturia inaequalis (scab).

The oligomers, mixtures comprising them and their compositions according to the invention are also suitable as bactericides. They are distinguished by an outstanding effectiveness against a broad spectrum of phytopathogenic bacteria. They can be used in crop protection as foliar bactericides, bactericides for seed dressing and soil bactericides. Moreover, they are suitable for controlling harmful bacteria, which inter alia occur in wood or roots of plants.

The oligomers, mixtures comprising them and their compositions according to the invention are particularly suitable for controlling the following plant diseases: Acidovorax spp. (bacterial fruit blotch, for example on cucurbits); Agrobacterium spp. (crown galls, for example on treefruits and grapes); Bacillus spp. (food spoiler); Clavibacter spp. (Goss's bacterial wilt and leaf blight, for example in corn); Curtobacterium spp. (Bacterial wilt, for example in beans); Erwinia spp. (Fire blight, for example on fruit trees and bacterial rot, for example of onions); Pectobacteruum spp. (Black leg, for example of potato, or bacterial rot of African violets); Pseudomonas spp., P. syringae (bacterial leaf spots and blight, formation of biofilm); Ralstonia spp. (bacterial blight, for example of tomato and tobacco); Rathayibacter spp. (Spike blight, for example in wheat); Spiroplasma spp. (Citrus stuborn disease, corn stunt disease); Streptomyces spp. (Potato scab, soft rot, for example in sweet potatoes); Xanthomonas spp. (Citrus canker, bacterial spots, for example on peaches, pepper and tomato); Xylella fastidiosa (Pierce's disease).

According to another aspect the present invention relates to a post-harvest treatment method for the suppression of biological infestation in harvested produce comprising applying an oligomer according to the invention to the harvested produce. Moreover, the invention relates also to a use of the postharvest treatment methods defined herein to lengthen the post-harvest shelf-life of the stored harvested produce. Harvested produce from cultivated plants such as bananas, plantains, pineapples, peaches, nectarines and artichokes often become biologically contaminated post-harvest. Contamination can be initiated pre-harvest (e. g. by parasitic presence at the time of picking/harvesting). During harvesting, (e. g. where contaminants are introduced by mechanical harvesting or human intervention) and post-harvest (e. g. where parasites or spores settle on post harvest product). Fungal or mold spores in the delatexing bath can be a source of spores during field packing of bananas.

Regardless of the time of contamination, it is desirable to treat harvested produce such as fruits, vegetables, flowers or nuts prior to transport and storage to prevent damage from any such contamination. For example, international quarantine regulations and inspection require fruit to be free of live pests.

Fungicides from the chemical class of benzimidazoles such as thiabenzadole or eenomyl are the most widely used chemicals for the post-harvest control of fungal infestation in several crops such as pears, apples or bananas (see e.g. D. Sugar and S. R. Basile, Timing and sequence of postharvest fungicide and biocontrol agent applications for control of per decay, Postharvest Biology and Technology (2008), 49, pp. 107-112). Practical agricultural experience has shown that exclusive application of a limited number of active compounds from a limited number of compound classes in the control of harmful fungi leads in many cases to a rapid selection of those fungus strains which have developed natural or adapted resistance against the active compound in question. (see e.g. P. F. Bertrand and J. Saulie-Carter, The occurrence of benomyl-tolerant strains of Penicillium expansum and Botrytis cinerea in the Mid-Columbia region of Oregon and Washington, Plant Dis. Reptr. (1978), 62,_pp. 302-305). Effective control of these fungi with the active compound in question is then no longer possible. Thus, with respect to the suppression of biological infestion, the action of these post-harvest treatments is not always completely satisfactory. Based on this it was an object of the present invention to provide postharvest treatment methods having improved action and/or a broadened activity spectrum against harmful fungi and molds.

This object is achieved by post-harvest treatment methods as defined herein.

To reduce the risk of the selection of resistant fungus strains, mixtures of different active compounds are nowadays conventionally employed for controlling harmful fungi.

By combining active compounds having different mechanisms of action, it is possible to ensure successful control over a relatively long period of time.

It is a further object of the present invention to provide, with a view to effective resistance management and effective control of phytopathogenic harmful fungi, at application rates which are as low as possible, post-harvest treatments with compositions which, at a reduced total amount of active compounds applied, have improved activity against the harmful fungi (synergistic mixtures) and a broadened activity spectrum, in particular for certain indications.

We have accordingly found that this object is achieved by a post-harvest treatment method for the suppression of biological infestation in harvested produce comprising applying to the harvested produce an oligomer according to the invention or a composition comprising such oligomer.

According to a further embodiment, the post-harvest treatment method, wherein the harvested produce is a fruit or vegetable with inedible peel, preferably selected from avocados, bananas, plantains, lemons, grapefruits, melons, oranges, pineapples, kiwi fruits, guavas, mandarins, mangoes and pumpkin, is preferred, more preferably oranges, lemons and peaches.

According to a further embodiment, the post-harvest treatment method, wherein the harvested produce is selected from avocados, bananas, plantains and citrus, is even more preferred.

The post-harvest treatment according to the invention is important in the control of a multitude of fungi or molds on various harvested produce, such as fruits, such as pomes, stone fruits or soft fruits, e. g. apples, pears, plums, peaches, almonds, cherries, strawberries, raspberries, blackberries or gooseberries; harvested produce from leguminous plants, such as lentils and peas; harvested produce from cucurbits, such as squashes, cucumber or melons; citrus fruits, such as oranges, lemons, grapefruits or mandarins; vegetables, such as asparagus, cabbages, onions, tomatoes, potatoes or paprika; harvested produce from lauraceous plants, such as avocados; bananas; table grapes; hop; turf.

The post-harvest treatment according to the invention is particularly important in the control of a multitude of fungi or molds on various harvested produce almonds, anise, apple, apricot, artichoke, arugula, asparagus, atemoya, avocado, baby corn, banana, beans, beet, bittermelon, black salsify, blackberry, blueberry, breadfruit, broccoli, Brussels sprout, cabbage, cactus fruit, caimito, calamondin, canistel, cantaloupe, carrot, cashew apple, cashew nuts, cauliflower, celeriac, celery, chard, chayote, cherimoya, cherry, chicory, chinese cabbage, chive, clementines, coconut, collard, corn, cranberry, cucumber, currant, custard apple, cut flowers, daikon, date, dewberry, dill, durian, eggplant, elderberry, endive, fennel, fig, flower bulbs, garlic, ginger, gooseberry, granadilla, grapes, grapefruit, groundnuts, guava, hazelnuts, horseradish, jaboticaba, jackfruit, Jerusalem artichoke, kaki, kale, kiwifruit, kohlrabi, kumquat, leek, lemon, lettuce, lime, lobok, loganberry, longan, loquat, luffa, lychee, malanga, mammee apple, mamey, mandarin, mango, mangosteen, manioc, melon, melon pear, mombin, mushrooms, nashi, nectarine, okra, olive, onions, dry onions, orange, papaya, paprika, parsley, passions fruit, peach, pear, pepper, pigweed, pineapple, plantain, plum, potatoes, prune, pumkin, pummelo, quince, radicchio, radish, rambutan, raspberry, rhubarb, rutabaga, salsify, sapote, shallot, spinach, squash, star-apple, starfruit, strawberry, sugar apple, sweet corn, sweet potato, tamarillo, tamarind, tangarines, tangelo, taro, tomato, turnip, water chestnut, watercress, watermelon, Witloof chicory, yambean, yucca, fresh cut salads and herbs (such as basil, mint, oregano, thyme); and even more preferably on almonds, apples, apricots, avocado, bananas, blueberry, cantaloupe, carrots, cashew Nuts, clementines, cherries, cucumber, cut flowers, flower bulbs, grapefruit, grapes, groundnuts, hazelnuts, kiwi, lemon, lime, lettuce, mandarins, mango, melon, mushrooms, nectarines, onions, dry onions, shallot, oranges, papaya, peaches, pears, pepper, pineapple, plum, pummelos, potatoes, raspberry, strawberry, sweet corn, tangarines, tomatoes, watermelon, fresh cut salads and vegetables.

The term “harvested produce” is to be understood to denote all harvested product, crop, such as fruits, vegetables, nuts, cut flowers, etc. derived from a cultivated plant.

The term “cultivated plants” is to be understood as including plants which have been modified by breeding, mutagenesis or genetic engineering including but not limiting to agricultural biotech products on the market or in development (cf. http://www.bio.org/speeches/pubs/er/agri_products.asp). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s), oligo- or polypeptides e. g. by glycosylation or polymer additions such as prenylated, acetylated or farnesylated moieties or PEG moieties.

In the detailed description, the term “plant” refers to a cultivated plant.

The inventive post-harvest treatment methods are particularly suitable for controlling the following diseases in harvested produce:

in pome fruits, such as apples and pears: blue mold, gray mold, anthracnose rot, lenticel spot, bitter rot, black rot, white rot, mucor rot, alternaria rot, cladosporium rot, pleospora rot, phomopsis rot, pink rot, side rot, sooty blotch, fly speck, brown rot, phytophthora rot;
in stone fruits, such as apricot, cherry, nectarine, peach, plum and prune: brown rot, gray mold, rhizopus rot, mucor rot, blue mold, alternaria rot, cladosporium rot;
in kiwifruit: botrytis rot, surface mold, alternaria rot, juice blotch, dothiorella rot, phoma rot, phomopsis rot, sclerotinia rot, mucor rot, blue mold, buckshot rot;
in strawberry: gray mold, leak rot, rhizopus rot, mucor rot, anthracnose, leather rot; in grapes: botrytis rot;
in avocado: dothiorella rot, stem-end rot, fusarium rot, anthracnose;
in citrus fruits: blue mold, green mold, brown rot, phomopsis stem-end rot, stem-end rot, alternaria stem-end rot, anthracnose, sour rot, sclerotinia rot, trichoderma rot, botrytis rot;
in bananas: crown rot disease complex, anthracnose, lasiodiplodia rot, thielaviopsis rot, ceratocystis rot, cigar-end rot, squirter disease, fusarium rot;
in mango fruits: anthracnose, stem-end rot;
in papayas: anthracnose, phoma rot, phomopsis rot, lasiodiplodia rot, phytophthora rot, alternaria rot;
in pineapple: thielaviopsis rot, black rot;
in carrots: bacterial soft rot, gray mold, carrot white rot, fusarium dry rot, black mold, crater rot;
in lettuce: bacterial soft rot, lettuce white rot, gray mold;
in melons: sour rot, rhizopus rot, fusarium rot, trichothecium rot, botrytis rot, lasiodiplodia rot, gummy stem blight, black rot, anthracnose;
in onions: neck rot, bacterial soft rot, smudge, fusarium bulb rot, black mold, blue mold rot;
in potatoes: bacterial soft rot, ring rot, late blight, fusarium dry rot, black scurf; in snap beans: botrytis gray mold rot, snap bean white rot, anthracnose;
in sweet potatoes: rhizopus rot, black rot, fusarium surface rot;
in tomatoes: alternaria rot, buckeye rot, gray mold, ghost spot, sour rot, rhizopus rot, and anthracnose.

The inventive post-harvest treatment methods are particularly suitable for controlling the following fungi or molds in harvested produce:

in pome fruits, such as apples and pears: Penicillium expansum (=Coremium glaucum, Penicillium glaucum), Botrytinia fuckeliana (=Sclerotinia fuckeliana), Botrytis cinerea (=Haplaria grisea, Botrytis vulgaris), Pezicula malicorticis (=Neofabraea malicorticis, Neofabraea perennans), Cryptosporiopsis curvispora (=Cryptosporiopsis malicorticis, Gloeopsorium perennans), Pezicula alba, Phyctema vagabunda (=Gloeosporium album, Gloeosporium llentoidem, Gloeosporium allantosporum, Gloeosporium diervillae, Gloeosporium frigidum, Gloeosporium tineum, Trichoseptoria fructigena), Glomerella cingulata, Colletotrichum gloeosporioides (=Gloeosporium fructigenum), Botryosphaeria obtusa (=Physalospora obtusa), Sphaeropsis malorum (=Sphaeropsis biformis, Sphaeropsis cerasina, Sphaeropsis druparum, Sphaeropsis fertilis, Sphaeropsis maclurae, Sphaeropsis phlei, Sphaeropsis rosarum), Botryosphaeria dothidea (=Botryosphaeria berengeriana, Physalospora suberumpens), Dothiarella gregaria, Fusicoccum aesouli, Mucor piriformis, Alternaria alternata (=Alternaria tenuis, Alternaria Fasciculata, Macrosporium fasciculatum, Macrosporium maydis), Mycosphaerella tassiana, Cladosporium herbarum (=Cladosporium caricicola, Cladosporium epiphyllum, Cladosporium fasciculatum, Cladosporium fuscatum, Gladosporium graminum, Helminthosporium flexuosum), Pleospora ssp., Stemphylium botryosum, Diaporthe pemiciosa, Phomopsis mali, Trichoehecium roseum, Cephalothecium roseum, Phialophora malorum, Sporotrichum malorum (=Sporotrichum carpogenum), Gloeodes pomigena, Zygophiala jamaicensis, Monilinia fructigena (=Sclerotinia fructigena), Phytophthora cactorum, Phytophthora syringae;
in stone fruits, such as apricot, cherry, nectarine, peach, plum and prune: Monilinia fructicola (=Sclerotinia fructicola), Monilia sp., Monilinia laxa (=Sclerotinia laxa), Monilinia cineria, Botryotinia fuckeliana, Rhizopus stolonifer (=Rhizopus nigricans, Rhizopus nodosum, Rhizopus oxyzae, Rhizopus tritici, Choanephore persicaris), Mucor piriformis, Mucor hiemalis, Penicillium expansum, Alternaria alternata, Mycosphaerella tassiana, Cladosporium herbarum kiwifruit: Botryotinia fuckeliana, Botrytis cinerea (=Haplaria grisea, Botrytis vulgaris), Alternaria alternata, Botryosphaeria dothidea Dothiorella gregaria, Phoma spp., Diaporthe actinidiae, Phomopsis sp., Sclerotinia sclerotiorum (=Whetzelinia sclerotiorum, Sclerotinia libertiana, Sclerotinia intermedia, Sclerotinia sativa), Mucor piriformis, Penicillium expansum, Typhula ssp., Botryotinia fuckeliana, strawberry: Botrytis cinerea, Rhizopus stolonifer, Mucor piriformis, Mucor hiemalis, Glomerella cingulata, Colletotrichum gloeosporioides (=Gloeosporium fructigenum), Phytophthora cactorum
in grapes: Botryotinia fuckeliana,
in avocado: Botryosphaeria dothidea, Dothiorella gregaria, Botryosphaeria rhodina, Lasiodiploida theobromae, Fusarium spp., Gomerella cingulata, Colleotrichum gloeosporioides (=Gloeosporium fructigenum);
in citrus fruits: Penicillium italicum, Penicillium digitatum, Phytophthora citrophthora, Diaporthe citri, Phomopsis citri, Botryosphaeria rhodina, Lasiodiploida theobromae, Botryosphaeria rhodina, Alternaria citri, Glomerella cingulata, Colletotrichum gloeosporioides (=Gloeosporium fructigenum), Galactomyces geotrichum, Geotrichum candidum (=Geotrichum citri-auranti, Oospora lactis), Sclerotinia sclerotiorum, Hypocrea sp., Trichoderma viride (=Trichoderma lignorum), Botryotinia fuckeliana,
in bananas: Colletotrichum musae (=Gloeosporium musarum, Myxosporium musae), Botryosphaeria rhodina (=Physalospora rhodina), Lasiodiplodia theobromae (=Botryodiplodia theobromae, Diplodia theobromae, Botryodiplodia gossypii, Diplodia gossypina), Ceratocystis pradoxa, Ceratostomella paradoxa, Endoconidiophora pradoxa, Ophiostoma pradoxum, Thielaviopsis pradoxa, Verticillium theobromae (=Stachylidium theobromae), Trachysphaera fructigena, Nigrospora sphaerica (=Trichosporum sphaerica), Fusarium roseum,
in mangoes: Glomerella cingulata, Colletotrichum gloeosporioides (=Gloeosporium fructigenum), Botryosphaeria rhodina, Lasiodiploida theobromae;
in papayas: Glomerella cingulata, Colletotrichum gloeosporioides (=Gloeosporium fructigenum), Mycosphaerella caricae, Phoma caricae-papayae (=Ascochyta caricae-papayae), Phomopsis caricae-papayae, Botryosphaeria rhodina, Lasiodiplodia theobromae, Phytophthora nicotianae, Alternaria alternata,
in pineapples: Ceratoscstis paradoxa (=Ceratostomella pradoxa, Ophiostoma pradoxa), Thielaviopsis pradoxa, Gibberella fujikori; Fusarium moniliforme, Penicillium funiculosum, Saccharomyces spp., Erwinia carotovora
in carrots: Erwinia carotovora Botrytinia fuckeliana (=Sclerotinia fuckeliana), Botrytis cinerea, Sclerotinia sclerotiorum, Sclerotinia minor, Fusarium spp., Thielaviopsis basicola (=Trichocladium basicola), Rhizoctonia carotae;
in lettuce: Erwinia carotovora, Sclerotinia sclerotiorum Sclerotinia minor, Botryotinia fuckeliana,
in melons: Galactomyces geotrichum, Geotrichum candidum (=Geotrichum citri-auranti, Oospora lactis), Rhizopus stolonifer, Fusarium spp., Trichothecium roseum, Botryotinia fuckeliana, Botryosphaeria rhodina, Lasiodiplodia theobromae, Didymella bryoniae (=Mycosphaerella citrullina, Didymella melnis, Mycosphaerella melonis), Phoma cucurbitacearum, Glomerella lagenarium, Colletotrichum orbiculare (=Gloeosporium orbiculare, Colletotrichum lagenarium, Gloeosporium lagenarium);
in onions: Botryotinia allii, Botryotinia squamosa (=Sclerotinia squamosa), Botrytis aclada (=Botrytis allii), Botrytis byssoidea, Botrytis squamosa, Erwinia carotovora, Colletotrichum circinans (=Vermicularia circinans, Colletotrichum dematium), Fusarium oxysporium, Fusarium zonatum, Aspergillus niger, Penicillium expansum in potatoes: Erwinia carotovora, Pseudomonas spp., Corynebacterium sepedonicum, Phytophthora infestans, Fusarium solani, Fusarium roseum, Thanatephorus cucumeris, Corticium areolatum (=Pellicularia filamentosa, Ceratobasidium filamentosum, Hypochnus filamentosus, Corticium praticola, Corticium sasaki, Hypochnus sasakii Botryobasidium solani, corticium solani), Rhizoctonia solani (=Moniliopsis solani, Rhizoctonia macrosclerotia, Rhizoctonia microsclerotia);
in snap beans: Botryotinia fuckeliana, Sclerotinia sclerotiorum, Sclerotinia minor, Glomerella lindemuthiana, Colletotrichum lindemuthianum,
in sweet potatoes: Rhizopus stolonifer, Ceratocystis fimbriata (=Ceratostomella fimbriata, Endoconidiophora fimbriata, Ophiostoma fimbriata), Botryosphaeria rhodina, Lasiodiplodia theobromae, Fusarium oxysporium;
in tomatoes: Alternaria alternata, Phytophthora nicotianae (=Phytophthora prasitica), Botryotinia fuckeliana, Botrytis cinerea, Galactomyces geotrichum, Geotrichum candidum (=Geotrichum citri-auranti, Oospora lactis), Rhizopus stolonifer, and Colletotrichum cocoodes (=Colletotrichum atramentarium).

The oligomers according to the invention, mixtures comprising them and their compositions are particularly suitable for controlling the following diseases: Alternaria Rot, Alternaria spp. (apple, pear); Anthracnose, Colletotrichum spp. (tomato, peppers, apple, cherry, citrus); Bacterial Soft Rot, Erwinia spp. (peppers, carrot); Black Mold Rot, Aspergillus niger(tomato, carrot); Blue Mold, Penicillium spp. (pepper, eggplant); Brown Rot, Monilia spp. (tree fruit-pome, citrus); Cladosporium Rot, Cladosporium spp. (cherry, pome, grapes); Cottony Leak, Pythium spp. (cucurbits); Dry Rot, Fusarium spp. (potatoes); Grey Mold, Botrytis cinerea (grapes, berries, ornamentals); Mucor Rot, Mucor piriformis (apples, pear); Mucor Rot, Mucor cirinelloides (plum, peach); Rhizopus Rot, Rhizopus spp. (peach, plum, tomato); Sclerotium Rot, Sclerotium rolfsii(potato); Silver Scurf, Helminthosporium solani (potato); Sour Rot or Geotrichum candidum (tomato, citrus).

The user applies the oligomers according to the invention, mixtures comprising them and their compositions usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

A pesticide is generally a chemical or biological agent (such as a virus, bacterium, antimicrobial or disinfectant) that through its effect deters, incapacitates, kills or otherwise discourages pests. Target pests can include insects, plant pathogens, weeds, mollusks, birds, mammals, fish, nematodes (roundworms), and microbes that destroy property, cause nuisance, spread disease or are vectors for disease. The term pesticides includes also plant growth regulators that alter the expected growth, flowering, or reproduction rate of plants; defoliants that cause leaves or other foliage to drop from a plant, usually to facilitate harvest; desiccants that promote drying of living tissues, such as unwanted plant tops; plant activators that activate plant physiology for defense of against certain pests; safeners that reduce unwanted herbicidal action of pesticides on crop plants; and plant growth promoters that affect plant physiology to increase plant growth, biomass, yield or any other quality parameter of the harvestable goods of acrop plant.

Biopesticides have been defined as a form of pesticides based on micro-organisms (bacteria, fungi, viruses, nematodes, etc.) or natural products (compounds, such as metabolites, proteins, or ectracts from biological or other natural sources). Biopesticides are typically created by growing and concentrating naturally occurring organisms and/or their metabolites including bacteria and other microbes, fungi, viruses, nematodes, proteins, etc. They are often considered to be important components of integrated pest management (IPM) programmes, and have received much practical attention as substitutes to synthetic chemical plant protection products (PPPs).

Biopesticides fall into two major classes, microbial and biochemical pesticides:

(1) Microbial pesticides consist of bacteria, fungi or viruses (and often include the metabolites that bacteria and fungi produce). Entomopathogenic nematodes are also classified as microbial pesticides, even though they are multi-cellular.
(2) Biochemical pesticides are naturally occurring substances or or structurally-similar and functionally identical to a naturally-occurring substance and extracts from biological sources that control pests or provide other crop protection uses as defined below, but have non-toxic mode of actions (such as growth or developmental regulation, attractents, repellents or defence activators (e.g. induced resistance) and are relatively non-toxic to mammals.

Examples for biochemical pesticides include, but are not limited to semiochemicals (insect pheromones and kairomones), natural plant and insect regulators, naturally-occurring repellents and attractants, and proteins (e.g. enzymes).

Biopesticides for use against crop diseases have already established themselves on a variety of crops. For example, biopesticides already play an important role in controlling downy mildew diseases. Their benefits include: a 0-Day Pre-Harvest Interval, the ability to use under moderate to severe disease pressure, and the ability to use in mixture or in a rotational program with other registered pesticides.

A major growth area for biopesticides is in the area of seed treatments and soil amendments. Biopesticidal seed treatments are e.g. used to control soil borne fungal pathogens that cause seed rots, damping-off, root rot and seedling blights. They can also be used to control internal seed borne fungal pathogens as well as fungal pathogens that are on the surface of the seed. Many biopesticidal products also show capacities to stimulate plant host defenses and other physiological processes that can make treated crops more resistant to a variety of biotic and abiotic stresses or can regulate plant growth. Many biopesticidal products also show capacities to stimulate plant health, plant growth and/or yield enhancing activity.

Practical agricultural experience has shown that the repeated and exclusive application of an individual active component in the control of harmful fungi, insects or other pests leads in many cases to a rapid selection of those fungus strains or pest isolates which have developed natural or adapted resistance against the active component in question. Effective control of these fungi, insects or other pests with the active component in question is then no longer possible.

Another typical problem arising in the field of pest control lies in the need to reduce the dosage rates of the active ingredient in order to reduce or avoid unfavorable environmental or toxicological effects whilst still allowing effective pest control.

It is an object of the present invention overcome the abovementioned disadvantages and to provide, with a view to effective resistance management and effective control of phytopathogenic harmful fungi, insects or other pests or to effective plant growth regulation, at application rates which are as low as possible, compositions which, at a reduced total amount of active compounds applied, have improved activity against the harmful fungi, insects or other pests or improved plant growth regulating activity (synergistic mixtures) and a broadened activity spectrum, in particular for certain indications. This is particularly visible if application rates for the beforementioned mixtures of pesticides are used where the individual components show no or virtually no activity. The invention can also result in an advantageous behavior during formulation or during use, for example during grinding, sieving, emulsifying, dissolving or dispensing; improved storage stability and light stability, advantageous residue formation, improved toxicological or ecotoxicological behaviour, improved properties of the plant, for example better growth, increased harvest yields, a better developed root system, a larger leaf area, greener leaves, stronger shoots, less seed required, lower phytotoxicity, mobilization of the defense system of the plant, good compatibility with plants. Moreover, even an enhanced systemic action of oligomers formed from a monomer of formula I and the pesticides as defined herein and/or a persistency of the fungicidal, insecticidal, acaricidal and/or nematicidal action is expected.

This is particularly visible if application rates for the mixtures of oligomers formed from a monomer of formula I with pesticides are defined are used where the applicaton rates of the individual components show no or virtually no activity. The invention can also result in an advantageous behavior during formulation or during use, for example during grinding, sieving, emulsifying, dissolving or dispensing; improved storage stability and light stability, advantageous residue formation, improved toxicological or ecotoxicological behaviour, improved properties of the plant, for example better growth, increased harvest yields, a better developed root system, a larger leaf area, greener leaves, stronger shoots, less seed required, lower phytotoxicity, mobilization of the defense system of the plant, good compatibility with plants. It was therefore also an object of the present invention to provide pesticidal mixtures which solve the problems of reducing the dosage rate and/or enhancing the spectrum of activity and/or combining knock-down activity with prolonged control and/or to resistance management and/or promoting (increasing) the health of plants.

We have accordingly found that this object is achieved by the mixtures and compositions as defined herein, comprising the oligomers formed from a monomer of formula I and further pesticides II as defined herein.

Thus, the present invention relates to mixtures comprising, as active components

1) an oligomer formed from a monomer of formula I

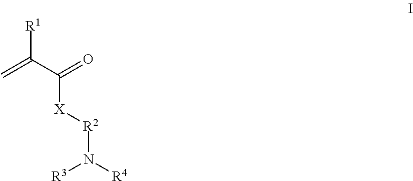

wherein

### R¹ is H or CH₃,

R² is a divalent C₁-C₅-alkylene group,
X is a divalent radical of —O—, —NH— or —NR⁵, wherein R⁵ is C₁-C₆-alkyl,
R³ and R⁴ independently of each other are H or C₁-C₅-alkyl radical which can be linear or branched,
or its agrochemically acceptable salts, wherein the oligomer has a weight average molecular weight (M_{w}) of 400 to 20,000 g/mole and a number average molecular weight (Mₙ) from 400 to 10,000 g/mole (determined according to GPC calibrated with poly methyl methacrylate narrow molecular weight standards), characterized in that the oligomers have a molecular weight polydispersity index (PDI) of 1.0 to 3.0; and
2) at least one pesticide II selected from the groups A) to O):

### A) Respiration Inhibitors

Inhibitors of complex III at Qₒ site (e.g. strobilurins): azoxystrobin (A.1.1), coumeth-oxystrobin (A.1.2), coumoxystrobin (A.1.3), dimoxystrobin (A.1.4), enestroburin (A.1.5), fenaminstrobin (A.1.6), fenoxystrobin/flufenoxystrobin (A.1.7), fluoxastrobin (A.1.8), kresoxim-methyl (A.1.9), mandestrobin (A.1.10), metominostrobin (A.1.11), orysastrobin (A.1.12), picoxystrobin (A.1.13), pyraciostrobin (A.1.14), pyrametostrobin (A.1.15), pyraoxystrobin (A.1.16), trifloxystrobin (A.1.17) and 2-(2-(3-(2,6-dichlorophenyl)-1-methyl-allylideneaminooxymethyl)-phenyl)-2-methoxyimino-N-methyl-acetamide (A.1.18), pyribencarb (A. 1.19), triclopyricarb/chlorodincarb (A.1.20), famoxadone (A.1.21), fenamidone (A.1.21);
inhibitors of complex III at Qᵢ site: cyazofamid (A.2.1), amisulbrom (A.2.2), [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate (A.2.3), [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate (A.2.4), [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate (A.2.5), [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate (A.2.6); (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate (A.2.7);
inhibitors of complex II (e. g. carboxamides): benodanil (A.3.1), benzovindiflupyr (A.3.2), bixafen (A.3.3), boscalid (A.3.4), carboxin (A.3.5), fenfuram (A.3.6), fluopyram (A.3.7), flutolanil (A.3.8), fluxapyroxad (A.3.9), furametpyr (A.3.10), isofetamid (A.3.11), isopyrazam (A.3.12), mepronil (A.3.13), oxycarboxin (A.3.14), penflufen (A.3.14), penthiopyrad (A.3.15), sedaxane (A.3.16), tecloftalam (A.3.17), thifluzamide (A.3.18), N-(4′-trifluoromethytthiobiphenyl-2-yl)-3-difluoromethyl-1-methyl-1H-pyrazole-4-carboxamide (A.3.19), N-(2-(1,3,3-trimethyl-butyl)-phenyl)-1,3-dimethyl-5-fluoro-1H-pyrazole-4-carboxamide (A.3.20), 3-(difluoromethyl)-1-methyl-N-(1,1,3-trimethylindan-4-yl)pyrazole-4-carboxamide (A.3.21), 3-(trifluoromethyl)-1-methyl-N-(1,1,3-trimethylindan-4-yl)pyrazole-4-carboxamide (A.3.22), 1,3-dimethyl-N-(1,1,3-trimethylindan-4-yl)pyrazole-4-carboxamide (A.3.23), 3-(trifluoromethyl)-1,5-dimethyl-N-(1,1,3-trimethylindan-4-yl)pyrazole-4-carboxamide (A.3.24), 1,3,5-trimethyl-N-(1,1,3-trimethylindan-4-yl)pyrazole-4-carboxamide (A.3.25), N-(7-fluoro-1,1,3-trimethyl-indan-4-yl)-1,3-dimethyl-pyrazole-4-carboxamide (A.3.26), N-[2-(2,4-dichlorophenyl)-2-methoxy-1-methyl-ethyl]-3-(difluoromethyl)-1-methyl-pyrazole-4-carboxamide (A.3.27);
other respiration inhibitors (e.g. complex I, uncouplers): diflumetorim (A.4.1), (5,8-difluoroquinazolin-4-yl)-[2-[2-fluoro-4-(4-trifluoromethylpyridin-2-yloxy)-phenyl]-ethyl)-amine (A.4.2); nitrophenyl derivates: binapacryl (A.4.3), dinobuton (A.4.4), dinocap (A.4.5), fluazinam (A.4.6); ferimzone (A.4.7); organometal compounds: fentin salts, such as fentin-acetate (A.4.8), fentin chloride (A.4.9) or fentin hydroxide (A.4.10); ametoctradin (A.4.11); and silthiofam (A.4.12);

### B) Sterol Biosynthesis Inhibitors (SBI Fungicides)

C14 demethylase inhibitors (DMI fungicides): triazoles: azaconazole (B.1.1), bitertanol (B.1.2), bromuconazole (B.1.3), cyproconazole (B.1.4), difenoconazole (B.1.5), diniconazole (B.1.6), diniconazole-M (B.1.7), epoxiconazole (B.1.8), fenbuconazole (B.1.9), fluquinconazole (B.1.10), flusilazole (B.1.11), flutriafol (B.1.12), hexaconazole (B.1.13), imibenconazole (B.1.14), ipconazole (B.1.15), metconazole (B.1.17), myclobutanil (B.1.18), oxpoconazole (B.1.19), paclobutrazole (B.1.20), penconazole (B.1.21), propiconazole (B.1.22), prothioconazole (B.1.23), simeconazole (B.1.24), tebuconazole (B.1.25), tetraconazole (B.1.26), triadimefon (B.1.27), triadimenol (B.1.28), triticonazole (B.1.29), uniconazole (B.1.30), 1-[rel-(2S,3R-3-(2-chlorophenyl)-2-(2,4-dfluorophenyl)-oxiranylmethyl]-5-thiocyanato-1H-[1,2,4]triazolo (B.1.31), 2-[rel(2S,3R)-3-(2-chlorophenyl)-2-(2,4-difluorophenyl)-oxiranylmethyl]-2H-[1,2,4]triazole-3-thiol (B.1.32), 2-[2-chloro-4-(4-chlorophenoxy)-phenyl]-1-(1,2,4-triazol-1-yl)pentan-2-ol (B.1.33), 1-[4-(4-chlorophenoxy)-2-(trifluoromethyl)phenyl]-1-cyclopropyl-2-(1,2,4-triazol-1-yl)ethanol (B.1.34), 2-[4-(4-chloro-phenoxy)-2-(trifluoromethyl)phenyl]-1-(1,2,4-triazol-1-yl)butan-2-ol (B.1.35), 2-[2-chloro-4-(4-chlorophenoxyl)phenyl]-1-(1,2,4-triazol-1-yl)butan-2-ol (B.1.36), 2-[4-(4-chlorophenoxy)-2-(trifluoromethyl)phenyl]-3-methyl-1-(1,2,4-triazol-1-yl)butan-2-ol (B.1.37), 2-[4-(4-chlorophenoxy)-2-(trifluoromethyl)phenyl]-1-(1,2,4-triazol-1-yl)propan-2-ol (B.1.38), 2-[2-chloro-4-(4-chlorophenoxyl)phenyl]-3-methyl-1-(1,2,4-triazol-1-yl)butan-2-ol (B.1.39), 2-[4-(4-chlorophenoxy)-2-(trifluoromethyl)-phenyl]-1-(1,2,4-triazol-1-yl)pentan-2-ol (B.1.40), 2-[4-(4-fluorophenoxy)-2-(trifluoromethyl)phenyl]-1-(1,2,4-triazol-1-yl)propan-2-ol (B.1.41); imidazoles: imazalil (B.1.42), pefurazoate (B.1.43), prochloraz (B.1.44), triflumizol (B.1.45); pyrimidines, pyridines and piperazines: fenarimol (B.1.46), nuarimol (B.1.47), pyrifenox (B.1.48), triforine (B.1.49), [3-(4-chloro-2-fluorophenyl)-5-(2,4-difluoro-phenyl)isoxazol-4-yl]-(3-pyridyl)methanol (B.1.50);
Delta 14-reductase inhibitors: aldimorph (B.2.1), dodemorph (B.2.2), dodemorph-acetate (B.2.3), fenpropimorph (B.2.4), tridemorph (B.2.5), fenpropidin (B.2.6), piperalin (B.2.7), spiroxamine (B.2.8);
Inhibitors of 3-keto reductase: fenhexamid (B.3.1);

### C) Nucleic Acid Synthesis Inhibitors

phenylamides or acyl amino acid fungicides: benalaxyl (C.1.1), benalaxyl-M (C.1.2), kiralaxyl (C.1.3), metalaxyl (C.1.4), metalaxyl-M (mefenoxam, C.1.5), ofurace (C.1.6), oxadixyl (C.1.7);
others: hymexazole (C.2.1), octhilinone (C.2.2), oxolinic acid (C.2.3), bupirimate (C.2.4), 5-fluorocytosine (C.2.5), 5-fluoro-2-(p-tolylmethoxy)pyrimidin-4-amine (C.2.6), 5-fluoro-2-(4-fluorophenylmethoxyl)pyrimidin-4-amine (C.2.7);

### D) Inhibitors of Cell Division and Cytoskeleton

tubulin inhibitors, such as benzimidazoles, thiophanates: benomyl (D1.1), carbendazim (D1.2), fuberidazole (D1.3), thiabendazole (D1.4), thiophanate-methyl (D1.5); triazolopyrimidines: 5-chloro-7-(4-methylpiperidin-1-yl)-6-(2,4,6-trifluoro-phenyl)-[1,2,4]triazolo[1,5-a]pyrimidine (D1.6);
other cell division inhibitors: diethofencarb (D2.1), ethaboxam (D2.2), pencycuron (D2.3), fluopicolide (D2.4), zoxamide (D2.5), metrafenone (D2.6), pyriofenone (D2.7);

### E) Inhibitors of Amino Acid and Protein Synthesis

methionine synthesis inhibitors (anilino-pyrimidines): cyprodinil (E.1.1), mepanipyrim (E.1.2), pyrimethanil (E.1.3);
protein synthesis inhibitors: blasticidin-S(E.2.1), kasugamycin (E.2.2), kasugamycin hydrochloride-hydrate (E.2.3), mildiomycin (E.2.4), streptomycin (E.2.5), oxytetracyclin (E.2.6), polyoxine (E.2.7), validamycin A (E.2.8);

### F) Signal Transduction Inhibitors

MAP/histidine kinase inhibitors: fluoroimid (F.1.1), iprodione (F.1.2), procymidone (F.1.3), vinciozolin (F.1.4), fenpicionil (F.1.5), fludioxonil (F.1.6);
G protein inhibitors: quinoxyfen (F.2.1);

### G) Lipid and Membrane Synthesis Inhibitors

Phospholipid biosynthesis inhibitors: edifenphos (G.1.1), iprobenfos (G.1.2), pyrazophos (G.1.3), isoprothiolane (G.1.4);
lipid peroxidation: dicloran (G.2.1), quintozene (G.2.2), tecnazene (G.2.3), tolclofos-methyl (G.2.4), biphenyl (G.2.5), chloroneb (G.2.6), etridiazole (G.2.7);
phospholipid biosynthesis and cell wall deposition: dimethomorph (G.3.1), flumorph (G.3.2), mandipropamid (G.3.3), pyrimorph (G.3.4), benthiavalicarb (G.3.5), iprovalicarb (G.3.6), valifenalate (G.3.7) and N-(1-(1-(4-cyano-phenyl)ethanesufonyl)-but-2-yl) carbamic acid-(4-fluorophenyl) ester (G.3.8);
compounds affecting cell membrane permeability and fatty acides: propamocarb (G.4.1);
fatty acid amide hydrolase inhibitors: oxathiapiprolin (G.5.1);
   H) Inhibitors with Multi Site Action
inorganic active substances: Bordeaux mixture (H.1.1), copper acetate (H.1.2), copper hydroxide (H.1.3), copper oxychloride (H.1.4), basic copper sulfate (H.1.5), sulfur (H.1.6);
thio- and dithiocarbamates: ferbam (H.2.1), mancozeb (H.2.2), maneb (H.2.3), metam (H.2.4), metiram (H.2.5), propineb (H.2.6), thiram (H.2.7), zineb (H.2.8), ziram (H.2.9);
organochlorine compounds (e.g. phthalimides, sulfamides, chloronitriles): anilazine (H.3.1), chlorothalonil (H.3.2), captafol (H.3.3), captan (H.3.4), folpet (H.3.5), dichlofluanid (H.3.6), dichlorophen (H.3.7), hexachlorobenzene (H.3.8), pentachlorphenole (H.3.9) and its salts, phthalide (H.3.10), tolylfluanid (H.3.11), N-(4-chloro-2-nitro-phenyl)-N-ethyl-4-methyl-benzenesulfonamide (H.3.12);
guanidines and others: guanidine (H.4.1), dodine (H.4.2), dodine free base (H.4.3), guazatine (H.4.4), guazatine-acetate (H.4.5), iminoctadine (H.4.6), iminoctadine-triacetate (H.4.7), iminoctadine-tris(albesilate) (H.4.8), dithianon (H.4.9), 2,6-di-methyl-1 H,5H-[1,4]dithiino[2,3-c:5,6-c′]dipyrrole-1,3,5,7(2H,6H)-tetraone (H.4.10);

### I) Cell Wall Synthesis Inhibitors

inhibitors of glucan synthesis: validamycin (1.1.1), polyoxin B (1.1.2);
melanin synthesis inhibitors: pyroquilon (1.2.1), tricyclazole (1.2.2), carpropamid (1.2.3), dicyclomet (1.2.4), fenoxanil (1.2.5);

### J) Plant Defence Inducers

acibenzolar-S-methyl (J.1.1), probenazole (J.1.2), isotianil (J.1.3), tiadinil (J.1.4), prohexadione-calcium (J.1.5); phosphonates: fosetyl (J.1.6), fosetyl-aluminum (J.1.7), phosphorous acid and its salts (J.1.8), potassium or sodium bicarbonate (J.1.9);

### K) Unknown Mode of Action

bronopol (K.1.1), chinomethionat (K.1.2), cyflufenamid (K.1.3), cymoxanil (K.1.4), dazomet (K.1.5), debacarb (K.1.6), diclomezine (K.1.7), difenzoquat (K.1.8), difenzoquat-methylsulfate (K.1.9), diphenylamin (K.1.10), fenpyrazamine (K.1.11), flumetover (K.1.12), flusulfamide (K.1.13), flutianil (K.1.14), methasulfocarb (K.1.15), nitrapyrin (K.1.16), nitrothal-isopropyl (K.1.18), oxathiapiprolin (K.1.19), tolprocarb (K.1.20), oxin-copper (K.1.21), proquinazid (K.1.22), tebufloquin (K.1.23), tecloftalam (K.1.24), triazoxide (K.1.25), 2-butoxy-6-iodo-3-propylchromen-4-one (K.1.26), 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone (K.1.27), 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone (K.1.28), 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone (K.1.29), N-(cyclopropylmethoxyimino-(6-difluoro-methoxy-2,3-di-fluoro-phenyl)-methyl)-2-phenyl acetamide (K.1.30), N′-(4-(4-chloro-3-trifluoro-methyl-phenoxy)-2,5-dimethyl-phenyl)-N-ethyl-N-methyl formamidine (K.1.31), N′-(4-(4-fluoro-3-trifluoromethyl-phenoxy)-2,5-dimethyl-phenyl)-N-ethyl-N-methyl formamidine (K.1.32), N′-(2-methyl-5-trifluoromethyl-4-(3-trimethylsilanyl-propoxy)-phenyl)-N-ethyl-N-methyl formamidine (K.1.33), N′-(5-difluoromethyl-2-methyl-4-(3-trimethylsilanyl-propoxy)-phenyl)-N-ethyl-N-methyl formamidine (K.1.34), methoxy-acetic acid 6-tert-butyl-8-fluoro-2,3-dimethyl-quinolin-4-yl ester (K.1.35), 3-[5-(4-methylphenyl)-2,3-dimethyl-isoxazolidin-3-yl]-pyridine (K.1.36), 3-[5-(4-chloro-phenyl)-2,3-dimethyl-isoxazolidin-3-yl]-pyridine (pyrisoxazole) (K.1.37), N-(6-meth-oxy-pyridin-3-yl) cyclopropanecarboxylic acid amide (K.1.38), 5-chloro-1-(4,6-di-methoxy-pyrimidin-2-yl)-2-methyl-1H-benzoimidazole (K.1.39), 2-(4-chloro-phenyl)-N-[4-(3,4-dimethoxy-phenyl)-isoxazol-5-yl]-2-prop-2-ynyloxy-acetamide, ethyl (Z)-3-amino-2-cyano-3-phenyl-prop-2-enoate (K.1.40), picarbutrazox (K.1.41), pentyl N-[6-[[(Z)-[(1-methyttetrazol-5-yl)-phenyl-methylene]amino]oxymethyl]-2-pyridyl]carbamate (K.1.42), 2-[2-[(7,8-difluoro-2-methyl-3-quinolyl)oxy]-6-fluoro-phenyl]propan-2-ol (K.1.43), 2-[2-fluoro-6-[(8-fluoro-2-methyl-3-quinolyl)oxy]phenyl]propan-2-ol (K.1.44), 3-(5-fluoro-3,3,4,4-tetramethyl-3,4-dihydroisoquinolin-1-yl)-quinoline (K.1.45), 3-(4,4-difluoro-3,3-dimethyl-3,4-dihydroisoquinolin-1-yl)quinoline (K.1.46), 3-(4,4,5-trifluoro-3,3-dimethyl-3,4-dihydroisoquinolin-1-yl)quinoline (K.1.47);

### L) Biopesticides

L1) Microbial pesticides with fungicidal, bactericidal, viricidal and/or plant defense activator activity: Ampelomyces quisqualis, Aspergillus flavus, Aureobasidium pullulans, Bacillus amyloliquefaciens, B. mojavensis, B. pumilus, B. simplex, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocadium roseum, Lysobacter antibioticus, L. enzymogenes, Metschnikowia fructicola, Microdochium dimerum, Microsphaeropsis ochracea, Muscodor albus, Paenibacillus polymyxa, Pantoea vagans, Phlebiopsis gigantea, Pseudomonas sp., Pseudomonas chloraphis, Pseudozyma flocculosa, Pichia anomala, Pythium oligandrum, Sphaerodes mycoparasitica, Streptomyces griseoviridis, S. lydicus, S. violaceusniger, Talaromyces flavus, Trichoderma asperellum, T. atroviride, T. fertile, T. gamsii, T. harmatum; mixture of T. harzianum and T. viride; mixture of T. polysporum and T. harzianum; T. stromaticum, T. virens (also named Gliocladium virens), T. viride, Typhula phacorrhiza, Ulocladium oudemansii, Verticillium dahlia, zucchini yellow mosaic virus (avirulent strain);
L2) Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium or sodium bicarbonate, Reynoutria sachlinensis extract, salicylic acid, tea tree oil;
L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tenebrionis, Beauveria bassiana, B. brongniartii, Burkholderia sp., Chromobacterium subtsugae, Cydia pomonella granulosis virus, Cryptophlebia leucotreta granulovirus (CrIeGV), Isaria fumosorosea, Heterorhabditis bacteriophora, Lecanicillium longisporum, L. muscarium (formerly Verticillium lecanii), Metarhizium anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramose, P. reneformis, P. thomea, P. usgae, Pseudomonas fluorescens, Steinemema carpocapsae, S. feltiae, S. kraussei;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Quillay extract, Tagetes oil;
L5) Microbial pesticides with plant stress reducing, plant growth regulator, plant growth promoting and/or yield enhancing activity: Azospirillum amazonense A. brasilense, A. lipoferum, A. irakense, A. halopraeferens, Bradyrhizobium sp., B. elkanii, B. japonicum, B. liaoningense, B. lupini, Delftia acidovorans, Glomus intraradices, Mesorhizobium sp., Paenibacillus alvei, Penicillium bilaiae, Rhizobium leguminosarum bv. phaseolii, R. I. trifolii, R. I. bv. viciae, R. tropici, Sinorhizobium meliloti;
L6) Biochemical pesticides with plant stress reducing, plant growth regulator and/or plant yield enhancing activity: abscisic acid, aluminium silicate (kaolin), 3-decen-2-one, formononetin, genistein, hesperetin, homobrassinlide, humates, jasmonic acid or salts or derivatives thereof, lysophosphatidyl ethanolamine, naringenin, polymeric polyhydroxy acid, Ascophyllum nodosum (Norwegian kelp, Brown kelp) extract and Ecklonia maxima (kelp) extract;

### M) Growth Regulators

abscisic acid (M.1.1), amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paciobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole;

### N) Herbicides

acetamides: acetochlor (N.1.1), alachlor, butachlor, dimethachlor, dimethenamid (N.1.2), flufenacet (N.1.3), mefenacet (N.1.4), metolachlor (N.1.5), metazachlor (N.1.6), napropamide, naproanilide, pethoxamid, pretilachlor, propachlor, thenylchlor
amino acid derivatives: bilanafos, glyphosate (N.2.1), glufosinate (N.2.2), sulfosate (N.2.3);
aryloxyphenoxypropionates: clodinafop (N.3.1), cyhalofop-butyl, fenoxaprop (N.3.2), fluazifop (N.3.3), haloxyfop (N.3.4), metamifop, propaquizafop, quizalofop, quizalofop-P-tefuryl;
Bipyridyls: diquat, paraquat (N.4.1);
(thio)carbamates: asulam, butylate, carbetamide, desmedipham, dimepiperate, eptam (EPTC), esprocarb, molinate, orbencarb, phenmedipham (N.5.1), prosulfocarb, pyributicarb, thiobencarb, triallate;
cyclohexanediones: butroxydim, clethodim (N.6.1), cycloxydim (N.6.2), profoxydim (N.6.3), sethoxydim (N.6.4), tepraloxydim (N.6.5), tralkoxydim;
dinitroanilines: benfluralin, ethalfluralin, oryzalin, pendimethalin (N.7.1), prodiamine (N.7.2), trifluralin (N.7.3);
diphenyl ethers: acifluorfen (N.8.1), acionifen, bifenox, diclofop, ethoxyfen, fomesafen, lactofen, oxyfluorfen;
hydroxybenzonitriles: bomoxynil (N.9.1), dichlobenil, ioxynil;
imidazolinones: imazamethabenz, imazamox (N.10.1), imazapic (N.10.2), imazapyr (N.10.3), imazaquin (N.10.4), imazethapyr (N.10.5);
phenoxy acetic acids: clomeprop, 2,4-dichlorophenoxyacetic acid (2,4-D) (N.11.1), 2,4-DB, dichlorprop, MCPA, MCPA-thioethyl, MCPB, Mecoprop;
pyrazines: chloridazon (N.11.1), flufenpyr-ethyl, fluthiacet, norflurazon, pyridate;
pyridines: aminopyralid, clopyralid (N.12.1), diflufenican, dithiopyr, fluridone, fluroxypyr (N.12.2), picloram (N.12.3), picolinafen (N.12.4), thiazopyr;
sulfonyl ureas: amidosulfuron, azimsulfuron, bensulfuron (N.13.1), chlorimuron-ethyl (N.13.2), chlorsulfuron, cinosulfuron, cyclosulfamuron (N.13.3), ethoxysulfuron, flazasulfuron, flucetosulfuron, flupyrsulfuron, foramsulfuron, halosulfuron, imazosulfuron, iodosulfuron (N.13.4), mesosulfuron (N.13.5), metazosulfuron, metsulfuron-methyl (N.13.6), nicosulfuron (N.13.7), oxasulfuron, primisulfuron, prosulfuron, pyrazosulfuron, rimsulfuron (N.13.8), sulfometuron, sulfosulfuron, thifensulfuron, triasulfuron, tribenuron, trifloxysulfuron, triflusulfuron (N.13.9), tritosulfuron, 1-((2-chloro-6-propyl-imidazo[1,2-b]pyridazin-3-yl)sulfonyl)-3-(4,6-dimethoxy-pyrimidin-2-yl)urea;
triazines: ametryn, atrazine (N.14.1), cyanazine, dimethametryn, ethiozin, hexazinone (N.14.2), metamitron, metribuzin, prometryn, simazine, terbuthylazine, terbutryn, triaziflam;
ureas: chlorotoluron, daimuron, diuron (N.15.1), fluometuron, isoproturon, linuron, methabenzthiazuron, tebuthiuron;
other acetolactate synthase inhibitors: bispyribac-sodium, cloransulam-methyl, diciosulam, florasulam (N.16.1), flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfone (N.16.2), pyroxsulam;
others: amicarbazone, aminotriazole, anilofos, beflubutamid, benazolin, bencarbazone, benfluresate, benzofenap, bentazone (N.17.1), benzobicyclon, bicyclopyrone, bromacil, bromobutide, butafenacil, butamifos, cafenstrole, carfentrazone, cinidon-ethyl (N.17.2), chlorthal, cinmethylin (N.17.3), clomazone (N.17.4), cumyluron, cyprosulfamide, dicamba (N.17.5), difenzoquat, diflufenzopyr (N.17.6), Drechslera monoceras, endothal, ethofumesate, etobenzanid, fenoxasuffone, fentrazamide, flumiciorac-pentyl, flumioxazin, flupoxam, flurochloridone, flurtamone, indanofan, isoxaben, isoxaflutole, lenacil, propanil, propyzamide, quinclorac (N.17.7), quinmerac (N.17.8), mesotrione (N.17.9), methyl arsonic acid, naptalam, oxadiargyl, oxadiazon, oxaziciomefone, pentoxazone, pinoxaden, pyracionil, pyraflufen-ethyl, pyrasuffotole, pyrazoxyfen, pyrazolynate, quinoclamine, saflufenacil (N.17.10), sulcotrione (N.17.11), sulfentrazone, terbacil, tefuryltrione, tembotrione, thiencarbazone, topramezone (N.17.12), (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methyl-phenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester;

### O) Insecticides

organo(thio)phosphates: acephate (O.1.1), azamethiphos (O.1.2), azinphos-methyl (O.1.3), chlorpyrifos (O.1.4), chlorpyrifos-methyl (O.1.5), chlorfenvinphos (O.1.6), diazinon (O.1.7), dichlorvos (O.1.8), dicrotophos (O.1.9), dimethoate (O.1.10), disulfoton (O.1.11), ethion (O.1.12), fenitrothion (O.1.13), fenthion (O.1.14), isoxathion (O.1.15), malathion (O.1.16), methamidophos (O.1.17), methidathion (O.1.18), methyl-parathion (O.1.19), mevinphos (O.1.20), monocrotophos (O.1.21), oxydemeton-methyl (O.1.22), paraoxon (O.1.23), parathion (O.1.24), phenthoate (O.1.25), phosalone (O.1.26), phosmet (O.1.27), phosphamidon (O.1.28), phorate (O.1.29), phoxim (O.1.30), pirimiphos-methyl (O.1.31), profenofos (O.1.32), prothiofos (O.1.33), sulprophos (O.1.34), tetrachlorvinphos (O.1.35), terbufos (O.1.36), triazophos (O.1.37), trichlorfon (O.1.38);
carbamates: alanycarb (O.2.1), aldicarb (O.2.2), bendiocarb (O.2.3), benfuracarb (O.2.4), carbaryl (O.2.5), carbofuran (O.2.6), carbosulfan (O.2.7), fenoxycarb (O.2.8), furathiocarb (O.2.9), methiocarb (O.2.10), methomyl (O.2.11), oxamyl (O.2.12), pirimicarb (O.2.13), propoxur (O.2.14), thiodicarb (O.2.15), triazamate (O.2.16);
pyrethroids: allethrin (O.3.1), bifenthrin (O.3.2), cyfluthrin (O.3.3), cyhalothrin (O.3.4), cyphenothrin (O.3.5), cypermethrin (O.3.6), alpha-cypermethrin (O.3.7), beta-cypermethrin (O.3.8), zeta-cypermethrin (O.3.9), deltamethrin (O.3.10), esfenvalerate (O.3.11), etofenprox (O.3.11), fenpropathrin (O.3.12), fenvalerate (O.3.13), imiprothrin (O.3.14), lambda-cyhalothrin (O.3.15), permethrin (O.3.16), prallethrin (O.3.17), pyrethrin I and II (O.3.18), resmethrin (O.3.19), silafluofen (O.3.20), tau-fluvalinate (O.3.21), tefluthrin (O.3.22), tetramethrin (O.3.23), tralomethrin (O.3.24), transfluthrin (O.3.25), profluthrin (O.3.26), dimefluthrin (O.3.27);
insect growth regulators: a) chitin synthesis inhibitors: benzoylureas: chlorfluazuron (O.4.1), cyramazin (O.4.2), diflubenzuron (O.4.3), flucycloxuron (O.4.4), flufenoxuron (O.4.5), hexaflumuron (O.4.6), lufenuron (O.4.7), novaluron (O.4.8), teflubenzuron (O.4.9), triflumuron (O.4.10); buprofezin (O.4.11), diofenolan (O.4.12), hexythiazox (O.4.13), etoxazole (O.4.14), ciofentazine (O.4.15); b) ecdysone antagonists: halofenozide (O.4.16), methoxyfenozide (O.4.17), tebufenozide (O.4.18), azadirachtin (O.4.19); c) juvenoids: pyriproxyfen (O.4.20), methoprene (O.4.21), fenoxycarb (O.4.22); d) lipid biosynthesis inhibitors: spirodiciofen (O.4.23), spiromesifen (O.4.24), spirotetramat (O.4.24);
nicotinic receptor agonists/antagonists compounds: clothianidin (O.5.1), dinotefuran (O.5.2), flupyradifurone (O.5.3), imidacioprid (O.5.4), thiamethoxam (O.5.5), nitenpyram (O.5.6), acetamiprid (O.5.7), thiacloprid (O.5.8), 1-2-chloro-thiazol-5-ylmethyl)-2-nitrimino-3,5-dimethyl-[1,3,5]triazinane (O.5.9);
GABA antagonist compounds: endosulfan (O.6.19, ethiprole (O.6.2), fipronil (O.6.3), vaniliprole (O.6.4), pyrafluprole (O.6.5), pyriprole (O.6.6), 5-amino-1-(2,6-dichloro-4-methyl-phenyl)-4-sufinamoyl-1H-pyrazole-3-carbothioic acid amide (O.6.7);
macrocyclic lactone insecticides: abamectin (O.7.1), emamectin (O.7.2), milbemectin (O.7.3), lepimectin (O.7.4), spinosad (O.7.5), spinetoram (O.7.6);
mitochondrial electron transport inhibitor (METI) I acaricides: fenazaquin (O.8.1), pyridaben (O.8.2), tebufenpyrad (O.8.3), tolfenpyrad (O.8.4), flufenerim (O.8.5);
METI II and III compounds: acequinocyl (O.9.1), fluacyprim (O.9.2), hydramethylnon (O.9.3);
Uncouplers: chlorfenapyr (O.10.1);
oxidative phosphorylation inhibitors: cyhexatin (O.11.1), diafenthiuron (O.11.2), fenbutatin oxide (O.11.3), propargite (O.11.4);
moulting disruptor compounds: cryomazine (O.12.1);
mixed function oxidase inhibitors: piperonyl butoxide (O.13.1);
sodium channel blockers: indoxacarb (O.14.1), metaflumizone (O.14.2);
ryanodine receptor inhibitors: chlorantraniliprole (O.15.1), cyantraniliprole (O.15.2), flubendiamide (O.15.3), N-[4,6-dichloro-2-[(diethyl-lambda-4-sulfanylidene)carbamoyl]-phenyl]-2-(3-chloro-2-pyridyl)-5-(trifluoromethyl)pyrazole-3-carboxamide (O.15.4); N-[4-chloro-2-[(diethy-lambda-4-sulfanylidene)carbamoyl]-6-methyl-phenyl]-2-(3-chloro-2-pyridyl)-5-(trifluoromethyl)pyrazole-3-carboxamide (O.15.5);

N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide (O.15.6); N-[4,6-di-chloro-2-[(di-2-propyl-lambda-4-sulfanylidene)carbamoyl]-phenyl]-2-(3-chloro-2-pyridyl)-5-(trifluoromethyl)pyrazole-3-carboxamide (O.15.7); N-[4,6-dichloro-2-[(diethyl-lambda-4-sufanylidene)carbamoyl]-phenyl]-2-(3-chloro-2-pyridyl)-5-(difluorometh-yl)pyrazole-3-carboxamide (O.15.8); N-[4,6-dibromo-2-[(di-2-propyl-lambda-4-sul-fanylidene)carbamoyl]-phenyl]-2-(3-chloro-2-pyridyl)-5-(trifluoromethyl)pyrazzole-3-carboxamide (O.15.9); N-[4-chloro-2-[(di-2-propyl-lambda-4-suffanylidene)carbamoyl]-6-cyano-phenyl]-2-(3-chloro-2-pyridyl)-5-(trifluoromethyl)pyrazole-3-carboxamide (O.15.10); N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide (O.15.11);
others: benclothiaz (O.16.1), bifenazate (O.16.2), artap (O.16.3), flonicamid (O.16.4), pyridalyl (O.16.5), pymetrozine (O.16.6), sulfur (O.16.7), thiocyclam (O.16.8), cyenopyrafen (O.16.9), flupyrazofos (O.16.10), cyflumetofen (O.16.11), amidoflumet (O.16.12), imicyafos (O.16.13), bistrifluron (O.16.14), pyrifluquinazon (O.16.15) and 1,1′-[(3S,4R,4aR,6S,6aS,12R, 12aS, 12bS)-4-[[(2-cyclopropylacetyl)-oxy]methyl]-1,3,4,4a,5,6,6a,12,12a,12b-decahydro-12-hydroxy-4,6a,12b-trimethyl-11-oxo-9-(3-pyridinyl)-2H, 11H-naphtho[2,1-b]pyrano[3,4-e]pyran-3,6-diyl]cyclopropaneacetic acid ester (O.16.16).

According to one embodiment, the mixtures comprise an oligomer formed from a monomer of formula I and at least one pesticide II in a synergistically effective amount.

The invention also relates to a method for controlling phytopathogenic harmful fungi using mixtures of an oligomer formed from a monomer of formula I and and at least one pesticide II and to the use of an oligomer formed from a monomer of formula I and pesticides II for preparing such mixtures, and to compositions comprising these mixtures and seed comprising these mixtures or coated with this mixture.

Moreover, we have found that simultaneous, that is joint or separate, application of an oligomer formed from a monomer of formula I and a pesticide II or successive application of an oligomer formed from a monomer of formula I and of a pesticide II allows better control of harmful fungi than is possible with the individual components alone (synergistic mixtures).

When applying an oligomer formed from a monomer of formula I and a pesticide II sequentially the time between both applications may vary e.g. between 2 hours to 7 days. Also a broader range is possible ranging from 0.25 hour to 30 days, preferably from 0.5 hour to 14 days, particularly from 1 hour to 7 days or from 1.5 hours to 5 days, even more preferred from 2 hours to 1 day. In case of a mixture comprising a pesticide II selected from group L), it is preferred that the pesticide II is applied as last treatment. Oligomers formed from a monomer of formula I and/or the pesticides II can be present in different crystal modifications, which may differ in biological activity.

Preference is given to mixtures comprising an oligomer according to the invention (component 1) and at least one active substance selected from group A) (component 2) and particularly selected from azoxystrobin, dimoxystrobin, fluoxastrobin, kresoxim-methyl, orysastrobin, picoxystrobin, pyraciostrobin, trifloxystrobin; famoxadone, fenamidone; bixafen, boscalid, fluopyram, fluxapyroxad, isopyrazam, penflufen, penthiopyrad, sedaxane; ametoctradin, cyazofamid, fluazinam, fentin salts, such as fentin acetate.

Preference is also given to mixtures comprising an oligomer according to the invention (component 1) and at least one active substance selected from group B) (component 2) and particularly selected from cyproconazole, difenoconazole, epoxiconazole, fluquinconazole, flusilazole, flutriafol, metconazole, myclobutanil, penconazole, propiconazole, prothioconazole, triadimefon, triadimenol, tebuconazole, tetraconazole, triticonazole, prochloraz, fenarimol, triforine; dodemorph, fenpropimorph, tridemorph, fenpropidin, spiroxamine; fenhexamid.

Preference is also given to mixtures comprising an oligomer according to the invention (component 1) and at least one active substance selected from group C) (component 2) and particularly selected from metalaxyl, (metalaxyl-M) mefenoxam, ofurace.

Preference is also given to mixtures comprising an oligomer according to the invention (component 1) and at least one active substance selected from group D) (component 2) and particularly selected from benomyl, carbendazim, thiophanate-methyl, ethaboxam, fluopicolide, zoxamide, metrafenone, pyriofenone.

Preference is also given to mixtures comprising an oligomer according to the invention (component 1) and at least one active substance selected from group E) (component 2) and particularly selected from cyprodinil, mepanipyrim, pyrimethanil.

Preference is also given to mixtures comprising an oligomer according to the invention (component 1) and at least one active substance selected from group F) (component 2) and particularly selected from iprodione, fludioxonil, vinclozolin, quinoxyfen.

Preference is also given to mixtures comprising an oligomer according to the invention (component 1) and at least one active substance selected from group G) (component 2) and particularly selected from dimethomorph, flumorph, iprovalicarb, benthiavalicarb, mandipropamid, propamocarb.

Preference is also given to mixtures comprising an oligomer according to the invention (component 1) and at least one active substance selected from group H) (component 2) and particularly selected from copper acetate, copper hydroxide, copper oxychloride, copper sulfate, sulfur, mancozeb, metiram, propineb, thiram, captafol, folpet, chlorothalonil, dichlofluanid, dithianon.

Preference is also given to mixtures comprising an oligomer according to the invention (component 1) and at least one active substance selected from group I) (component 2) and particularly selected from carpropamid and fenoxanil.

Preference is also given to mixtures comprising an oligomer according to the invention (component 1) and at least one active substance selected from group J) (component 2) and particularly selected from acibenzolar-S-methyl, probenazole, tiadinil, fosetyl, fosetyl-aluminium, H₃PO₃ and salts thereof.

Preference is also given to mixtures comprising an oligomer according to the invention (component 1) and at least one active substance selected from group K) (component 2) and particularly selected from cymoxanil, proquinazid and N-methyl-2-{1-[(5-methyl-3-trifluoromethyl-1H-pyrazol-1-yl)-acetyl]-piperidin-4-yl}-N-[(1R)-1,2,3,4-tetrahydro-naphthalen-1-yl]-4-thiazolecarboxamide.

For pesticides II selected from groups L1), L3) and L5) in the mixtures embraces not only the isolated, pure cultures of the respective microorganisms as defined herein, but also its cell-free extract having pesticidal activity, preferably a ketone-based extract, its suspensions in a whole broth culture or as a metabolite-containing supernatant or a purified metabolite obtained from a whole broth culture of the microorganism or microorganism strain.

Accordingly, the present invention furthermore relates to mixtures comprising one oligomer formed from a monomer of formula I (component 1) and one pesticide II (component 2), which pesticide II is selected from the column “Co. 2” of the lines B-1 to B-810 of Table B.

A further embodiment relates to the mixtures B-1 to B-810 listed in Table B, where a row of Table B corresponds in each case to a fungicidal mixture comprising as active components one of the in the present specification individualized oligomers formed from a monomer of formula I (component 1), preferably oligomers I.B-1 to I.B-36 as defined herein; and the respective pesticide II from groups A) to O) (component 2) stated in the row in question. Preferably, the mixtures described comprise the active components in synergistically effective amounts.

With respect to their use as compenent 1) (Co. 1) in the inventive mixtures, preference is given to homooligomers I.B-1 to I.B-16 formed from a monomer of formula I.1, I.2, I.3 or I.4 and wherein the oligomer has a weight average molecular weight (M_{w}) and a molecular weight polydispersity index (PDI) as defined in each case in one row in the Table B.1 below.

TABLE B.1

| Co. 1 | monomer | M_{w} [g/mole] | PDI |
|---|---|---|---|
| I.B-1 | I.1 | 400 to 20,000 | 1.0 to 3.0 |
| I.B-2 | I.2 | 400 to 20,000 | 1.0 to 3.0 |
| I.B-3 | I.3 | 400 to 20,000 | 1.0 to 3.0 |
| I.B-4 | I.4 | 400 to 20,000 | 1.0 to 3.0 |
| I.B-5 | I.1 | 2,000 to 8,000 | 1.0 to 3.0 |
| I.B-6 | I.2 | 2,000 to 8,000 | 1.0 to 3.0 |
| I.B-7 | I.3 | 2,000 to 8,000 | 1.0 to 3.0 |
| I.B-8 | I.4 | 2,000 to 8,000 | 1.0 to 3.0 |
| I.B-9 | I.1 | 400 to 20,000 | 1.0 to 2.0 |
| I.B-10 | I.2 | 400 to 20,000 | 1.0 to 2.0 |
| I.B-11 | I.3 | 400 to 20,000 | 1.0 to 2.0 |
| I.B-12 | I.4 | 400 to 20,000 | 1.0 to 2.0 |
| I.B-13 | I.1 | 2,000 to 8,000 | 1.0 to 2.0 |
| I.B-14 | I.2 | 2,000 to 8,000 | 1.0 to 2.0 |
| I.B-15 | I.3 | 2,000 to 8,000 | 1.0 to 2.0 |
| I.B-16 | I.4 | 2,000 to 8,000 | 1.0 to 2.0 |

TABLE B
Mixtures comprising as active components one indiviualized
oligomer formed from a monomer of formula I (in Column Co.
1), preferably an oligomer selected from I.B-1 to I.B-16
as defined herein; and as component 2) (in Column Co. 2)
one pesticide II from groups A) to O) [which is coded
e.g. as (A.1.1) for azoxystrobin as defined above]:

| Mixt. | Co.1 | Co. 2 |
|---|---|---|
| B-1 | (I) | (A.1.1) |
| B-2 | (I) | (A.1.2) |
| B-3 | (I) | (A.1.3) |
| B-4 | (I) | (A.1.4) |
| B-5 | (I) | (A.1.5) |
| B-6 | (I) | (A.1.6) |
| B-7 | (I) | (A.1.7) |
| B-8 | (I) | (A.1.8) |
| B-9 | (I) | (A.1.9) |
| B-10 | (I) | (A.1.10) |
| B-11 | (I) | (A.1.11) |
| B-12 | (I) | (A.1.12) |
| B-13 | (I) | (A.1.13) |
| B-14 | (I) | (A.1.14) |
| B-15 | (I) | (A.1.15) |
| B-16 | (I) | (A.1.16) |
| B-17 | (I) | (A.1.17) |
| B-18 | (I) | (A.1.18) |
| B-19 | (I) | (A.1.19) |
| B-20 | (I) | (A.1.20) |
| B-21 | (I) | (A.1.21) |
| B-22 | (I) | (A.2.1) |
| B-23 | (I) | (A.2.2) |
| B-24 | (I) | (A.2.3) |
| B-25 | (I) | (A.2.4) |
| B-26 | (I) | (A.2.5) |
| B-27 | (I) | (A.2.6) |
| B-28 | (I) | (A.2.7) |
| B-29 | (I) | (A.3.1) |
| B-30 | (I) | (A.3.2) |
| B-31 | (I) | (A.3.3) |
| B-32 | (I) | (A.3.4) |
| B-33 | (I) | (A.3.5) |
| B-34 | (I) | (A.3.6) |
| B-35 | (I) | (A.3.7) |
| B-36 | (I) | (A.3.8) |
| B-37 | (I) | (A.3.9) |
| B-38 | (I) | (A.3.10) |
| B-39 | (I) | (A.3.11) |
| B-40 | (I) | (A.3.12) |
| B-41 | (I) | (A.3.13) |
| B-42 | (I) | (A.3.14) |
| B-43 | (I) | (A.3.15) |
| B-44 | (I) | (A.3.16) |
| B-45 | (I) | (A.3.17) |
| B-46 | (I) | (A.3.18) |
| B-47 | (I) | (A.3.19) |
| B-48 | (I) | (A.3.20) |
| B-49 | (I) | (A.3.21) |
| B-50 | (I) | (A.3.22) |
| B-51 | (I) | (A.3.23) |
| B-52 | (I) | (A.3.24) |
| B-53 | (I) | (A.3.25) |
| B-54 | (I) | (A.3.26) |
| B-55 | (I) | (A.3.27) |
| B-56 | (I) | (A.4.1) |
| B-57 | (I) | (A.4.2) |
| B-58 | (I) | (A.4.3) |
| B-59 | (I) | (A.4.4) |
| B-60 | (I) | (A.4.5) |
| B-61 | (I) | (A.4.6) |
| B-62 | (I) | (A.4.7) |
| B-63 | (I) | (A.4.8) |
| B-64 | (I) | (A.4.9) |
| B-65 | (I) | (A.4.10) |
| B-66 | (I) | (A.4.11) |
| B-67 | (I) | (A.4.12) |
| B-68 | (I) | (B.1.1) |
| B-69 | (I) | (B.1.2) |
| B-70 | (I) | (B.1.3) |
| B-71 | (I) | (B.1.4) |
| B-72 | (I) | (B.1.5) |
| B-73 | (I) | (B.1.6) |
| B-74 | (I) | (B.1.7) |
| B-75 | (I) | (B.1.8) |
| B-76 | (I) | (B.1.9) |
| B-77 | (I) | (B.1.10) |
| B-78 | (I) | (B.1.11) |
| B-79 | (I) | (B.1.12) |
| B-80 | (I) | (B.1.13) |
| B-81 | (I) | (B.1.14) |
| B-82 | (I) | (B.1.15) |
| B-83 | (I) | (B.1.16) |
| B-84 | (I) | (B.1.17) |
| B-85 | (I) | (B.1.18) |
| B-86 | (I) | (B.1.19) |
| B-87 | (I) | (B.1.20) |
| B-88 | (I) | (B.1.21) |
| B-89 | (I) | (B.1.22) |
| B-90 | (I) | (B.1.23) |
| B-91 | (I) | (B.1.24) |
| B-92 | (I) | (B.1.25) |
| B-93 | (I) | (B.1.26) |
| B-94 | (I) | (B.1.27) |
| B-95 | (I) | (B.1.28) |
| B-96 | (I) | (B.1.29) |
| B-97 | (I) | (B.1.30) |
| B-98 | (I) | (B.1.31) |
| B-99 | (I) | (B.1.32) |
| B-100 | (I) | (B.1.33) |
| B-101 | (I) | (B.1.34) |
| B-102 | (I) | (B.1.35) |
| B-103 | (I) | (B.1.36) |
| B-104 | (I) | (B.1.37) |
| B-105 | (I) | (B.1.38) |
| B-106 | (I) | (B.1.39) |
| B-107 | (I) | (B.1.40) |
| B-108 | (I) | (B.1.41) |
| B-109 | (I) | (B.1.42) |
| B-110 | (I) | (B.1.43) |
| B-111 | (I) | (B.1.44) |
| B-112 | (I) | (B.1.45) |
| B-113 | (I) | (B.1.46) |
| B-114 | (I) | (B.1.47) |
| B-115 | (I) | (B.1.48) |
| B-116 | (I) | (B.1.49) |
| B-117 | (I) | (B.1.50) |
| B-118 | (I) | (B.2.1) |
| B-119 | (I) | (B.2.2) |
| B-120 | (I) | (B.2.3) |
| B-121 | (I) | (B.2.4) |
| B-122 | (I) | (B.2.5) |
| B-123 | (I) | (B.2.6) |
| B-124 | (I) | (B.2.7) |
| B-125 | (I) | (B.2.8) |
| B-126 | (I) | (B.3.1) |
| B-127 | (I) | (C.1.1) |
| B-128 | (I) | (C.1.2) |
| B-129 | (I) | (C.1.3) |
| B-130 | (I) | (C.1.4) |
| B-131 | (I) | (C.1.5) |
| B-132 | (I) | (C.1.6) |
| B-133 | (I) | (C.1.7) |
| B-134 | (I) | (C.2.1) |
| B-135 | (I) | (C.2.2) |
| B-136 | (I) | (C.2.3) |
| B-137 | (I) | (C.2.4) |
| B-138 | (I) | (C.2.5) |
| B-139 | (I) | (C.2.6) |
| B-140 | (I) | (C.2.7) |
| B-141 | (I) | (D.1.1) |
| B-142 | (I) | (D.1.2) |
| B-143 | (I) | (D.1.3) |
| B-144 | (I) | (D.1.4) |
| B-145 | (I) | (D.1.5) |
| B-146 | (I) | (D.1.6) |
| B-147 | (I) | (D.2.1) |
| B-148 | (I) | (D.2.2) |
| B-149 | (I) | (D.2.3) |
| B-150 | (I) | (D.2.4) |
| B-151 | (I) | (D.2.5) |
| B-152 | (I) | (D.2.6) |
| B-153 | (I) | (D.2.7) |
| B-154 | (I) | (E.1.1) |
| B-155 | (I) | (E.1.2) |
| B-156 | (I) | (E.1.3) |
| B-157 | (I) | (E.2.1) |
| B-158 | (I) | (E.2.2) |
| B-159 | (I) | (E.2.3) |
| B-160 | (I) | (E.2.4) |
| B-161 | (I) | (E.2.5) |
| B-162 | (I) | (E.2.6) |
| B-163 | (I) | (E.2.7) |
| B-164 | (I) | (E.2.8) |
| B-165 | (I) | (F.1.1) |
| B-166 | (I) | (F.1.2) |
| B-167 | (I) | (F.1.3) |
| B-168 | (I) | (F.1.4) |
| B-169 | (I) | (F.1.5) |
| B-170 | (I) | (F.1.6) |
| B-171 | (I) | (F.2.1) |
| B-172 | (I) | (G.1.1) |
| B-173 | (I) | (G.1.2) |
| B-174 | (I) | (G.1.3) |
| B-175 | (I) | (G.1.4) |
| B-176 | (I) | (G.2.1) |
| B-177 | (I) | (G.2.2) |
| B-178 | (I) | (G.2.3) |
| B-179 | (I) | (G.2.4) |
| B-180 | (I) | (G.2.5) |
| B-181 | (I) | (G.2.6) |
| B-182 | (I) | (G.2.7) |
| B-183 | (I) | (G.3.1) |
| B-184 | (I) | (G.3.2) |
| B-185 | (I) | (G.3.3) |
| B-186 | (I) | (G.3.4) |
| B-187 | (I) | (G.3.5) |
| B-188 | (I) | (G.3.6) |
| B-189 | (I) | (G.3.7) |
| B-190 | (I) | (G.3.8) |
| B-191 | (I) | (G.4.1) |
| B-192 | (I) | (G.5.1) |
| B-193 | (I) | (H.1.1) |
| B-194 | (I) | (H.1.2) |
| B-195 | (I) | (H.1.3) |
| B-196 | (I) | (H.1.4) |
| B-197 | (I) | (H.1.5) |
| B-198 | (I) | (H.1.6) |
| B-199 | (I) | (H.2.1) |
| B-200 | (I) | (H.2.2) |
| B-201 | (I) | (H.2.3) |
| B-202 | (I) | (H.2.4) |
| B-203 | (I) | (H.2.5) |
| B-204 | (I) | (H.2.6) |
| B-205 | (I) | (H.2.7) |
| B-206 | (I) | (H.2.8) |
| B-207 | (I) | (H.2.9) |
| B-208 | (I) | (H.3.1) |
| B-209 | (I) | (H.3.2) |
| B-210 | (I) | (H.3.3) |
| B-211 | (I) | (H.3.4) |
| B-212 | (I) | (H.3.5) |
| B-213 | (I) | (H.3.6) |
| B-214 | (I) | (H.3.7) |
| B-215 | (I) | (H.3.8) |
| B-216 | (I) | (H.3.9) |
| B-217 | (I) | (H.3.10) |
| B-218 | (I) | (H.3.11) |
| B-219 | (I) | (H.4.1) |
| B-220 | (I) | (H.4.2) |
| B-221 | (I) | (H.4.3) |
| B-222 | (I) | (H.4.4) |
| B-223 | (I) | (H.4.5) |
| B-224 | (I) | (H.4.6) |
| B-225 | (I) | (H.4.7) |
| B-226 | (I) | (H.4.8) |
| B-227 | (I) | (H.4.9) |
| B-228 | (I) | (H.4.10) |
| B-229 | (I) | (I.1.1) |
| B-230 | (I) | (I.1.2) |
| B-231 | (I) | (I.2.1) |
| B-232 | (I) | (I.2.2) |
| B-233 | (I) | (I.2.3) |
| B-234 | (I) | (I.2.4) |
| B-235 | (I) | (I.2.5) |
| B-236 | (I) | (J.1.1) |
| B-237 | (I) | (J.1.2) |
| B-238 | (I) | (J.1.3) |
| B-239 | (I) | (J.1.4) |
| B-240 | (I) | (J.1.5) |
| B-241 | (I) | (J.1.6) |
| B-242 | (I) | (J.1.7) |
| B-243 | (I) | (J.1.8) |
| B-244 | (I) | (J.1.9) |
| B-245 | (I) | (K.1.1) |
| B-246 | (I) | (K.1.2) |
| B-247 | (I) | (K.1.3) |
| B-248 | (I) | (K.1.4) |
| B-249 | (I) | (K.1.5) |
| B-250 | (I) | (K.1.6) |
| B-251 | (I) | (K.1.7) |
| B-252 | (I) | (K.1.8) |
| B-253 | (I) | (K.1.9) |
| B-254 | (I) | (K.1.10) |
| B-255 | (I) | (K.1.11) |
| B-256 | (I) | (K.1.12) |
| B-257 | (I) | (K.1.13) |
| B-258 | (I) | (K.1.14) |
| B-259 | (I) | (K.1.15) |
| B-260 | (I) | (K.1.16) |
| B-261 | (I) | (K.1.17) |
| B-262 | (I) | (K.1.18) |
| B-263 | (I) | (K.1.19) |
| B-264 | (I) | (K.1.20) |
| B-265 | (I) | (K.1.21) |
| B-266 | (I) | (K.1.22) |
| B-267 | (I) | (K.1.23) |
| B-268 | (I) | (K.1.24) |
| B-269 | (I) | (K.1.25) |
| B-270 | (I) | (K.1.26) |
| B-271 | (I) | (K.1.27) |
| B-272 | (I) | (K.1.28) |
| B-273 | (I) | (K.1.29) |
| B-274 | (I) | (K.1.30) |
| B-275 | (I) | (K.1.31) |
| B-276 | (I) | (K.1.32) |
| B-277 | (I) | (K.1.33) |
| B-278 | (I) | (K.1.34) |
| B-279 | (I) | (K.1.35) |
| B-280 | (I) | (K.1.36) |
| B-281 | (I) | (K.1.37) |
| B-282 | (I) | (K.1.38) |
| B-283 | (I) | (K.1.39) |
| B-284 | (I) | (K.1.40) |
| B-285 | (I) | (K.1.41) |
| B-286 | (I) | (K.1.42) |
| B-287 | (I) | (K.1.43) |
| B-288 | (I) | (K.1.44) |
| B-289 | (I) | (K.1.45) |
| B-290 | (I) | (K.1.46) |
| B-291 | (I) | (K.1.47) |
| B-292 | (I) | (M.1.1) |
| B-293 | (I) | (M.1.2) |
| B-294 | (I) | (M.1.3) |
| B-295 | (I) | (M.1.4) |
| B-296 | (I) | (M.1.5) |
| B-297 | (I) | (M.1.6) |
| B-298 | (I) | (M.1.7) |
| B-299 | (I) | (M.1.8) |
| B-300 | (I) | (M.1.9) |
| B-301 | (I) | (M.1.10) |
| B-302 | (I) | (M.1.11) |
| B-303 | (I) | (M.1.12) |
| B-304 | (I) | (M.1.13) |
| B-305 | (I) | (M.1.14) |
| B-306 | (I) | (M.1.15) |
| B-307 | (I) | (M.1.16) |
| B-308 | (I) | (M.1.17) |
| B-309 | (I) | (M.1.18) |
| B-310 | (I) | (M.1.19) |
| B-311 | (I) | (M.1.20) |
| B-312 | (I) | (M.1.21) |
| B-313 | (I) | (M.1.22) |
| B-314 | (I) | (M.1.23) |
| B-315 | (I) | (M.1.24) |
| B-316 | (I) | (M.1.25) |
| B-317 | (I) | (M.1.26) |
| B-318 | (I) | (M.1.27) |
| B-319 | (I) | (M.1.28) |
| B-320 | (I) | (M.1.29) |
| B-321 | (I) | (M.1.30) |
| B-322 | (I) | (M.1.31) |
| B-323 | (I) | (M.1.32) |
| B-324 | (I) | (M.1.33) |
| B-325 | (I) | (M.1.34) |
| B-326 | (I) | (M.1.35) |
| B-327 | (I) | (M.1.36) |
| B-328 | (I) | (M.1.37) |
| B-329 | (I) | (M.1.38) |
| B-330 | (I) | (M.1.39) |
| B-331 | (I) | (M.1.40) |
| B-332 | (I) | (M.1.41) |
| B-333 | (I) | (M.1.42) |
| B-334 | (I) | (M.1.43) |
| B-335 | (I) | (M.1.44) |
| B-336 | (I) | (M.1.45) |
| B-337 | (I) | (M.1.46) |
| B-338 | (I) | (M.1.47) |
| B-339 | (I) | (M.1.48) |
| B-340 | (I) | (M.1.49) |
| B-341 | (I) | (M.1.50) |
| B-342 | (I) | (N.1.1) |
| B-343 | (I) | (N.1.2) |
| B-344 | (I) | (N.1.3) |
| B-345 | (I) | (N.1.4) |
| B-346 | (I) | (N.1.5) |
| B-347 | (I) | (N.2.1) |
| B-348 | (I) | (N.2.2) |
| B-349 | (I) | (N.2.3) |
| B-350 | (I) | (N.3.1) |
| B-351 | (I) | (N.3.2) |
| B-352 | (I) | (N.3.3) |
| B-353 | (I) | (N.3.4) |
| B-354 | (I) | (N.4.1) |
| B-355 | (I) | (N.5.1) |
| B-356 | (I) | (N.6.1) |
| B-357 | (I) | (N.6.2) |
| B-358 | (I) | (N.6.3) |
| B-359 | (I) | (N.6.4) |
| B-360 | (I) | (N.6.5) |
| B-361 | (I) | (N.7.1) |
| B-362 | (I) | (N.7.2) |
| B-363 | (I) | (N.7.3) |
| B-364 | (I) | (N.8.1) |
| B-365 | (I) | (N.9.1) |
| B-366 | (I) | (N.10.1) |
| B-367 | (I) | (N.10.2) |
| B-368 | (I) | (N.10.3) |
| B-369 | (I) | (N.10.4) |
| B-370 | (I) | (N.10.5) |
| B-371 | (I) | (N.11.1) |
| B-372 | (I) | (N.12.1) |
| B-373 | (I) | (N.12.2) |
| B-374 | (I) | (N.12.3) |
| B-375 | (I) | (N.12.4) |
| B-376 | (I) | (N.13.1) |
| B-377 | (I) | (N.13.2) |
| B-378 | (I) | (N.13.3) |
| B-379 | (I) | (N.13.4) |
| B-380 | (I) | (N.13.5) |
| B-381 | (I) | (N.13.6) |
| B-382 | (I) | (N.13.7) |
| B-383 | (I) | (N.13.8) |
| B-384 | (I) | (N.13.9) |
| B-385 | (I) | (N.14.1) |
| B-386 | (I) | (N.14.2) |
| B-387 | (I) | (N.15.1) |
| B-388 | (I) | (N.16.1) |
| B-389 | (I) | (N.16.2) |
| B-390 | (I) | (N.17.1) |
| B-391 | (I) | (N.17.2) |
| B-392 | (I) | (N.17.3) |
| B-393 | (I) | (N.17.4) |
| B-394 | (I) | (N.17.5) |
| B-395 | (I) | (N.17.6) |
| B-396 | (I) | (N.17.7) |
| B-397 | (I) | (N.17.8) |
| B-398 | (I) | (N.17.9) |
| B-399 | (I) | (N.17.10) |
| B-400 | (I) | (N.17.11) |
| B-401 | (I) | (N.17.12) |
| B-402 | (I) | (O.1.1) |
| B-403 | (I) | (O.1.2) |
| B-404 | (I) | (O.1.3) |
| B-405 | (I) | (O.1.4) |
| B-406 | (I) | (O.1.5) |
| B-407 | (I) | (O.1.6) |
| B-408 | (I) | (O.1.7) |
| B-409 | (I) | (O.1.8) |
| B-410 | (I) | (O.1.9) |
| B-411 | (I) | (O.1.10) |
| B-412 | (I) | (O.1.11) |
| B-413 | (I) | (O.1.12) |
| B-414 | (I) | (O.1.13) |
| B-415 | (I) | (O.1.14) |
| B-416 | (I) | (O.1.15) |
| B-417 | (I) | (O.1.16) |
| B-418 | (I) | (O.1.17) |
| B-419 | (I) | (O.1.18) |
| B-420 | (I) | (O.1.19) |
| B-421 | (I) | (O.1.20) |
| B-422 | (I) | (O.1.21) |
| B-423 | (I) | (O.1.22) |
| B-424 | (I) | (O.1.23) |
| B-425 | (I) | (O.1.24) |
| B-426 | (I) | (O.1.25) |
| B-427 | (I) | (O.1.26) |
| B-428 | (I) | (O.1.27) |
| B-429 | (I) | (O.1.28) |
| B-430 | (I) | (O.1.29) |
| B-431 | (I) | (O.1.30) |
| B-432 | (I) | (O.1.31) |
| B-433 | (I) | (O.1.32) |
| B-434 | (I) | (O.1.33) |
| B-435 | (I) | (O.1.34) |
| B-436 | (I) | (O.1.35) |
| B-437 | (I) | (O.1.36) |
| B-438 | (I) | (O.1.37) |
| B-439 | (I) | (O.1.38) |
| B-440 | (I) | (O.2.1) |
| B-441 | (I) | (O.2.2) |
| B-442 | (I) | (O.2.3) |
| B-443 | (I) | (O.2.4) |
| B-444 | (I) | (O.2.5) |
| B-445 | (I) | (O.2.6) |
| B-446 | (I) | (O.2.7) |
| B-447 | (I) | (O.2.8) |
| B-448 | (I) | (O.2.9) |
| B-449 | (I) | (O.2.10) |
| B-450 | (I) | (O.2.11) |
| B-451 | (I) | (O.2.12) |
| B-452 | (I) | (O.2.13) |
| B-453 | (I) | (O.2.14) |
| B-454 | (I) | (O.2.15) |
| B-455 | (I) | (O.2.16) |
| B-456 | (I) | (O.3.1) |
| B-457 | (I) | (O.3.2) |
| B-458 | (I) | (O.3.3) |
| B-459 | (I) | (O.3.4) |
| B-460 | (I) | (O.3.5) |
| B-461 | (I) | (O.3.6) |
| B-462 | (I) | (O.3.7) |
| B-463 | (I) | (O.3.8) |
| B-464 | (I) | (O.3.9) |
| B-465 | (I) | (O.3.10) |
| B-466 | (I) | (O.3.11) |
| B-467 | (I) | (O.3.12) |
| B-468 | (I) | (O.3.13) |
| B-469 | (I) | (O.3.14) |
| B-470 | (I) | (O.3.15) |
| B-471 | (I) | (O.3.16) |
| B-472 | (I) | (O.3.17) |
| B-473 | (I) | (O.3.18) |
| B-474 | (I) | (O.3.19) |
| B-475 | (I) | (O.3.20) |
| B-476 | (I) | (O.3.21) |
| B-477 | (I) | (O.3.22) |
| B-478 | (I) | (O.3.23) |
| B-479 | (I) | (O.3.24) |
| B-480 | (I) | (O.3.25) |
| B-481 | (I) | (O.3.26) |
| B-482 | (I) | (O.3.27) |
| B-483 | (I) | (O.4.1) |
| B-484 | (I) | (O.4.2) |
| B-485 | (I) | (O.4.3) |
| B-486 | (I) | (O.4.4) |
| B-487 | (I) | (O.4.5) |
| B-488 | (I) | (O.4.6) |
| B-489 | (I) | (O.4.7) |
| B-490 | (I) | (O.4.8) |
| B-491 | (I) | (O.4.9) |
| B-492 | (I) | (O.4.10) |
| B-493 | (I) | (O.4.11) |
| B-494 | (I) | (O.4.12) |
| B-495 | (I) | (O.4.13) |
| B-496 | (I) | (O.4.14) |
| B-497 | (I) | (O.4.15) |
| B-498 | (I) | (O.4.16) |
| B-499 | (I) | (O.4.17) |
| B-500 | (I) | (O.4.18) |
| B-501 | (I) | (O.4.19) |
| B-502 | (I) | (O.4.20) |
| B-503 | (I) | (O.4.21) |
| B-504 | (I) | (O.4.22) |
| B-505 | (I) | (O.4.23) |
| B-506 | (I) | (O.4.24) |
| B-507 | (I) | (O.5.1) |
| B-508 | (I) | (O.5.2) |
| B-509 | (I) | (O.5.3) |
| B-510 | (I) | (O.5.4) |
| B-511 | (I) | (O.5.5) |
| B-512 | (I) | (O.5.6) |
| B-513 | (I) | (O.5.7) |
| B-514 | (I) | (O.5.8) |
| B-515 | (I) | (O.5.9) |
| B-516 | (I) | (O.6.1) |
| B-517 | (I) | (O.6.2) |
| B-518 | (I) | (O.6.3) |
| B-519 | (I) | (O.6.4) |
| B-520 | (I) | (O.6.5) |
| B-521 | (I) | (O.6.6) |
| B-522 | (I) | (O.6.7) |
| B-523 | (I) | (O.7.1) |
| B-524 | (I) | (O.7.2) |
| B-525 | (I) | (O.7.3) |
| B-526 | (I) | (O.7.4) |
| B-527 | (I) | (O.7.5) |
| B-528 | (I) | (O.7.6) |
| B-529 | (I) | (O.8.1) |
| B-530 | (I) | (O.8.2) |
| B-531 | (I) | (O.8.3) |
| B-532 | (I) | (O.8.4) |
| B-533 | (I) | (O.8.5) |
| B-534 | (I) | (O.9.1) |
| B-535 | (I) | (O.9.2) |
| B-536 | (I) | (O.9.3) |
| B-537 | (I) | (O.10.1) |
| B-538 | (I) | (O.11.1) |
| B-539 | (I) | (O.11.2) |
| B-540 | (I) | (O.11.3) |
| B-541 | (I) | (O.11.4) |
| B-542 | (I) | (O.12.1) |
| B-543 | (I) | (O.13.1) |
| B-544 | (I) | (O.14.1) |
| B-545 | (I) | (O.14.2) |
| B-546 | (I) | (O.15.1) |
| B-547 | (I) | (O.15.2) |
| B-548 | (I) | (O.15.3) |
| B-549 | (I) | (O.15.4) |
| B-550 | (I) | (O.15.5) |
| B-551 | (I) | (O.15.6) |
| B-552 | (I) | (O.15.7) |
| B-553 | (I) | (O.15.8) |
| B-554 | (I) | (O.15.9) |
| B-555 | (I) | (O.15.10) |
| B-556 | (I) | (O.15.11) |
| B-557 | (I) | (O.16.1) |
| B-558 | (I) | (O.16.2) |
| B-559 | (I) | (O.16.3) |
| B-560 | (I) | (O.16.4) |
| B-561 | (I) | (O.16.5) |
| B-562 | (I) | (O.16.6) |
| B-563 | (I) | (L.1.1) |
| B-564 | (I) | (L.1.2) |
| B-565 | (I) | (L.1.3) |
| B-566 | (I) | (L.1.4) |
| B-567 | (I) | (L.1.5) |
| B-568 | (I) | (L.1.6) |
| B-569 | (I) | (L.1.7) |
| B-570 | (I) | (L.1.8) |
| B-571 | (I) | (L.1.9) |
| B-572 | (I) | (L.1.10) |
| B-573 | (I) | (L.1.11) |
| B-574 | (I) | (L.1.12) |
| B-575 | (I) | (L.1.13) |
| B-576 | (I) | (L.1.14) |
| B-577 | (I) | (L.1.15) |
| B-578 | (I) | (L.1.16) |
| B-579 | (I) | (L.1.17) |
| B-580 | (I) | (L.1.18) |
| B-581 | (I) | (L.1.19) |
| B-582 | (I) | (L.1.20) |
| B-583 | (I) | (L.1.21) |
| B-584 | (I) | (L.1.22) |
| B-585 | (I) | (L.1.23) |
| B-586 | (I) | (L.1.24) |
| B-587 | (I) | (L.1.25) |
| B-588 | (I) | (L.1.26) |
| B-589 | (I) | (L.1.27) |
| B-590 | (I) | (L.1.28) |
| B-591 | (I) | (L.1.29) |
| B-592 | (I) | (L.1.30) |
| B-593 | (I) | (L.1.31) |
| B-594 | (I) | (L.1.32) |
| B-595 | (I) | (L.1.33) |
| B-596 | (I) | (L.1.34) |
| B-597 | (I) | (L.1.35) |
| B-598 | (I) | (L.1.36) |
| B-599 | (I) | (L.1.37) |
| B-600 | (I) | (L.1.38) |
| B-601 | (I) | (L.1.39) |
| B-602 | (I) | (L.1.40) |
| B-603 | (I) | (L.1.41) |
| B-604 | (I) | (L.1.42) |
| B-605 | (I) | (L.1.43) |
| B-606 | (I) | (L.1.44) |
| B-607 | (I) | (L.1.45) |
| B-608 | (I) | (L.1.46) |
| B-609 | (I) | (L.1.47) |
| B-610 | (I) | (L.1.48) |
| B-611 | (I) | (L.1.49) |
| B-612 | (I) | (L.1.50) |
| B-613 | (I) | (L.1.51) |
| B-614 | (I) | (L.1.52) |
| B-615 | (I) | (L.1.53) |
| B-616 | (I) | (L.1.54) |
| B-617 | (I) | (L.1.55) |
| B-618 | (I) | (L.1.56) |
| B-619 | (I) | (L.1.57) |
| B-620 | (I) | (L.1.58) |
| B-621 | (I) | (L.1.59) |
| B-622 | (I) | (L.1.60) |
| B-623 | (I) | (L.1.61) |
| B-624 | (I) | (L.1.62) |
| B-625 | (I) | (L.1.63) |
| B-626 | (I) | (L.1.64) |
| B-627 | (I) | (L.1.65) |
| B-628 | (I) | (L.1.66) |
| B-629 | (I) | (L.1.67) |
| B-630 | (I) | (L.1.68) |
| B-631 | (I) | (L.1.69) |
| B-632 | (I) | (L.1.70) |
| B-633 | (I) | (L.1.71) |
| B-634 | (I) | (L.1.72) |
| B-635 | (I) | (L.1.73) |
| B-636 | (I) | (L.2.1) |
| B-637 | (I) | (L.2.2) |
| B-638 | (I) | (L.2.3) |
| B-639 | (I) | (L.2.4) |
| B-640 | (I) | (L.2.5) |
| B-641 | (I) | (L.2.6) |
| B-642 | (I) | (L.2.7) |
| B-643 | (I) | (L.2.8) |
| B-644 | (I) | (L.2.9) |
| B-645 | (I) | (L.2.10) |
| B-646 | (I) | (L.2.11) |
| B-647 | (I) | (L.3.1) |
| B-648 | (I) | (L.3.2) |
| B-649 | (I) | (L.3.3) |
| B-650 | (I) | (L.3.4) |
| B-651 | (I) | (L.3.5) |
| B-652 | (I) | (L.3.6) |
| B-653 | (I) | (L.3.7) |
| B-654 | (I) | (L.3.8) |
| B-655 | (I) | (L.3.9) |
| B-656 | (I) | (L.3.10) |
| B-657 | (I) | (L.3.11) |
| B-658 | (I) | (L.3.12) |
| B-659 | (I) | (L.3.13) |
| B-660 | (I) | (L.3.14) |
| B-661 | (I) | (L.3.15) |
| B-662 | (I) | (L.3.16) |
| B-663 | (I) | (L.3.17) |
| B-664 | (I) | (L.3.18) |
| B-665 | (I) | (L.3.19) |
| B-666 | (I) | (L.3.20) |
| B-667 | (I) | (L.3.21) |
| B-668 | (I) | (L.3.22) |
| B-669 | (I) | (L.3.23) |
| B-670 | (I) | (L.3.24) |
| B-671 | (I) | (L.3.25) |
| B-672 | (I) | (L.3.26) |
| B-673 | (I) | (L.3.27) |
| B-674 | (I) | (L.3.28) |
| B-675 | (I) | (L.3.29) |
| B-676 | (I) | (L.3.30) |
| B-677 | (I) | (L.3.31) |
| B-678 | (I) | (L.3.32) |
| B-679 | (I) | (L.3.33) |
| B-680 | (I) | (L.3.34) |
| B-681 | (I) | (L.3.35) |
| B-682 | (I) | (L.3.36) |
| B-683 | (I) | (L.3.37) |
| B-684 | (I) | (L.3.38) |
| B-685 | (I) | (L.3.39) |
| B-686 | (I) | (L.3.40) |
| B-687 | (I) | (L.3.41) |
| B-688 | (I) | (L.3.42) |
| B-689 | (I) | (L.3.43) |
| B-690 | (I) | (L.3.44) |
| B-691 | (I) | (L.3.45) |
| B-692 | (I) | (L.3.46) |
| B-693 | (I) | (L.3.47) |
| B-694 | (I) | (L.3.48) |
| B-695 | (I) | (L.3.49) |
| B-696 | (I) | (L.3.50) |
| B-697 | (I) | (L.3.51) |
| B-698 | (I) | (L.3.52) |
| B-699 | (I) | (L.3.53) |
| B-700 | (I) | (L.3.54) |
| B-701 | (I) | (L.3.55) |
| B-702 | (I) | (L.4.1) |
| B-703 | (I) | (L.4.2) |
| B-704 | (I) | (L.4.3) |
| B-705 | (I) | (L.4.4) |
| B-706 | (I) | (L.4.5) |
| B-707 | (I) | (L.4.6) |
| B-708 | (I) | (L.4.7) |
| B-709 | (I) | (L.4.8) |
| B-710 | (I) | (L.4.9) |
| B-711 | (I) | (L.4.10) |
| B-712 | (I) | (L.4.11) |
| B-713 | (I) | (L.4.12) |
| B-714 | (I) | (L.4.13) |
| B-715 | (I) | (L.4.14) |
| B-716 | (I) | (L.4.15) |
| B-717 | (I) | (L.4.16) |
| B-718 | (I) | (L.4.17) |
| B-719 | (I) | (L.4.18) |
| B-720 | (I) | (L.4.19) |
| B-721 | (I) | (L.4.20) |
| B-722 | (I) | (L.4.21) |
| B-723 | (I) | (L.4.22) |
| B-724 | (I) | (L.4.23) |
| B-725 | (I) | (L.4.24) |
| B-726 | (I) | (L.4.25) |
| B-727 | (I) | (L.4.26) |
| B-728 | (I) | (L.4.27) |
| B-729 | (I) | (L.4.28) |
| B-730 | (I) | (L.4.29) |
| B-731 | (I) | (L.4.30) |
| B-732 | (I) | (L.4.31) |
| B-733 | (I) | (L.4.32) |
| B-734 | (I) | (L.4.33) |
| B-735 | (I) | (L.5.1) |
| B-736 | (I) | (L.5.2) |
| B-737 | (I) | (L.5.3) |
| B-738 | (I) | (L.5.4) |
| B-739 | (I) | (L.5.5) |
| B-740 | (I) | (L.5.6) |
| B-741 | (I) | (L.5.7) |
| B-742 | (I) | (L.5.8) |
| B-743 | (I) | (L.5.9) |
| B-744 | (I) | (L.5.10) |
| B-745 | (I) | (L.5.11) |
| B-746 | (I) | (L.5.12) |
| B-747 | (I) | (L.5.13) |
| B-748 | (I) | (L.5.14) |
| B-749 | (I) | (L.5.15) |
| B-750 | (I) | (L.5.16) |
| B-751 | (I) | (L.5.17) |
| B-752 | (I) | (L.5.18) |
| B-753 | (I) | (L.5.19) |
| B-754 | (I) | (L.5.20) |
| B-755 | (I) | (L.5.21) |
| B-756 | (I) | (L.5.22) |
| B-757 | (I) | (L.5.23) |
| B-758 | (I) | (L.5.24) |
| B-759 | (I) | (L.5.25) |
| B-760 | (I) | (L.5.26) |
| B-761 | (I) | (L.5.27) |
| B-762 | (I) | (L.5.28) |
| B-763 | (I) | (L.5.29) |
| B-764 | (I) | (L.5.30) |
| B-765 | (I) | (L.5.31) |
| B-766 | (I) | (L.5.32) |
| B-767 | (I) | (L.5.33) |
| B-768 | (I) | (L.5.34) |
| B-769 | (I) | (L.5.35) |
| B-770 | (I) | (L.5.36) |
| B-771 | (I) | (L.5.37) |
| B-772 | (I) | (L.5.38) |
| B-773 | (I) | (L.5.39) |
| B-774 | (I) | (L.5.40) |
| B-775 | (I) | (L.5.41) |
| B-776 | (I) | (L.5.42) |
| B-777 | (I) | (L.5.43) |
| B-778 | (I) | (L.5.44) |
| B-779 | (I) | (L.5.45) |
| B-780 | (I) | (L.5.46) |
| B-781 | (I) | (L.5.47) |
| B-782 | (I) | (L.5.48) |
| B-783 | (I) | (L.5.49) |
| B-784 | (I) | (L.5.50) |
| B-785 | (I) | (L.5.51) |
| B-786 | (I) | (L.5.52) |
| B-787 | (I) | (L.5.53) |
| B-788 | (I) | (L.5.54) |
| B-789 | (I) | (L.5.55) |
| B-790 | (I) | (L.5.56) |
| B-791 | (I) | (L.5.57) |
| B-792 | (I) | (L.5.58) |
| B-793 | (I) | (L.5.59) |
| B-794 | (I) | (L.5.60) |
| B-795 | (I) | (L.6.1) |
| B-796 | (I) | (L.6.2) |
| B-797 | (I) | (L.6.3) |
| B-798 | (I) | (L.6.4) |
| B-799 | (I) | (L.6.5) |
| B-800 | (I) | (L.6.6) |
| B-801 | (I) | (L.6.7) |
| B-802 | (I) | (L.6.8) |
| B-803 | (I) | (L.6.9) |
| B-804 | (I) | (L.6.10) |
| B-805 | (I) | (L.6.11) |
| B-806 | (I) | (L.6.12) |
| B-807 | (I) | (L.6.13) |
| B-808 | (I) | (L.6.14) |
| B-809 | (I) | (L.6.15) |
| B-810 | (I) | (L.6.16) |

With respect to their use as compenent 3) (Co. 3) in the inventive ternary mixtures, preference is given to the pesticides III selected from lines B.III-1 to B.III-49 which are compiled in Table B.3 below.

TABLE B.3

| | |
|---|---|
| B.III-1 | Acibenzolar-S-Methyl |
| B.III-2 | Agri-Fos |
| B.III-3 | Ametoctradin |
| B.III-4 | Azoxystrobin |
| B.III-5 | Basic Copper Sulfate |
| B.III-6 | Boscalid |
| B.III-7 | Captan |
| B.III-8 | Chlorothalonil |
| B.III-9 | Cupric Hydroxide |
| B.III-10 | Cymoxanil |
| B.III-11 | Cyprodinil |
| B.III-12 | Difenoconazole |
| B.III-13 | Dimethomorph |
| B.III-14 | Famoxadone |
| B.III-15 | Fenamidone |
| B.III-16 | Fenbuconazole |
| B.III-17 | Fludioxonil |
| B.III-18 | Fluopyram |
| B.III-19 | Fluoxastrobin |
| B.III-20 | Flutriafol |
| B.III-21 | Fluxapyroxad |
| B.III-22 | Fosetyl Al |
| B.III-23 | Iprodione |
| B.III-24 | Kresoxim-Methyl |
| B.III-25 | Mancozeb |
| B.III-26 | Mandipromamid |
| B.III-27 | Mefenoxam |
| B.III-28 | Metalaxyl |
| B.III-29 | Metconazole |
| B.III-30 | Metiram |
| B.III-31 | Metrafenone |
| B.III-32 | Myclobutanil |
| B.III-33 | Penthiopyrad |
| B.III-34 | Phosphorous Acid |
| B.III-35 | Polyoxin D |
| B.III-36 | Propiconazole |
| B.III-37 | Prothioconazole |
| B.III-38 | Pyraclostrobin |
| B.III-39 | Pyrimethanil |
| B.III-40 | Quinoxyfen |
| B.III-41 | Streptomycin Sulfate |
| B.III-42 | Sulfur |
| B.III-43 | Tebuconazole |
| B.III-44 | Tetraconazole |
| B.III-45 | Thiophanate-methyl |
| B.III-46 | Trifloxystrobin |
| B.III-47 | Triphenyltin Hydroxide |
| B.III-48 | Triticonazole |
| B.III-49 | Ziram |

Accordingly, the present invention furthermore relates to the ternary mixtures as defined in Tables T.3.1 to T.3.49; wherein the combination of component 1) and component 2) in each case corresponds to one row T.3-1 to T.3-784 as defined in table T.3.1 and wherein component 3) (Co. 3) is selected from compounds B.III-1 to B.III-49 as compiled in table B.3. Preferably, the mixtures described comprise the active substances in synergistically effective amounts.

TABLE T.3.1

| Mixture | Co. 1 | Co. 2 | Co. 3 |
|---|---|---|---|
| T.3-1 | B.I-1 | B.III-1 | B.IIII-1 |
| T.3-2 | B.I-2 | B.III-1 | B.IIII-1 |
| T.3-3 | B.I-3 | B.III-1 | B.IIII-1 |
| T.3-4 | B.I-4 | B.III-1 | B.IIII-1 |
| T.3-5 | B.I-5 | B.III-1 | B.IIII-1 |
| T.3-6 | B.I-6 | B.III-1 | B.IIII-1 |
| T.3-7 | B.I-7 | B.III-1 | B.IIII-1 |
| T.3-8 | B.I-8 | B.III-1 | B.IIII-1 |
| T.3-9 | B.I-9 | B.III-1 | B.IIII-1 |
| T.3-10 | B.I-10 | B.III-1 | B.IIII-1 |
| T.3-11 | B.I-11 | B.III-1 | B.IIII-1 |
| T.3-12 | B.I-12 | B.III-1 | B.IIII-1 |
| T.3-13 | B.I-13 | B.III-1 | B.IIII-1 |
| T.3-14 | B.I-14 | B.III-1 | B.IIII-1 |
| T.3-15 | B.I-15 | B.III-1 | B.IIII-1 |
| T.3-16 | B.I-16 | B.III-1 | B.IIII-1 |
| T.3-17 | B.I-1 | B.III-2 | B.IIII-1 |
| T.3-18 | B.I-2 | B.III-2 | B.IIII-1 |
| T.3-19 | B.I-3 | B.III-2 | B.IIII-1 |
| T.3-20 | B.I-4 | B.III-2 | B.IIII-1 |
| T.3-21 | B.I-5 | B.III-2 | B.IIII-1 |
| T.3-22 | B.I-6 | B.III-2 | B.IIII-1 |
| T.3-23 | B.I-7 | B.III-2 | B.IIII-1 |
| T.3-24 | B.I-8 | B.III-2 | B.IIII-1 |
| T.3-25 | B.I-9 | B.III-2 | B.IIII-1 |
| T.3-26 | B.I-10 | B.III-2 | B.IIII-1 |
| T.3-27 | B.I-11 | B.III-2 | B.IIII-1 |
| T.3-28 | B.I-12 | B.III-2 | B.IIII-1 |
| T.3-29 | B.I-13 | B.III-2 | B.IIII-1 |
| T.3-30 | B.I-14 | B.III-2 | B.IIII-1 |
| T.3-31 | B.I-15 | B.III-2 | B.IIII-1 |
| T.3-32 | B.I-16 | B.III-2 | B.IIII-1 |
| T.3-33 | B.I-1 | B.III-3 | B.IIII-1 |
| T.3-34 | B.I-2 | B.III-3 | B.IIII-1 |
| T.3-35 | B.I-3 | B.III-3 | B.IIII-1 |
| T.3-36 | B.I-4 | B.III-3 | B.IIII-1 |
| T.3-37 | B.I-5 | B.III-3 | B.IIII-1 |
| T.3-38 | B.I-6 | B.III-3 | B.IIII-1 |
| T.3-39 | B.I-7 | B.III-3 | B.IIII-1 |
| T.3-40 | B.I-8 | B.III-3 | B.IIII-1 |
| T.3-41 | B.I-9 | B.III-3 | B.IIII-1 |
| T.3-42 | B.I-10 | B.III-3 | B.IIII-1 |
| T.3-43 | B.I-11 | B.III-3 | B.IIII-1 |
| T.3-44 | B.I-12 | B.III-3 | B.IIII-1 |
| T.3-45 | B.I-13 | B.III-3 | B.IIII-1 |
| T.3-46 | B.I-14 | B.III-3 | B.IIII-1 |
| T.3-47 | B.I-15 | B.III-3 | B.IIII-1 |
| T.3-48 | B.I-16 | B.III-3 | B.IIII-1 |
| T.3-49 | B.I-1 | B.III-4 | B.IIII-1 |
| T.3-50 | B.I-2 | B.III-4 | B.IIII-1 |
| T.3-51 | B.I-3 | B.III-4 | B.IIII-1 |
| T.3-52 | B.I-4 | B.III-4 | B.IIII-1 |
| T.3-53 | B.I-5 | B.III-4 | B.IIII-1 |
| T.3-54 | B.I-6 | B.III-4 | B.IIII-1 |
| T.3-55 | B.I-7 | B.III-4 | B.IIII-1 |
| T.3-56 | B.I-8 | B.III-4 | B.IIII-1 |
| T.3-57 | B.I-9 | B.III-4 | B.IIII-1 |
| T.3-58 | B.I-10 | B.III-4 | B.IIII-1 |
| T.3-59 | B.I-11 | B.III-4 | B.IIII-1 |
| T.3-60 | B.I-12 | B.III-4 | B.IIII-1 |
| T.3-61 | B.I-13 | B.III-4 | B.IIII-1 |
| T.3-62 | B.I-14 | B.III-4 | B.IIII-1 |
| T.3-63 | B.I-15 | B.III-4 | B.IIII-1 |
| T.3-64 | B.I-16 | B.III-4 | B.IIII-1 |
| T.3-65 | B.I-1 | B.III-5 | B.IIII-1 |
| T.3-66 | B.I-2 | B.III-5 | B.IIII-1 |
| T.3-67 | B.I-3 | B.III-5 | B.IIII-1 |
| T.3-68 | B.I-4 | B.III-5 | B.IIII-1 |
| T.3-69 | B.I-5 | B.III-5 | B.IIII-1 |
| T.3-70 | B.I-6 | B.III-5 | B.IIII-1 |
| T.3-71 | B.I-7 | B.III-5 | B.IIII-1 |
| T.3-72 | B.I-8 | B.III-5 | B.IIII-1 |
| T.3-73 | B.I-9 | B.III-5 | B.IIII-1 |
| T.3-74 | B.I-10 | B.III-5 | B.IIII-1 |
| T.3-75 | B.I-11 | B.III-5 | B.IIII-1 |
| T.3-76 | B.I-12 | B.III-5 | B.IIII-1 |
| T.3-77 | B.I-13 | B.III-5 | B.IIII-1 |
| T.3-78 | B.I-14 | B.III-5 | B.IIII-1 |
| T.3-79 | B.I-15 | B.III-5 | B.IIII-1 |
| T.3-80 | B.I-16 | B.III-5 | B.IIII-1 |
| T.3-81 | B.I-1 | B.III-6 | B.IIII-1 |
| T.3-82 | B.I-2 | B.III-6 | B.IIII-1 |
| T.3-83 | B.I-3 | B.III-6 | B.IIII-1 |
| T.3-84 | B.I-4 | B.III-6 | B.IIII-1 |
| T.3-85 | B.I-5 | B.III-6 | B.IIII-1 |
| T.3-86 | B.I-6 | B.III-6 | B.IIII-1 |
| T.3-87 | B.I-7 | B.III-6 | B.IIII-1 |
| T.3-88 | B.I-8 | B.III-6 | B.IIII-1 |
| T.3-89 | B.I-9 | B.III-6 | B.IIII-1 |
| T.3-90 | B.I-10 | B.III-6 | B.IIII-1 |
| T.3-91 | B.I-11 | B.III-6 | B.IIII-1 |
| T.3-92 | B.I-12 | B.III-6 | B.IIII-1 |
| T.3-93 | B.I-13 | B.III-6 | B.IIII-1 |
| T.3-94 | B.I-14 | B.III-6 | B.IIII-1 |
| T.3-95 | B.I-15 | B.III-6 | B.IIII-1 |
| T.3-96 | B.I-16 | B.III-6 | B.IIII-1 |
| T.3-97 | B.I-1 | B.III-7 | B.IIII-1 |
| T.3-98 | B.I-2 | B.III-7 | B.IIII-1 |
| T.3-99 | B.I-3 | B.III-7 | B.IIII-1 |
| T.3-100 | B.I-4 | B.III-7 | B.IIII-1 |
| T.3-101 | B.I-5 | B.III-7 | B.IIII-1 |
| T.3-102 | B.I-6 | B.III-7 | B.IIII-1 |
| T.3-103 | B.I-7 | B.III-7 | B.IIII-1 |
| T.3-104 | B.I-8 | B.III-7 | B.IIII-1 |
| T.3-105 | B.I-9 | B.III-7 | B.IIII-1 |
| T.3-106 | B.I-10 | B.III-7 | B.IIII-1 |
| T.3-107 | B.I-11 | B.III-7 | B.IIII-1 |
| T.3-108 | B.I-12 | B.III-7 | B.IIII-1 |
| T.3-109 | B.I-13 | B.III-7 | B.IIII-1 |
| T.3-110 | B.I-14 | B.III-7 | B.IIII-1 |
| T.3-111 | B.I-15 | B.III-7 | B.IIII-1 |
| T.3-112 | B.I-16 | B.III-7 | B.IIII-1 |
| T.3-113 | B.I-1 | B.III-8 | B.IIII-1 |
| T.3-114 | B.I-2 | B.III-8 | B.IIII-1 |
| T.3-115 | B.I-3 | B.III-8 | B.IIII-1 |
| T.3-116 | B.I-4 | B.III-8 | B.IIII-1 |
| T.3-117 | B.I-5 | B.III-8 | B.IIII-1 |
| T.3-118 | B.I-6 | B.III-8 | B.IIII-1 |
| T.3-119 | B.I-7 | B.III-8 | B.IIII-1 |
| T.3-120 | B.I-8 | B.III-8 | B.IIII-1 |
| T.3-121 | B.I-9 | B.III-8 | B.IIII-1 |
| T.3-122 | B.I-10 | B.III-8 | B.IIII-1 |
| T.3-123 | B.I-11 | B.III-8 | B.IIII-1 |
| T.3-124 | B.I-12 | B.III-8 | B.IIII-1 |
| T.3-125 | B.I-13 | B.III-8 | B.IIII-1 |
| T.3-126 | B.I-14 | B.III-8 | B.IIII-1 |
| T.3-127 | B.I-15 | B.III-8 | B.IIII-1 |
| T.3-128 | B.I-16 | B.III-8 | B.IIII-1 |
| T.3-129 | B.I-1 | B.III-9 | B.IIII-1 |
| T.3-130 | B.I-2 | B.III-9 | B.IIII-1 |
| T.3-131 | B.I-3 | B.III-9 | B.IIII-1 |
| T.3-132 | B.I-4 | B.III-9 | B.IIII-1 |
| T.3-133 | B.I-5 | B.III-9 | B.IIII-1 |
| T.3-134 | B.I-6 | B.III-9 | B.IIII-1 |
| T.3-135 | B.I-7 | B.III-9 | B.IIII-1 |
| T.3-136 | B.I-8 | B.III-9 | B.IIII-1 |
| T.3-137 | B.I-9 | B.III-9 | B.IIII-1 |
| T.3-138 | B.I-10 | B.III-9 | B.IIII-1 |
| T.3-139 | B.I-11 | B.III-9 | B.IIII-1 |
| T.3-140 | B.I-12 | B.III-9 | B.IIII-1 |
| T.3-141 | B.I-13 | B.III-9 | B.IIII-1 |
| T.3-142 | B.I-14 | B.III-9 | B.IIII-1 |
| T.3-143 | B.I-15 | B.III-9 | B.IIII-1 |
| T.3-144 | B.I-16 | B.III-9 | B.IIII-1 |
| T.3-145 | B.I-1 | B.III-10 | B.IIII-1 |
| T.3-146 | B.I-2 | B.III-10 | B.IIII-1 |
| T.3-147 | B.I-3 | B.III-10 | B.IIII-1 |
| T.3-148 | B.I-4 | B.III-10 | B.IIII-1 |
| T.3-149 | B.I-5 | B.III-10 | B.IIII-1 |
| T.3-150 | B.I-6 | B.III-10 | B.IIII-1 |
| T.3-151 | B.I-7 | B.III-10 | B.IIII-1 |
| T.3-152 | B.I-8 | B.III-10 | B.IIII-1 |
| T.3-153 | B.I-9 | B.III-10 | B.IIII-1 |
| T.3-154 | B.I-10 | B.III-10 | B.IIII-1 |
| T.3-155 | B.I-11 | B.III-10 | B.IIII-1 |
| T.3-156 | B.I-12 | B.III-10 | B.IIII-1 |
| T.3-157 | B.I-13 | B.III-10 | B.IIII-1 |
| T.3-158 | B.I-14 | B.III-10 | B.IIII-1 |
| T.3-159 | B.I-15 | B.III-10 | B.IIII-1 |
| T.3-160 | B.I-16 | B.III-10 | B.IIII-1 |
| T.3-161 | B.I-1 | B.III-11 | B.IIII-1 |
| T.3-162 | B.I-2 | B.III-11 | B.IIII-1 |
| T.3-163 | B.I-3 | B.III-11 | B.IIII-1 |
| T.3-164 | B.I-4 | B.III-11 | B.IIII-1 |
| T.3-165 | B.I-5 | B.III-11 | B.IIII-1 |
| T.3-166 | B.I-6 | B.III-11 | B.IIII-1 |
| T.3-167 | B.I-7 | B.III-11 | B.IIII-1 |
| T.3-168 | B.I-8 | B.III-11 | B.IIII-1 |
| T.3-169 | B.I-9 | B.III-11 | B.IIII-1 |
| T.3-170 | B.I-10 | B.III-11 | B.IIII-1 |
| T.3-171 | B.I-11 | B.III-11 | B.IIII-1 |
| T.3-172 | B.I-12 | B.III-11 | B.IIII-1 |
| T.3-173 | B.I-13 | B.III-11 | B.IIII-1 |
| T.3-174 | B.I-14 | B.III-11 | B.IIII-1 |
| T.3-175 | B.I-15 | B.III-11 | B.IIII-1 |
| T.3-176 | B.I-16 | B.III-11 | B.IIII-1 |
| T.3-177 | B.I-1 | B.III-12 | B.IIII-1 |
| T.3-178 | B.I-2 | B.III-12 | B.IIII-1 |
| T.3-179 | B.I-3 | B.III-12 | B.IIII-1 |
| T.3-180 | B.I-4 | B.III-12 | B.IIII-1 |
| T.3-181 | B.I-5 | B.III-12 | B.IIII-1 |
| T.3-182 | B.I-6 | B.III-12 | B.IIII-1 |
| T.3-183 | B.I-7 | B.III-12 | B.IIII-1 |
| T.3-184 | B.I-8 | B.III-12 | B.IIII-1 |
| T.3-185 | B.I-9 | B.III-12 | B.IIII-1 |
| T.3-186 | B.I-10 | B.III-12 | B.IIII-1 |
| T.3-187 | B.I-11 | B.III-12 | B.IIII-1 |
| T.3-188 | B.I-12 | B.III-12 | B.IIII-1 |
| T.3-189 | B.I-13 | B.III-12 | B.IIII-1 |
| T.3-190 | B.I-14 | B.III-12 | B.IIII-1 |
| T.3-191 | B.I-15 | B.III-12 | B.IIII-1 |
| T.3-192 | B.I-16 | B.III-12 | B.IIII-1 |
| T.3-193 | B.I-1 | B.III-13 | B.IIII-1 |
| T.3-194 | B.I-2 | B.III-13 | B.IIII-1 |
| T.3-195 | B.I-3 | B.III-13 | B.IIII-1 |
| T.3-196 | B.I-4 | B.III-13 | B.IIII-1 |
| T.3-197 | B.I-5 | B.III-13 | B.IIII-1 |
| T.3-198 | B.I-6 | B.III-13 | B.IIII-1 |
| T.3-199 | B.I-7 | B.III-13 | B.IIII-1 |
| T.3-200 | B.I-8 | B.III-13 | B.IIII-1 |
| T.3-201 | B.I-9 | B.III-13 | B.IIII-1 |
| T.3-202 | B.I-10 | B.III-13 | B.IIII-1 |
| T.3-203 | B.I-11 | B.III-13 | B.IIII-1 |
| T.3-204 | B.I-12 | B.III-13 | B.IIII-1 |
| T.3-205 | B.I-13 | B.III-13 | B.IIII-1 |
| T.3-206 | B.I-14 | B.III-13 | B.IIII-1 |
| T.3-207 | B.I-15 | B.III-13 | B.IIII-1 |
| T.3-208 | B.I-16 | B.III-13 | B.IIII-1 |
| T.3-209 | B.I-1 | B.III-14 | B.IIII-1 |
| T.3-210 | B.I-2 | B.III-14 | B.IIII-1 |
| T.3-211 | B.I-3 | B.III-14 | B.IIII-1 |
| T.3-212 | B.I-4 | B.III-14 | B.IIII-1 |
| T.3-213 | B.I-5 | B.III-14 | B.IIII-1 |
| T.3-214 | B.I-6 | B.III-14 | B.IIII-1 |
| T.3-215 | B.I-7 | B.III-14 | B.IIII-1 |
| T.3-216 | B.I-8 | B.III-14 | B.IIII-1 |
| T.3-217 | B.I-9 | B.III-14 | B.IIII-1 |
| T.3-218 | B.I-10 | B.III-14 | B.IIII-1 |
| T.3-219 | B.I-11 | B.III-14 | B.IIII-1 |
| T.3-220 | B.I-12 | B.III-14 | B.IIII-1 |
| T.3-221 | B.I-13 | B.III-14 | B.IIII-1 |
| T.3-222 | B.I-14 | B.III-14 | B.IIII-1 |
| T.3-223 | B.I-15 | B.III-14 | B.IIII-1 |
| T.3-224 | B.I-16 | B.III-14 | B.IIII-1 |
| T.3-225 | B.I-1 | B.III-15 | B.IIII-1 |
| T.3-226 | B.I-2 | B.III-15 | B.IIII-1 |
| T.3-227 | B.I-3 | B.III-15 | B.IIII-1 |
| T.3-228 | B.I-4 | B.III-15 | B.IIII-1 |
| T.3-229 | B.I-5 | B.III-15 | B.IIII-1 |
| T.3-230 | B.I-6 | B.III-15 | B.IIII-1 |
| T.3-231 | B.I-7 | B.III-15 | B.IIII-1 |
| T.3-232 | B.I-8 | B.III-15 | B.IIII-1 |
| T.3-233 | B.I-9 | B.III-15 | B.IIII-1 |
| T.3-234 | B.I-10 | B.III-15 | B.IIII-1 |
| T.3-235 | B.I-11 | B.III-15 | B.IIII-1 |
| T.3-236 | B.I-12 | B.III-15 | B.IIII-1 |
| T.3-237 | B.I-13 | B.III-15 | B.IIII-1 |
| T.3-238 | B.I-14 | B.III-15 | B.IIII-1 |
| T.3-239 | B.I-15 | B.III-15 | B.IIII-1 |
| T.3-240 | B.I-16 | B.III-15 | B.IIII-1 |
| T.3-241 | B.I-1 | B.III-16 | B.IIII-1 |
| T.3-242 | B.I-2 | B.III-16 | B.IIII-1 |
| T.3-243 | B.I-3 | B.III-16 | B.IIII-1 |
| T.3-244 | B.I-4 | B.III-16 | B.IIII-1 |
| T.3-245 | B.I-5 | B.III-16 | B.IIII-1 |
| T.3-246 | B.I-6 | B.III-16 | B.IIII-1 |
| T.3-247 | B.I-7 | B.III-16 | B.IIII-1 |
| T.3-248 | B.I-8 | B.III-16 | B.IIII-1 |
| T.3-249 | B.I-9 | B.III-16 | B.IIII-1 |
| T.3-250 | B.I-10 | B.III-16 | B.IIII-1 |
| T.3-251 | B.I-11 | B.III-16 | B.IIII-1 |
| T.3-252 | B.I-12 | B.III-16 | B.IIII-1 |
| T.3-253 | B.I-13 | B.III-16 | B.IIII-1 |
| T.3-254 | B.I-14 | B.III-16 | B.IIII-1 |
| T.3-255 | B.I-15 | B.III-16 | B.IIII-1 |
| T.3-256 | B.I-16 | B.III-16 | B.IIII-1 |
| T.3-257 | B.I-1 | B.III-17 | B.IIII-1 |
| T.3-258 | B.I-2 | B.III-17 | B.IIII-1 |
| T.3-259 | B.I-3 | B.III-17 | B.IIII-1 |
| T.3-260 | B.I-4 | B.III-17 | B.IIII-1 |
| T.3-261 | B.I-5 | B.III-17 | B.IIII-1 |
| T.3-262 | B.I-6 | B.III-17 | B.IIII-1 |
| T.3-263 | B.I-7 | B.III-17 | B.IIII-1 |
| T.3-264 | B.I-8 | B.III-17 | B.IIII-1 |
| T.3-265 | B.I-9 | B.III-17 | B.IIII-1 |
| T.3-266 | B.I-10 | B.III-17 | B.IIII-1 |
| T.3-267 | B.I-11 | B.III-17 | B.IIII-1 |
| T.3-268 | B.I-12 | B.III-17 | B.IIII-1 |
| T.3-269 | B.I-13 | B.III-17 | B.IIII-1 |
| T.3-270 | B.I-14 | B.III-17 | B.IIII-1 |
| T.3-271 | B.I-15 | B.III-17 | B.IIII-1 |
| T.3-272 | B.I-16 | B.III-17 | B.IIII-1 |
| T.3-273 | B.I-1 | B.III-18 | B.IIII-1 |
| T.3-274 | B.I-2 | B.III-18 | B.IIII-1 |
| T.3-275 | B.I-3 | B.III-18 | B.IIII-1 |
| T.3-276 | B.I-4 | B.III-18 | B.IIII-1 |
| T.3-277 | B.I-5 | B.III-18 | B.IIII-1 |
| T.3-278 | B.I-6 | B.III-18 | B.IIII-1 |
| T.3-279 | B.I-7 | B.III-18 | B.IIII-1 |
| T.3-280 | B.I-8 | B.III-18 | B.IIII-1 |
| T.3-281 | B.I-9 | B.III-18 | B.IIII-1 |
| T.3-282 | B.I-10 | B.III-18 | B.IIII-1 |
| T.3-283 | B.I-11 | B.III-18 | B.IIII-1 |
| T.3-284 | B.I-12 | B.III-18 | B.IIII-1 |
| T.3-285 | B.I-13 | B.III-18 | B.IIII-1 |
| T.3-286 | B.I-14 | B.III-18 | B.IIII-1 |
| T.3-287 | B.I-15 | B.III-18 | B.IIII-1 |
| T.3-288 | B.I-16 | B.III-18 | B.IIII-1 |
| T.3-289 | B.I-1 | B.III-19 | B.IIII-1 |
| T.3-290 | B.I-2 | B.III-19 | B.IIII-1 |
| T.3-291 | B.I-3 | B.III-19 | B.IIII-1 |
| T.3-292 | B.I-4 | B.III-19 | B.IIII-1 |
| T.3-293 | B.I-5 | B.III-19 | B.IIII-1 |
| T.3-294 | B.I-6 | B.III-19 | B.IIII-1 |
| T.3-295 | B.I-7 | B.III-19 | B.IIII-1 |
| T.3-296 | B.I-8 | B.III-19 | B.IIII-1 |
| T.3-297 | B.I-9 | B.III-19 | B.IIII-1 |
| T.3-298 | B.I-10 | B.III-19 | B.IIII-1 |
| T.3-299 | B.I-11 | B.III-19 | B.IIII-1 |
| T.3-300 | B.I-12 | B.III-19 | B.IIII-1 |
| T.3-301 | B.I-13 | B.III-19 | B.IIII-1 |
| T.3-302 | B.I-14 | B.III-19 | B.IIII-1 |
| T.3-303 | B.I-15 | B.III-19 | B.IIII-1 |
| T.3-304 | B.I-16 | B.III-19 | B.IIII-1 |
| T.3-305 | B.I-1 | B.III-20 | B.IIII-1 |
| T.3-306 | B.I-2 | B.III-20 | B.IIII-1 |
| T.3-307 | B.I-3 | B.III-20 | B.IIII-1 |
| T.3-308 | B.I-4 | B.III-20 | B.IIII-1 |
| T.3-309 | B.I-5 | B.III-20 | B.IIII-1 |
| T.3-310 | B.I-6 | B.III-20 | B.IIII-1 |
| T.3-311 | B.I-7 | B.III-20 | B.IIII-1 |
| T.3-312 | B.I-8 | B.III-20 | B.IIII-1 |
| T.3-313 | B.I-9 | B.III-20 | B.IIII-1 |
| T.3-314 | B.I-10 | B.III-20 | B.IIII-1 |
| T.3-315 | B.I-11 | B.III-20 | B.IIII-1 |
| T.3-316 | B.I-12 | B.III-20 | B.IIII-1 |
| T.3-317 | B.I-13 | B.III-20 | B.IIII-1 |
| T.3-318 | B.I-14 | B.III-20 | B.IIII-1 |
| T.3-319 | B.I-15 | B.III-20 | B.IIII-1 |
| T.3-320 | B.I-16 | B.III-20 | B.IIII-1 |
| T.3-321 | B.I-1 | B.III-21 | B.IIII-1 |
| T.3-322 | B.I-2 | B.III-21 | B.IIII-1 |
| T.3-323 | B.I-3 | B.III-21 | B.IIII-1 |
| T.3-324 | B.I-4 | B.III-21 | B.IIII-1 |
| T.3-325 | B.I-5 | B.III-21 | B.IIII-1 |
| T.3-326 | B.I-6 | B.III-21 | B.IIII-1 |
| T.3-327 | B.I-7 | B.III-21 | B.IIII-1 |
| T.3-328 | B.I-8 | B.III-21 | B.IIII-1 |
| T.3-329 | B.I-9 | B.III-21 | B.IIII-1 |
| T.3-330 | B.I-10 | B.III-21 | B.IIII-1 |
| T.3-331 | B.I-11 | B.III-21 | B.IIII-1 |
| T.3-332 | B.I-12 | B.III-21 | B.IIII-1 |
| T.3-333 | B.I-13 | B.III-21 | B.IIII-1 |
| T.3-334 | B.I-14 | B.III-21 | B.IIII-1 |
| T.3-335 | B.I-15 | B.III-21 | B.IIII-1 |
| T.3-336 | B.I-16 | B.III-21 | B.IIII-1 |
| T.3-337 | B.I-1 | B.III-22 | B.IIII-1 |
| T.3-338 | B.I-2 | B.III-22 | B.IIII-1 |
| T.3-339 | B.I-3 | B.III-22 | B.IIII-1 |
| T.3-340 | B.I-4 | B.III-22 | B.IIII-1 |
| T.3-341 | B.I-5 | B.III-22 | B.IIII-1 |
| T.3-342 | B.I-6 | B.III-22 | B.IIII-1 |
| T.3-343 | B.I-7 | B.III-22 | B.IIII-1 |
| T.3-344 | B.I-8 | B.III-22 | B.IIII-1 |
| T.3-345 | B.I-9 | B.III-22 | B.IIII-1 |
| T.3-346 | B.I-10 | B.III-22 | B.IIII-1 |
| T.3-347 | B.I-11 | B.III-22 | B.IIII-1 |
| T.3-348 | B.I-12 | B.III-22 | B.IIII-1 |
| T.3-349 | B.I-13 | B.III-22 | B.IIII-1 |
| T.3-350 | B.I-14 | B.III-22 | B.IIII-1 |
| T.3-351 | B.I-15 | B.III-22 | B.IIII-1 |
| T.3-352 | B.I-16 | B.III-22 | B.IIII-1 |
| T.3-353 | B.I-1 | B.III-23 | B.IIII-1 |
| T.3-354 | B.I-2 | B.III-23 | B.IIII-1 |
| T.3-355 | B.I-3 | B.III-23 | B.IIII-1 |
| T.3-356 | B.I-4 | B.III-23 | B.IIII-1 |
| T.3-357 | B.I-5 | B.III-23 | B.IIII-1 |
| T.3-358 | B.I-6 | B.III-23 | B.IIII-1 |
| T.3-359 | B.I-7 | B.III-23 | B.IIII-1 |
| T.3-360 | B.I-8 | B.III-23 | B.IIII-1 |
| T.3-361 | B.I-9 | B.III-23 | B.IIII-1 |
| T.3-362 | B.I-10 | B.III-23 | B.IIII-1 |
| T.3-363 | B.I-11 | B.III-23 | B.IIII-1 |
| T.3-364 | B.I-12 | B.III-23 | B.IIII-1 |
| T.3-365 | B.I-13 | B.III-23 | B.IIII-1 |
| T.3-366 | B.I-14 | B.III-23 | B.IIII-1 |
| T.3-367 | B.I-15 | B.III-23 | B.IIII-1 |
| T.3-368 | B.I-16 | B.III-23 | B.IIII-1 |
| T.3-369 | B.I-1 | B.III-24 | B.IIII-1 |
| T.3-370 | B.I-2 | B.III-24 | B.IIII-1 |
| T.3-371 | B.I-3 | B.III-24 | B.IIII-1 |
| T.3-372 | B.I-4 | B.III-24 | B.IIII-1 |
| T.3-373 | B.I-5 | B.III-24 | B.IIII-1 |
| T.3-374 | B.I-6 | B.III-24 | B.IIII-1 |
| T.3-375 | B.I-7 | B.III-24 | B.IIII-1 |
| T.3-376 | B.I-8 | B.III-24 | B.IIII-1 |
| T.3-377 | B.I-9 | B.III-24 | B.IIII-1 |
| T.3-378 | B.I-10 | B.III-24 | B.IIII-1 |
| T.3-379 | B.I-11 | B.III-24 | B.IIII-1 |
| T.3-380 | B.I-12 | B.III-24 | B.IIII-1 |
| T.3-381 | B.I-13 | B.III-24 | B.IIII-1 |
| T.3-382 | B.I-14 | B.III-24 | B.IIII-1 |
| T.3-383 | B.I-15 | B.III-24 | B.IIII-1 |
| T.3-384 | B.I-16 | B.III-24 | B.IIII-1 |
| T.3-385 | B.I-1 | B.III-25 | B.IIII-1 |
| T.3-386 | B.I-2 | B.III-25 | B.IIII-1 |
| T.3-387 | B.I-3 | B.III-25 | B.IIII-1 |
| T.3-388 | B.I-4 | B.III-25 | B.IIII-1 |
| T.3-389 | B.I-5 | B.III-25 | B.IIII-1 |
| T.3-390 | B.I-6 | B.III-25 | B.IIII-1 |
| T.3-391 | B.I-7 | B.III-25 | B.IIII-1 |
| T.3-392 | B.I-8 | B.III-25 | B.IIII-1 |
| T.3-393 | B.I-9 | B.III-25 | B.IIII-1 |
| T.3-394 | B.I-10 | B.III-25 | B.IIII-1 |
| T.3-395 | B.I-11 | B.III-25 | B.IIII-1 |
| T.3-396 | B.I-12 | B.III-25 | B.IIII-1 |
| T.3-397 | B.I-13 | B.III-25 | B.IIII-1 |
| T.3-398 | B.I-14 | B.III-25 | B.IIII-1 |
| T.3-399 | B.I-15 | B.III-25 | B.IIII-1 |
| T.3-400 | B.I-16 | B.III-25 | B.IIII-1 |
| T.3-401 | B.I-1 | B.III-26 | B.IIII-1 |
| T.3-402 | B.I-2 | B.III-26 | B.IIII-1 |
| T.3-403 | B.I-3 | B.III-26 | B.IIII-1 |
| T.3-404 | B.I-4 | B.III-26 | B.IIII-1 |
| T.3-405 | B.I-5 | B.III-26 | B.IIII-1 |
| T.3-406 | B.I-6 | B.III-26 | B.IIII-1 |
| T.3-407 | B.I-7 | B.III-26 | B.IIII-1 |
| T.3-408 | B.I-8 | B.III-26 | B.IIII-1 |
| T.3-409 | B.I-9 | B.III-26 | B.IIII-1 |
| T.3-410 | B.I-10 | B.III-26 | B.IIII-1 |
| T.3-411 | B.I-11 | B.III-26 | B.IIII-1 |
| T.3-412 | B.I-12 | B.III-26 | B.IIII-1 |
| T.3-413 | B.I-13 | B.III-26 | B.IIII-1 |
| T.3-414 | B.I-14 | B.III-26 | B.IIII-1 |
| T.3-415 | B.I-15 | B.III-26 | B.IIII-1 |
| T.3-416 | B.I-16 | B.III-26 | B.IIII-1 |
| T.3-417 | B.I-1 | B.III-27 | B.IIII-1 |
| T.3-418 | B.I-2 | B.III-27 | B.IIII-1 |
| T.3-419 | B.I-3 | B.III-27 | B.IIII-1 |
| T.3-420 | B.I-4 | B.III-27 | B.IIII-1 |
| T.3-421 | B.I-5 | B.III-27 | B.IIII-1 |
| T.3-422 | B.I-6 | B.III-27 | B.IIII-1 |
| T.3-423 | B.I-7 | B.III-27 | B.IIII-1 |
| T.3-424 | B.I-8 | B.III-27 | B.IIII-1 |
| T.3-425 | B.I-9 | B.III-27 | B.IIII-1 |
| T.3-426 | B.I-10 | B.III-27 | B.IIII-1 |
| T.3-427 | B.I-11 | B.III-27 | B.IIII-1 |
| T.3-428 | B.I-12 | B.III-27 | B.IIII-1 |
| T.3-429 | B.I-13 | B.III-27 | B.IIII-1 |
| T.3-430 | B.I-14 | B.III-27 | B.IIII-1 |
| T.3-431 | B.I-15 | B.III-27 | B.IIII-1 |
| T.3-432 | B.I-16 | B.III-27 | B.IIII-1 |
| T.3-433 | B.I-1 | B.III-28 | B.IIII-1 |
| T.3-434 | B.I-2 | B.III-28 | B.IIII-1 |
| T.3-435 | B.I-3 | B.III-28 | B.IIII-1 |
| T.3-436 | B.I-4 | B.III-28 | B.IIII-1 |
| T.3-437 | B.I-5 | B.III-28 | B.IIII-1 |
| T.3-438 | B.I-6 | B.III-28 | B.IIII-1 |
| T.3-439 | B.I-7 | B.III-28 | B.IIII-1 |
| T.3-440 | B.I-8 | B.III-28 | B.IIII-1 |
| T.3-441 | B.I-9 | B.III-28 | B.IIII-1 |
| T.3-442 | B.I-10 | B.III-28 | B.IIII-1 |
| T.3-443 | B.I-11 | B.III-28 | B.IIII-1 |
| T.3-444 | B.I-12 | B.III-28 | B.IIII-1 |
| T.3-445 | B.I-13 | B.III-28 | B.IIII-1 |
| T.3-446 | B.I-14 | B.III-28 | B.IIII-1 |
| T.3-447 | B.I-15 | B.III-28 | B.IIII-1 |
| T.3-448 | B.I-16 | B.III-28 | B.IIII-1 |
| T.3-449 | B.I-1 | B.III-29 | B.IIII-1 |
| T.3-450 | B.I-2 | B.III-29 | B.IIII-1 |
| T.3-451 | B.I-3 | B.III-29 | B.IIII-1 |
| T.3-452 | B.I-4 | B.III-29 | B.IIII-1 |
| T.3-453 | B.I-5 | B.III-29 | B.IIII-1 |
| T.3-454 | B.I-6 | B.III-29 | B.IIII-1 |
| T.3-455 | B.I-7 | B.III-29 | B.IIII-1 |
| T.3-456 | B.I-8 | B.III-29 | B.IIII-1 |
| T.3-457 | B.I-9 | B.III-29 | B.IIII-1 |
| T.3-458 | B.I-10 | B.III-29 | B.IIII-1 |
| T.3-459 | B.I-11 | B.III-29 | B.IIII-1 |
| T.3-460 | B.I-12 | B.III-29 | B.IIII-1 |
| T.3-461 | B.I-13 | B.III-29 | B.IIII-1 |
| T.3-462 | B.I-14 | B.III-29 | B.IIII-1 |
| T.3-463 | B.I-15 | B.III-29 | B.IIII-1 |
| T.3-464 | B.I-16 | B.III-29 | B.IIII-1 |
| T.3-465 | B.I-1 | B.III-30 | B.IIII-1 |
| T.3-466 | B.I-2 | B.III-30 | B.IIII-1 |
| T.3-467 | B.I-3 | B.III-30 | B.IIII-1 |
| T.3-468 | B.I-4 | B.III-30 | B.IIII-1 |
| T.3-469 | B.I-5 | B.III-30 | B.IIII-1 |
| T.3-470 | B.I-6 | B.III-30 | B.IIII-1 |
| T.3-471 | B.I-7 | B.III-30 | B.IIII-1 |
| T.3-472 | B.I-8 | B.III-30 | B.IIII-1 |
| T.3-473 | B.I-9 | B.III-30 | B.IIII-1 |
| T.3-474 | B.I-10 | B.III-30 | B.IIII-1 |
| T.3-475 | B.I-11 | B.III-30 | B.IIII-1 |
| T.3-476 | B.I-12 | B.III-30 | B.IIII-1 |
| T.3-477 | B.I-13 | B.III-30 | B.IIII-1 |
| T.3-478 | B.I-14 | B.III-30 | B.IIII-1 |
| T.3-479 | B.I-15 | B.III-30 | B.IIII-1 |
| T.3-480 | B.I-16 | B.III-30 | B.IIII-1 |
| T.3-481 | B.I-1 | B.III-31 | B.IIII-1 |
| T.3-482 | B.I-2 | B.III-31 | B.IIII-1 |
| T.3-483 | B.I-3 | B.III-31 | B.IIII-1 |
| T.3-484 | B.I-4 | B.III-31 | B.IIII-1 |
| T.3-485 | B.I-5 | B.III-31 | B.IIII-1 |
| T.3-486 | B.I-6 | B.III-31 | B.IIII-1 |
| T.3-487 | B.I-7 | B.III-31 | B.IIII-1 |
| T.3-488 | B.I-8 | B.III-31 | B.IIII-1 |
| T.3-489 | B.I-9 | B.III-31 | B.IIII-1 |
| T.3-490 | B.I-10 | B.III-31 | B.IIII-1 |
| T.3-491 | B.I-11 | B.III-31 | B.IIII-1 |
| T.3-492 | B.I-12 | B.III-31 | B.IIII-1 |
| T.3-493 | B.I-13 | B.III-31 | B.IIII-1 |
| T.3-494 | B.I-14 | B.III-31 | B.IIII-1 |
| T.3-495 | B.I-15 | B.III-31 | B.IIII-1 |
| T.3-496 | B.I-16 | B.III-31 | B.IIII-1 |
| T.3-497 | B.I-1 | B.III-32 | B.IIII-1 |
| T.3-498 | B.I-2 | B.III-32 | B.IIII-1 |
| T.3-499 | B.I-3 | B.III-32 | B.IIII-1 |
| T.3-500 | B.I-4 | B.III-32 | B.IIII-1 |
| T.3-501 | B.I-5 | B.III-32 | B.IIII-1 |
| T.3-502 | B.I-6 | B.III-32 | B.IIII-1 |
| T.3-503 | B.I-7 | B.III-32 | B.IIII-1 |
| T.3-504 | B.I-8 | B.III-32 | B.IIII-1 |
| T.3-505 | B.I-9 | B.III-32 | B.IIII-1 |
| T.3-506 | B.I-10 | B.III-32 | B.IIII-1 |
| T.3-507 | B.I-11 | B.III-32 | B.IIII-1 |
| T.3-508 | B.I-12 | B.III-32 | B.IIII-1 |
| T.3-509 | B.I-13 | B.III-32 | B.IIII-1 |
| T.3-510 | B.I-14 | B.III-32 | B.IIII-1 |
| T.3-511 | B.I-15 | B.III-32 | B.IIII-1 |
| T.3-512 | B.I-16 | B.III-32 | B.IIII-1 |
| T.3-513 | B.I-1 | B.III-33 | B.IIII-1 |
| T.3-514 | B.I-2 | B.III-33 | B.IIII-1 |
| T.3-515 | B.I-3 | B.III-33 | B.IIII-1 |
| T.3-516 | B.I-4 | B.III-33 | B.IIII-1 |
| T.3-517 | B.I-5 | B.III-33 | B.IIII-1 |
| T.3-518 | B.I-6 | B.III-33 | B.IIII-1 |
| T.3-519 | B.I-7 | B.III-33 | B.IIII-1 |
| T.3-520 | B.I-8 | B.III-33 | B.IIII-1 |
| T.3-521 | B.I-9 | B.III-33 | B.IIII-1 |
| T.3-522 | B.I-10 | B.III-33 | B.IIII-1 |
| T.3-523 | B.I-11 | B.III-33 | B.IIII-1 |
| T.3-524 | B.I-12 | B.III-33 | B.IIII-1 |
| T.3-525 | B.I-13 | B.III-33 | B.IIII-1 |
| T.3-526 | B.I-14 | B.III-33 | B.IIII-1 |
| T.3-527 | B.I-15 | B.III-33 | B.IIII-1 |
| T.3-528 | B.I-16 | B.III-33 | B.IIII-1 |
| T.3-529 | B.I-1 | B.III-34 | B.IIII-1 |
| T.3-530 | B.I-2 | B.III-34 | B.IIII-1 |
| T.3-531 | B.I-3 | B.III-34 | B.IIII-1 |
| T.3-532 | B.I-4 | B.III-34 | B.IIII-1 |
| T.3-533 | B.I-5 | B.III-34 | B.IIII-1 |
| T.3-534 | B.I-6 | B.III-34 | B.IIII-1 |
| T.3-535 | B.I-7 | B.III-34 | B.IIII-1 |
| T.3-536 | B.I-8 | B.III-34 | B.IIII-1 |
| T.3-537 | B.I-9 | B.III-34 | B.IIII-1 |
| T.3-538 | B.I-10 | B.III-34 | B.IIII-1 |
| T.3-539 | B.I-11 | B.III-34 | B.IIII-1 |
| T.3-540 | B.I-12 | B.III-34 | B.IIII-1 |
| T.3-541 | B.I-13 | B.III-34 | B.IIII-1 |
| T.3-542 | B.I-14 | B.III-34 | B.IIII-1 |
| T.3-543 | B.I-15 | B.III-34 | B.IIII-1 |
| T.3-544 | B.I-16 | B.III-34 | B.IIII-1 |
| T.3-545 | B.I-1 | B.III-35 | B.IIII-1 |
| T.3-546 | B.I-2 | B.III-35 | B.IIII-1 |
| T.3-547 | B.I-3 | B.III-35 | B.IIII-1 |
| T.3-548 | B.I-4 | B.III-35 | B.IIII-1 |
| T.3-549 | B.I-5 | B.III-35 | B.IIII-1 |
| T.3-550 | B.I-6 | B.III-35 | B.IIII-1 |
| T.3-551 | B.I-7 | B.III-35 | B.IIII-1 |
| T.3-552 | B.I-8 | B.III-35 | B.IIII-1 |
| T.3-553 | B.I-9 | B.III-35 | B.IIII-1 |
| T.3-554 | B.I-10 | B.III-35 | B.IIII-1 |
| T.3-555 | B.I-11 | B.III-35 | B.IIII-1 |
| T.3-556 | B.I-12 | B.III-35 | B.IIII-1 |
| T.3-557 | B.I-13 | B.III-35 | B.IIII-1 |
| T.3-558 | B.I-14 | B.III-35 | B.IIII-1 |
| T.3-559 | B.I-15 | B.III-35 | B.IIII-1 |
| T.3-560 | B.I-16 | B.III-35 | B.IIII-1 |
| T.3-561 | B.I-1 | B.III-36 | B.IIII-1 |
| T.3-562 | B.I-2 | B.III-36 | B.IIII-1 |
| T.3-563 | B.I-3 | B.III-36 | B.IIII-1 |
| T.3-564 | B.I-4 | B.III-36 | B.IIII-1 |
| T.3-565 | B.I-5 | B.III-36 | B.IIII-1 |
| T.3-566 | B.I-6 | B.III-36 | B.IIII-1 |
| T.3-567 | B.I-7 | B.III-36 | B.IIII-1 |
| T.3-568 | B.I-8 | B.III-36 | B.IIII-1 |
| T.3-569 | B.I-9 | B.III-36 | B.IIII-1 |
| T.3-570 | B.I-10 | B.III-36 | B.IIII-1 |
| T.3-571 | B.I-11 | B.III-36 | B.IIII-1 |
| T.3-572 | B.I-12 | B.III-36 | B.IIII-1 |
| T.3-573 | B.I-13 | B.III-36 | B.IIII-1 |
| T.3-574 | B.I-14 | B.III-36 | B.IIII-1 |
| T.3-575 | B.I-15 | B.III-36 | B.IIII-1 |
| T.3-576 | B.I-16 | B.III-36 | B.IIII-1 |
| T.3-577 | B.I-1 | B.III-37 | B.IIII-1 |
| T.3-578 | B.I-2 | B.III-37 | B.IIII-1 |
| T.3-579 | B.I-3 | B.III-37 | B.IIII-1 |
| T.3-580 | B.I-4 | B.III-37 | B.IIII-1 |
| T.3-581 | B.I-5 | B.III-37 | B.IIII-1 |
| T.3-582 | B.I-6 | B.III-37 | B.IIII-1 |
| T.3-583 | B.I-7 | B.III-37 | B.IIII-1 |
| T.3-584 | B.I-8 | B.III-37 | B.IIII-1 |
| T.3-585 | B.I-9 | B.III-37 | B.IIII-1 |
| T.3-586 | B.I-10 | B.III-37 | B.IIII-1 |
| T.3-587 | B.I-11 | B.III-37 | B.IIII-1 |
| T.3-588 | B.I-12 | B.III-37 | B.IIII-1 |
| T.3-589 | B.I-13 | B.III-37 | B.IIII-1 |
| T.3-590 | B.I-14 | B.III-37 | B.IIII-1 |
| T.3-591 | B.I-15 | B.III-37 | B.IIII-1 |
| T.3-592 | B.I-16 | B.III-37 | B.IIII-1 |
| T.3-593 | B.I-1 | B.III-38 | B.IIII-1 |
| T.3-594 | B.I-2 | B.III-38 | B.IIII-1 |
| T.3-595 | B.I-3 | B.III-38 | B.IIII-1 |
| T.3-596 | B.I-4 | B.III-38 | B.IIII-1 |
| T.3-597 | B.I-5 | B.III-38 | B.IIII-1 |
| T.3-598 | B.I-6 | B.III-38 | B.IIII-1 |
| T.3-599 | B.I-7 | B.III-38 | B.IIII-1 |
| T.3-600 | B.I-8 | B.III-38 | B.IIII-1 |
| T.3-601 | B.I-9 | B.III-38 | B.IIII-1 |
| T.3-602 | B.I-10 | B.III-38 | B.IIII-1 |
| T.3-603 | B.I-11 | B.III-38 | B.IIII-1 |
| T.3-604 | B.I-12 | B.III-38 | B.IIII-1 |
| T.3-605 | B.I-13 | B.III-38 | B.IIII-1 |
| T.3-606 | B.I-14 | B.III-38 | B.IIII-1 |
| T.3-607 | B.I-15 | B.III-38 | B.IIII-1 |
| T.3-608 | B.I-16 | B.III-38 | B.IIII-1 |
| T.3-609 | B.I-1 | B.III-39 | B.IIII-1 |
| T.3-610 | B.I-2 | B.III-39 | B.IIII-1 |
| T.3-611 | B.I-3 | B.III-39 | B.IIII-1 |
| T.3-612 | B.I-4 | B.III-39 | B.IIII-1 |
| T.3-613 | B.I-5 | B.III-39 | B.IIII-1 |
| T.3-614 | B.I-6 | B.III-39 | B.IIII-1 |
| T.3-615 | B.I-7 | B.III-39 | B.IIII-1 |
| T.3-616 | B.I-8 | B.III-39 | B.IIII-1 |
| T.3-617 | B.I-9 | B.III-39 | B.IIII-1 |
| T.3-618 | B.I-10 | B.III-39 | B.IIII-1 |
| T.3-619 | B.I-11 | B.III-39 | B.IIII-1 |
| T.3-620 | B.I-12 | B.III-39 | B.IIII-1 |
| T.3-621 | B.I-13 | B.III-39 | B.IIII-1 |
| T.3-622 | B.I-14 | B.III-39 | B.IIII-1 |
| T.3-623 | B.I-15 | B.III-39 | B.IIII-1 |
| T.3-624 | B.I-16 | B.III-39 | B.IIII-1 |
| T.3-625 | B.I-1 | B.III-40 | B.IIII-1 |
| T.3-626 | B.I-2 | B.III-40 | B.IIII-1 |
| T.3-627 | B.I-3 | B.III-40 | B.IIII-1 |
| T.3-628 | B.I-4 | B.III-40 | B.IIII-1 |
| T.3-629 | B.I-5 | B.III-40 | B.IIII-1 |
| T.3-630 | B.I-6 | B.III-40 | B.IIII-1 |
| T.3-631 | B.I-7 | B.III-40 | B.IIII-1 |
| T.3-632 | B.I-8 | B.III-40 | B.IIII-1 |
| T.3-633 | B.I-9 | B.III-40 | B.IIII-1 |
| T.3-634 | B.I-10 | B.III-40 | B.IIII-1 |
| T.3-635 | B.I-11 | B.III-40 | B.IIII-1 |
| T.3-636 | B.I-12 | B.III-40 | B.IIII-1 |
| T.3-637 | B.I-13 | B.III-40 | B.IIII-1 |
| T.3-638 | B.I-14 | B.III-40 | B.IIII-1 |
| T.3-639 | B.I-15 | B.III-40 | B.IIII-1 |
| T.3-640 | B.I-16 | B.III-40 | B.IIII-1 |
| T.3-641 | B.I-1 | B.III-41 | B.IIII-1 |
| T.3-642 | B.I-2 | B.III-41 | B.IIII-1 |
| T.3-643 | B.I-3 | B.III-41 | B.IIII-1 |
| T.3-644 | B.I-4 | B.III-41 | B.IIII-1 |
| T.3-645 | B.I-5 | B.III-41 | B.IIII-1 |
| T.3-646 | B.I-6 | B.III-41 | B.IIII-1 |
| T.3-647 | B.I-7 | B.III-41 | B.IIII-1 |
| T.3-648 | B.I-8 | B.III-41 | B.IIII-1 |
| T.3-649 | B.I-9 | B.III-41 | B.IIII-1 |
| T.3-650 | B.I-10 | B.III-41 | B.IIII-1 |
| T.3-651 | B.I-11 | B.III-41 | B.IIII-1 |
| T.3-652 | B.I-12 | B.III-41 | B.IIII-1 |
| T.3-653 | B.I-13 | B.III-41 | B.IIII-1 |
| T.3-654 | B.I-14 | B.III-41 | B.IIII-1 |
| T.3-655 | B.I-15 | B.III-41 | B.IIII-1 |
| T.3-656 | B.I-16 | B.III-41 | B.IIII-1 |
| T.3-657 | B.I-1 | B.III-42 | B.IIII-1 |
| T.3-658 | B.I-2 | B.III-42 | B.IIII-1 |
| T.3-659 | B.I-3 | B.III-42 | B.IIII-1 |
| T.3-660 | B.I-4 | B.III-42 | B.IIII-1 |
| T.3-661 | B.I-5 | B.III-42 | B.IIII-1 |
| T.3-662 | B.I-6 | B.III-42 | B.IIII-1 |
| T.3-663 | B.I-7 | B.III-42 | B.IIII-1 |
| T.3-664 | B.I-8 | B.III-42 | B.IIII-1 |
| T.3-665 | B.I-9 | B.III-42 | B.IIII-1 |
| T.3-666 | B.I-10 | B.III-42 | B.IIII-1 |
| T.3-667 | B.I-11 | B.III-42 | B.IIII-1 |
| T.3-668 | B.I-12 | B.III-42 | B.IIII-1 |
| T.3-669 | B.I-13 | B.III-42 | B.IIII-1 |
| T.3-670 | B.I-14 | B.III-42 | B.IIII-1 |
| T.3-671 | B.I-15 | B.III-42 | B.IIII-1 |
| T.3-672 | B.I-16 | B.III-42 | B.IIII-1 |
| T.3-673 | B.I-1 | B.III-43 | B.IIII-1 |
| T.3-674 | B.I-2 | B.III-43 | B.IIII-1 |
| T.3-675 | B.I-3 | B.III-43 | B.IIII-1 |
| T.3-676 | B.I-4 | B.III-43 | B.IIII-1 |
| T.3-677 | B.I-5 | B.III-43 | B.IIII-1 |
| T.3-678 | B.I-6 | B.III-43 | B.IIII-1 |
| T.3-679 | B.I-7 | B.III-43 | B.IIII-1 |
| T.3-680 | B.I-8 | B.III-43 | B.IIII-1 |
| T.3-681 | B.I-9 | B.III-43 | B.IIII-1 |
| T.3-682 | B.I-10 | B.III-43 | B.IIII-1 |
| T.3-683 | B.I-11 | B.III-43 | B.IIII-1 |
| T.3-684 | B.I-12 | B.III-43 | B.IIII-1 |
| T.3-685 | B.I-13 | B.III-43 | B.IIII-1 |
| T.3-686 | B.I-14 | B.III-43 | B.IIII-1 |
| T.3-687 | B.I-15 | B.III-43 | B.IIII-1 |
| T.3-688 | B.I-16 | B.III-43 | B.IIII-1 |
| T.3-689 | B.I-1 | B.III-44 | B.IIII-1 |
| T.3-690 | B.I-2 | B.III-44 | B.IIII-1 |
| T.3-691 | B.I-3 | B.III-44 | B.IIII-1 |
| T.3-692 | B.I-4 | B.III-44 | B.IIII-1 |
| T.3-693 | B.I-5 | B.III-44 | B.IIII-1 |
| T.3-694 | B.I-6 | B.III-44 | B.IIII-1 |
| T.3-695 | B.I-7 | B.III-44 | B.IIII-1 |
| T.3-696 | B.I-8 | B.III-44 | B.IIII-1 |
| T.3-697 | B.I-9 | B.III-44 | B.IIII-1 |
| T.3-698 | B.I-10 | B.III-44 | B.IIII-1 |
| T.3-699 | B.I-11 | B.III-44 | B.IIII-1 |
| T.3-700 | B.I-12 | B.III-44 | B.IIII-1 |
| T.3-701 | B.I-13 | B.III-44 | B.IIII-1 |
| T.3-702 | B.I-14 | B.III-44 | B.IIII-1 |
| T.3-703 | B.I-15 | B.III-44 | B.IIII-1 |
| T.3-704 | B.I-16 | B.III-44 | B.IIII-1 |
| T.3-705 | B.I-1 | B.III-45 | B.IIII-1 |
| T.3-706 | B.I-2 | B.III-45 | B.IIII-1 |
| T.3-707 | B.I-3 | B.III-45 | B.IIII-1 |
| T.3-708 | B.I-4 | B.III-45 | B.IIII-1 |
| T.3-709 | B.I-5 | B.III-45 | B.IIII-1 |
| T.3-710 | B.I-6 | B.III-45 | B.IIII-1 |
| T.3-711 | B.I-7 | B.III-45 | B.IIII-1 |
| T.3-712 | B.I-8 | B.III-45 | B.IIII-1 |
| T.3-713 | B.I-9 | B.III-45 | B.IIII-1 |
| T.3-714 | B.I-10 | B.III-45 | B.IIII-1 |
| T.3-715 | B.I-11 | B.III-45 | B.IIII-1 |
| T.3-716 | B.I-12 | B.III-45 | B.IIII-1 |
| T.3-717 | B.I-13 | B.III-45 | B.IIII-1 |
| T.3-718 | B.I-14 | B.III-45 | B.IIII-1 |
| T.3-719 | B.I-15 | B.III-45 | B.IIII-1 |
| T.3-720 | B.I-16 | B.III-45 | B.IIII-1 |
| T.3-721 | B.I-1 | B.III-46 | B.IIII-1 |
| T.3-722 | B.I-2 | B.III-46 | B.IIII-1 |
| T.3-723 | B.I-3 | B.III-46 | B.IIII-1 |
| T.3-724 | B.I-4 | B.III-46 | B.IIII-1 |
| T.3-725 | B.I-5 | B.III-46 | B.IIII-1 |
| T.3-726 | B.I-6 | B.III-46 | B.IIII-1 |
| T.3-727 | B.I-7 | B.III-46 | B.IIII-1 |
| T.3-728 | B.I-8 | B.III-46 | B.IIII-1 |
| T.3-729 | B.I-9 | B.III-46 | B.IIII-1 |
| T.3-730 | B.I-10 | B.III-46 | B.IIII-1 |
| T.3-731 | B.I-11 | B.III-46 | B.IIII-1 |
| T.3-732 | B.I-12 | B.III-46 | B.IIII-1 |
| T.3-733 | B.I-13 | B.III-46 | B.IIII-1 |
| T.3-734 | B.I-14 | B.III-46 | B.IIII-1 |
| T.3-735 | B.I-15 | B.III-46 | B.IIII-1 |
| T.3-736 | B.I-16 | B.III-46 | B.IIII-1 |
| T.3-737 | B.I-1 | B.III-47 | B.IIII-1 |
| T.3-738 | B.I-2 | B.III-47 | B.IIII-1 |
| T.3-739 | B.I-3 | B.III-47 | B.IIII-1 |
| T.3-740 | B.I-4 | B.III-47 | B.IIII-1 |
| T.3-741 | B.I-5 | B.III-47 | B.IIII-1 |
| T.3-742 | B.I-6 | B.III-47 | B.IIII-1 |
| T.3-743 | B.I-7 | B.III-47 | B.IIII-1 |
| T.3-744 | B.I-8 | B.III-47 | B.IIII-1 |
| T.3-745 | B.I-9 | B.III-47 | B.IIII-1 |
| T.3-746 | B.I-10 | B.III-47 | B.IIII-1 |
| T.3-747 | B.I-11 | B.III-47 | B.IIII-1 |
| T.3-748 | B.I-12 | B.III-47 | B.IIII-1 |
| T.3-749 | B.I-13 | B.III-47 | B.IIII-1 |
| T.3-750 | B.I-14 | B.III-47 | B.IIII-1 |
| T.3-751 | B.I-15 | B.III-47 | B.IIII-1 |
| T.3-752 | B.I-16 | B.III-47 | B.IIII-1 |
| T.3-753 | B.I-1 | B.III-48 | B.IIII-1 |
| T.3-754 | B.I-2 | B.III-48 | B.IIII-1 |
| T.3-755 | B.I-3 | B.III-48 | B.IIII-1 |
| T.3-756 | B.I-4 | B.III-48 | B.IIII-1 |
| T.3-757 | B.I-5 | B.III-48 | B.IIII-1 |
| T.3-758 | B.I-6 | B.III-48 | B.IIII-1 |
| T.3-759 | B.I-7 | B.III-48 | B.IIII-1 |
| T.3-760 | B.I-8 | B.III-48 | B.IIII-1 |
| T.3-761 | B.I-9 | B.III-48 | B.IIII-1 |
| T.3-762 | B.I-10 | B.III-48 | B.IIII-1 |
| T.3-763 | B.I-11 | B.III-48 | B.IIII-1 |
| T.3-764 | B.I-12 | B.III-48 | B.IIII-1 |
| T.3-765 | B.I-13 | B.III-48 | B.IIII-1 |
| T.3-766 | B.I-14 | B.III-48 | B.IIII-1 |
| T.3-767 | B.I-15 | B.III-48 | B.IIII-1 |
| T.3-768 | B.I-16 | B.III-48 | B.IIII-1 |
| T.3-769 | B.I-1 | B.III-49 | B.IIII-1 |
| T.3-770 | B.I-2 | B.III-49 | B.IIII-1 |
| T.3-771 | B.I-3 | B.III-49 | B.IIII-1 |
| T.3-772 | B.I-4 | B.III-49 | B.IIII-1 |
| T.3-773 | B.I-5 | B.III-49 | B.IIII-1 |
| T.3-774 | B.I-6 | B.III-49 | B.IIII-1 |
| T.3-775 | B.I-7 | B.III-49 | B.IIII-1 |
| T.3-776 | B.I-8 | B.III-49 | B.IIII-1 |
| T.3-777 | B.I-9 | B.III-49 | B.IIII-1 |
| T.3-778 | B.I-10 | B.III-49 | B.IIII-1 |
| T.3-779 | B.I-11 | B.III-49 | B.IIII-1 |
| T.3-780 | B.I-12 | B.III-49 | B.IIII-1 |
| T.3-781 | B.I-13 | B.III-49 | B.IIII-1 |
| T.3-782 | B.I-14 | B.III-49 | B.IIII-1 |
| T.3-783 | B.I-15 | B.III-49 | B.IIII-1 |
| T.3-784 | B.I-16 | B.III-49 | B.IIII-1 |

Table T.3.2: Ternary mixtures as defined in table T.3.1 wherein component 3 (Co. 3) is compound B.III-2 instead of B.III-1.

Table T.3.3: Ternary mixtures as defined in table T.3.1 wherein component 3 (Co. 3) is compound B.III-3 instead of B.III-1.

Table T.3.4: Ternary mixtures as defined in table T.3.1 wherein component 3 (Co. 3) is compound B.III-4 instead of B.III-1.

Table T.3.5: Ternary mixtures as defined in table T.3.1 wherein component 3 (Co. 3) is compound B.III-5 instead of B.III-1.

Table T.3.6: Ternary mixtures as defined in table T.3.1 wherein component 3 (Co. 3) is compound B.III-6 instead of B.III-1.

Table T.3.7: Ternary mixtures as defined in table T.3.1 wherein component 3 (Co. 3) is compound B.III-7 instead of B.III-1.

Table T.3.8: Ternary mixtures as defined in table T.3.1 wherein component 3 (Co. 3) is compound B.III-8 instead of B.III-1.

Table T.3.9: Ternary mixtures as defined in table T.3.1 wherein component 3 (Co. 3) is compound B.III-9 instead of B.III-1.

Table T.3.10: Ternary mixtures as defined in table T.3.1 wherein component 3 (Co. 3) is compound B.III-10 instead of B.III-1.

Table T.3.11: Ternary mixtures as defined in table T.3.1 wherein component 3 (Co. 3) is compound B.III-11 instead of B.III-1.

Table T.3.12: Ternary mixtures as defined in table T.3.1 wherein component 3 (Co. 3) is compound B.III-12 instead of B.III-1.

Table T.3.13: Ternary mixtures as defined in table T.3.1 wherein component 3 (Co. 3) is compound B.III-13 instead of B.III-1.

Table T.3.14: Ternary mixtures as defined in table T.3.1 wherein component 3 (Co. 3) is compound B.III-14 instead of B.III-1.

Table T.3.15: Ternary mixtures as defined in table T.3.1 wherein component 3 (Co. 3) is compound B.III-15 instead of B.III-1.

Table T.3.16: Ternary mixtures as defined in table T.3.1 wherein component 3 (Co. 3) is compound B.III-16 instead of B.III-1.

Table T.3.17: Ternary mixtures as defined in table T.3.1 wherein component 3 (Co. 3) is compound B.III-17 instead of B.III-1.

Table T.3.18: Ternary mixtures as defined in table T.3.1 wherein component 3 (Co. 3) is compound B.III-18 instead of B.III-1.

Table T.3.19: Ternary mixtures as defined in table T.3.1 wherein component 3 (Co. 3) is compound B.III-19 instead of B.III-1.

Table T.3.20: Ternary mixtures as defined in table T.3.1 wherein component 3 (Co. 3) is compound B.III-20 instead of B.III-1.

Table T.3.21: Ternary mixtures as defined in table T.3.1 wherein component 3 (Co. 3) is compound B.III-21 instead of B.III-1.

Table T.3.22: Ternary mixtures as defined in table T.3.1 wherein component 3 (Co. 3) is compound B.III-22 instead of B.III-1.

Table T.3.23: Ternary mixtures as defined in table T.3.1 wherein component 3 (Co. 3) is compound B.III-23 instead of B.III-1.

Table T.3.24: Ternary mixtures as defined in table T.3.1 wherein component 3 (Co. 3) is compound B.III-24 instead of B.III-1.

Table T.3.25: Ternary mixtures as defined in table T.3.1 wherein component 3 (Co. 3) is compound B.III-25 instead of B.III-1.

Table T.3.26: Ternary mixtures as defined in table T.3.1 wherein component 3 (Co. 3) is compound B.III-26 instead of B.III-1.

Table T.3.27: Ternary mixtures as defined in table T.3.1 wherein component 3 (Co. 3) is compound B.III-27 instead of B.III-1.

Table T.3.28: Ternary mixtures as defined in table T.3.1 wherein component 3 (Co. 3) is compound B.III-28 instead of B.III-1.

Table T.3.29: Ternary mixtures as defined in table T.3.1 wherein component 3 (Co. 3) is compound B.III-29 instead of B.III-1.

Table T.3.30: Ternary mixtures as defined in table T.3.1 wherein component 3 (Co. 3) is compound B.III-30 instead of B.III-1.

Table T.3.31: Ternary mixtures as defined in table T.3.1 wherein component 3 (Co. 3) is compound B.III-31 instead of B.III-1.

Table T.3.32: Ternary mixtures as defined in table T.3.1 wherein component 3 (Co. 3) is compound B.III-32 instead of B.III-1.

Table T.3.33: Ternary mixtures as defined in table T.3.1 wherein component 3 (Co. 3) is compound B.III-33 instead of B.III-1.

Table T.3.34: Ternary mixtures as defined in table T.3.1 wherein component 3 (Co. 3) is compound B.III-34 instead of B.III-1.

Table T.3.35: Ternary mixtures as defined in table T.3.1 wherein component 3 (Co. 3) is compound B.III-35 instead of B.III-1.

Table T.3.36: Ternary mixtures as defined in table T.3.1 wherein component 3 (Co. 3) is compound B.III-36 instead of B.III-1.

Table T.3.37: Ternary mixtures as defined in table T.3.1 wherein component 3 (Co. 3) is compound B.III-37 instead of B.III-1.

Table T.3.38: Ternary mixtures as defined in table T.3.1 wherein component 3 (Co. 3) is compound B.III-38 instead of B.III-1.

Table T.3.39: Ternary mixtures as defined in table T.3.1 wherein component 3 (Co. 3) is compound B.III-39 instead of B.III-1.

Table T.3.40: Ternary mixtures as defined in table T.3.1 wherein component 3 (Co. 3) is compound B.III-40 instead of B.III-1.

Table T.3.41: Ternary mixtures as defined in table T.3.1 wherein component 3 (Co. 3) is compound B.III-41 instead of B.III-1.

Table T.3.42: Ternary mixtures as defined in table T.3.1 wherein component 3 (Co. 3) is compound B.III-42 instead of B.III-1.

Table T.3.43: Ternary mixtures as defined in table T.3.1 wherein component 3 (Co. 3) is compound B.III-43 instead of B.III-1.

Table T.3.44: Ternary mixtures as defined in table T.3.1 wherein component 3 (Co. 3) is compound B.III-44 instead of B.III-1.

Table T.3.45: Ternary mixtures as defined in table T.3.1 wherein component 3 (Co. 3) is compound B.III-45 instead of B.III-1.

Table T.3.46: Ternary mixtures as defined in table T.3.1 wherein component 3 (Co. 3) is compound B.III-46 instead of B.III-1.

Table T.3.47: Ternary mixtures as defined in table T.3.1 wherein component 3 (Co. 3) is compound B.III-47 instead of B.III-1.

Table T.3.48: Ternary mixtures as defined in table T.3.1 wherein component 3 (Co. 3) is compound B.III-48 instead of B.III-1.

Table T.3.49: Ternary mixtures as defined in table T.3.1 wherein component 3 (Co. 3) is compound B.III-49 instead of B.III-1.

“Whole broth culture” refers to a liquid culture containing both cells and media.

“Supernatant” refers to the liquid broth remaining when cells grown in broth are removed by centrifugation, filtration, sedimentation, or other means well known in the art.

The term “metabolite” refers to any compound, substance or byproduct produced by a microorganism (such as fungi and bacteria) that has pesticidal activity or improves plant growth, water use efficiency of the plant, plant health, plant appearance, or the population of beneficial microorganisms in the soil around the plant activity.

The term “mutant” refers a microorganism, obtained by direct mutant selection but also includes microorganisms that have been further mutagenized or otherwise manipulated (e.g., via the introduction of a plasmid). Accordingly, embodiments include mutants, variants, and or derivatives of the respective microorganism, both naturally occurring and artificially induced mutants. For example, mutants may be induced by subjecting the microorganism to known mutagens, such as N-methyl-nitrosoguanidine, using conventional methods. Preferably such mutants retain the pesticidal activity of the respective microorganism.

The mixtures and compositions thereof according to the invention can, in the use form as fungicides, also be present together with other active substances, e. g. with herbicides, insecticides, growth regulators, fungicides or else with fertilizers, as premix or, if appropriate, not until immediately prior to use (tank mix).

Mixing an oligomer formed from a monomer of formula I and one pesticide II and the compositions comprising them, respectively, in the use form as fungicides with other fungicides results in many cases in an expansion of the fungicidal spectrum of activity being obtained or in a prevention of fungicide resistance development. Furthermore, in many cases, synergistic effects are obtained.

According to the present invention, it may be preferred that the mixtures comprise besides one oligomer formed from a monomer of formula I and one pesticide II one further active substance (e.g. pesticide III) as component 3), preferably in a synergistically effective amount. Another embodiment relates to mixtures wherein the component 3) is an pesticide III selected from groups A) to O).

The pesticides II and/or III of chemical nature described by their common names, their preparation and their biological activity e.g. against harmful fungi, pests or weed is known (cf.: http://www.alanwood.net/pesticides/); these substances are commercially available and known, for example, from the references below:

benalaxyl, methyl N-(phenylacetyl)-N-(2,6-xylyl)-DL-alaninate (DE 29 03 612); metalaxyl, methyl N-(methoxyacetyl)-N-(2,6-xylyl)-DL-alaninate (GB 15 00 581); ofurace, (RS)-α-(2-chloro-N-2,6-xylylacetamido)-γ-butyrolactone [CAS RN 58810-48-3]; oxadixyl; N-(2,6-dimethylphenyl)-2-methoxy-N-(2-oxo-3-oxazolidinyl)acetamide (GB 20 58 059); aldimorph, “4-alkyl-2,5(or 2,6)-dimethylmorpholine”, comprising 65-75% of 2,6-dimethylmorpholine and 25-35% of 2,5-dimethylmorpholine, comprising more than 85% of 4-dodecyl-2,5(or 2,6)-dimethylmorpholine, where “alkyl” also includes octyl, decyl, tetradecyl and hexadecyl, with a cis/trans ratio of 1:1 [CAS RN 91315-15-0]; dodine, 1-dodecylguanidinium acetate (Plant Dis. Rep., Vol. 41, p.1029 (1957)); dodemorph, 4-cyciododecyl-2,6-dimethylmorpholine (DE 1198125); fenpropimorph, (RS)-cis-4-[3-(4-tert-butylphenyl)-2-methylpropyl]-2,6-dimethylmorpholine (DE 27 52 096); fenpropidin, (RS)-1-[3-(4-tert-butylphenyl)-2-methylpropyl]piperidine (DE 27 52 096); guazatine, mixture of the reaction products from the amidation of technical grade iminodi(octa-methylene)diamine, comprising various guanidines and polyamines [CAS RN 108173-90-6]; iminoctadine, 1,1′-iminodi(octamethylene)diguanidine (Congr. Plant Pathol. 1, p.27 (1968); spiroxamine, (8-tert-butyl-1,4-dioxaspiro[4.5]dec-2-yl)diethylamine (EP-A 281 842); tridemorph, 2,6-dimethyl-4-tridecylmorpholine (DE 11 64 152); pyrimethanil, 4,6-dimethylpyrimidin-2-ylphenylamine (DD-A 151 404); mepanipyrim, (4-methyl-6-prop-1-ynylpyrimidin-2-yl)phenylamine (EP-A 224 339); cyprodinil, (4-cyclopropyl-6-methylpyrimidin-2-yl)phenylamine (EP-A 310 550); cycloheximid, 4-{(2R)-2-[(1 S,3S,5S)-3,5-dimethyl-2-oxocyclohexyl]-2-hydroxyethyl}piperidine-2,6-dione [CAS RN 66-81-9]; griseofulvin, 7-chloro-2′,4,6-trimethoxy-6′-methylspiro[benzo-furan-2(3H),1′-cyciohex-2′-ene]-3,4′-dione [CAS RN 126-07-8]; kasugamycin, 3-O-[2-amino-4-[(carboxyiminomethyl)amino]-2,3,4,6-tetradeoxy-α-D-arabino-hexopyranosyl]-D-chiro-inositol [CAS RN 6980-18-3]; natamycin, (8E,14E, 16E,18E,20E)-(1 R,3S,5R, 7R,12R,22R,24S,25R,26S)-22-(3-amino-3,6-dideoxy-β-D-mannopyranosyloxy)-1,3,26-trihydroxy-12-methyl-10-oxo-6,11,28-trioxatricyco[22.3.1.05,7]octacosa-8,14,16,18,20-pentaene-25-carboxylic acid [CAS RN 7681-93-8]; polyoxin, 5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid [CAS RN 22976-86-9]; streptomycin, 1,1′-{1-L-(1,3,5/2,4,6)-4-[5-deoxy-2-O-(2-deoxy-2-methylamino-α-L-glucopyranosyl)-3-C-formyl-α-L-lyxofuranosyloxy]-2,5,6-trihydroxycyclohex-1,3-ylene}diguanidine (J. Am. Chem. Soc. 69, p.1234 (1947)); bitertanol, 1-([1,1′-biphenyl]-4-yloxy)-α-(1,1-dimethylethyl)-1H-1,2,4-triazole-1-ethanol (DE 23 24 020); bromuconazole, 1-[[4-bromo-2-(2,4-dichloro-phenyl)tetrahydro-2-furanyl]methyl]-1H-1,2,4-triazole (Proc. Br. Crop. Prot. Conf. 1990-Pests Dis. Vol. 1, p. 459); cyproconazole, 2-(4-chlorophenyl)-3-cyclopropyl-1-[1,2,4]triazol-1-ylbutan-2-ol (U.S. Pat. No. 4,664,696); difenoconazole, 1-{2-[2-chloro-4-(4-chloro-phenoxy)phenyl]-4-methyl-[1,3]dioxolan-2-ylmethyl}-1H-[1,2,4]triazole (GB-A 2 098 607); diniconazole, (βE)-β-[(2,4-dichlorophenyl)methylene]-α-(1,1-dimethylethyl)-1H-1,2,4-triazole-1-ethanol (Noyaku Kagaku, 1983, Vol. 8, p. 575); enilconazole (imazalil), 1-[2-(2,4-dichlorphenyl)-2-(2-propenyloxyl)ethyl]-1H-imidazole (Fruits 28, p. 545, 1973); epoxiconazole, (2RS,3SR)-1-[3-(2-chlorophenyl)-2,3-epoxy-2-(4-fluorophenyl)propyl]-1H-1,2,4-triazole (EP-A 196 038); fenbuconazole, α-[2-(4-chlorophenyl)ethyl]-α-phenyl-1H-1,2,4-triazole-1-propanenitrile (Proc. Br. Crop Prot. Conf. 1988-Pests Dis. Vol. 1, p. 33); fluquinconazole, 3-(2,4-dichlorophenyl)-6-fluoro-2-[1,2,4]-triazol-1-yl-3H-quinazolin-4-one (Proc. Br. Crop Prot. Conf.-Pests Dis., 5-3, 411 (1992)); flusilazole, 1-{[bis-(4-fluorophenyl)methylsilanyl]methyl}-1H-[1,2,4]triazole (Proc. Br. Crop Prot. Conf.-Pests Dis., 1, 413 (1984)); flutriafol, α-(2-fluorophenyl)-α-(4-fluorophenyl)-1H-1,2,4-triazole-1-ethanol (EP 15 756); hexaconazole, 2-(2,4-dichlorophenyl)-1-[1,2,4]triazol-1-ylhexan-2-ol (CAS RN 79983-71-4); ipconazole, 2-[(4-chlorophenyl)-methyl]-5-(1-methylethyl)-1-(1H-1,2,4-triazol-1-ylmethyl)cyclopentanol (EP 267 778), metconazole, 5-(4-chlorobenzyl)-2,2-dimethyl-1-[1,2,4]triazol-1-ylmethylcyclopentanol (GB 857 383); myciobutanil, 2-(4-chlorophenyl)-2-[1,2,4]triazol-1-ylmethylpentanenitrile (CAS RN 88671-89-0); penconazole, 1-[2-(2,4-dichlorophenyl)pentyl]-1H-[1,2,4]triazole (Pesticide Manual, 12th Ed. (2000), S.712); propiconazole, 1-[[2-(2,4-dichloro-phenyl)-4-propyl-1,3-dioxolan-2-yl]methyl]-1H-1,2,4-triazole (BE 835 579); prochloraz, N-(propyl-[2-(2,4,6-trichlorophenoxyl)ethyl])imidazole-1-carboxamide (U.S. Pat. No. 3,991,071); prothioconazole, 2-[2-(1-chlorocyclopropyl)-3-(2-chlorophenyl)-2-hydroxypropyl]-2,4-dihydro-[1,2,4]triazole-3-thione (WO 96/16048); simeconazole, α-(4-fluorophenyl)-α-[(trimethylsilyl)methyl]-1H-1,2,4-triazole-1-ethanol [CAS RN 149508-90-7]; tebuconazole, 1-(4-chlorophenyl)-4,4-dimethyl-3-[1,2,4]triazol-1-ylmethylpentan-3-ol (EP-A 40 345); tetraconazole, 1-[2-(2,4-dichlorophenyl)-3-(1,1,2,2-tetrafluoroethoxyl)propyl]-1H-1,2,4-triazole (EP 234 242); triadimefon, 1-(4-chlorophenoxy)-3,3-dimethyl-1-(1H-1,2,4-triazol-1-yl)-2-butanone (BE 793 867); triadimenol, (4-chlorophenoxy)-α-(1,1-dimethylethyl)-1H-1,2,4-triazole-1-ethanol (DE 23 24 010); triflumizol, (4-chloro-2-trifluoro-methylphenyl)-(2-propoxy-1-[1,2,4]triazol-1-ylethyliden)-amine (JP-A 79/119 462); triticonazole, (5E)-5-[(4-chlorophenyl)methylene]-2,2-dimethyl-1-(1H-1,2,4-triazol-1-yl-methyl)cyclopentanol (FR 26 41 277); iprodione, N-isopropyl-3-(3,5-dichlorophenyl)-2,4-dioxoimidazolidine-1-carboxamide (GB 13 12 536); myclozolin, (RS)-3-(3,5-dichlorophenyl)-5-methoxymethyl-5-methyl-1,3-oxazolidine-2,4-dione [CAS RN 54864-61-8]; procymidone, N-(3,5-dichlorophenyl)-1,2-dimethylcyclopropane-1,2-dicarboximide (U.S. Pat. No. 3,903,090); vinciozolin, 3-(3,5-dichlorophenyl)-5-methyl-5-vinyloxazolidine-2,4-dione (DE-A 22 07 576); ferbam, iron(3+)dimethyldithiocarbamate (U.S. Pat. No. 1,972,961); nabam, disodium ethylenebis(dithiocarbamate) (U.S. Pat. No. 2,317,765); maneb, manganese ethylenebis(dithiocarbamate) (U.S. Pat. No. 2,504,404); mancozeb, manganese ethylenebis-(dithiocarbamate) polymer complex zinc salt (GB 996 264); metam, methyldithiocar-baminic acid (U.S. Pat. No. 2,791,605); metiram, zinc ammoniate ethylenebis(dithiocarbamate) (U.S. Pat. No. 3,248,400); propineb, zinc propylenebis(dithiocarbamate) polymer (BE 611 960); polycarbamate, bis(dimethylcarbamodithioato-S,S′)[μ-[[1,2-ethanediylbis[carbamodi-thioato-S,S′]](2-)]]di[zinc][CAS RN 64440-88-6]; thiram, bis(dimethytthiocarbamoyl)disulfide (DE 642 532); ziram, dimethyldithiocarbamate [CAS RN 137-30-4]; zineb, zinc ethylenebis(dithiocarbamate) (U.S. Pat. No. 2,457,674); anilazine, 4,6-dichloro-N-(2-chloro-phenyl)-1,3,5-triazine-2-amine (U.S. Pat. No. 2,720,480); benomyl, N-butyl-2-acetylaminobenzo-imidazole-1-carboxamide (U.S. Pat. No. 3,631,176); boscalid, 2-chloro-N-(4′-chlorobiphenyl-2-yl)-nicotinamide (EP-A 545 099); carbendazim, methyl (1H-benzoimidazol-2-yl)carbamate (U.S. Pat. No. 3,657,443); carboxin, 5,6-dihydro-2-methy-N-phenyl-1,4-oxathiin-3-carboxamide (U.S. Pat. No. 3,249,499); oxycarboxin, 5,6-dihydro-2-methyl-1,4-oxathiin-3-carboxanilide 4,4-dioxide (U.S. Pat. No. 3,399,214); cyazofamid, 4-chloro-2-cyano-N,N-dimethyl-5-(4-methylphenyl)-1H-imidazole-1-sulfonamide (CAS RN 120116-88-3]; dazomet, 3,5-dimethyl-1,3,5-thia-diazinane-2-thione (Bull. Soc. Chim. Fr. 15, p. 891 (1897)); dithianon, 5,10-dioxo-5,10-dihydronaphtho[2,3-b][1,4]dithiin-2,3-dicarbonitrile (GB 857 383); famoxadone, (RS)-3-anilino-5-methyl-5-(4-phenoxyphenyl)-1,3-oxazolidine-2,4-dione [CAS RN 131807-57-3]; fenamidone, (S)-1-anilino-4-methyl-2-methylthio-4-phenylimidazolin-5-one [CAS RN 161326-34-7]; fenarimol, α-(2-chlorophenyl)-α-(4-chlorophenyl)-5-pyrimidinemethanol (GB 12 18 623); fuberidazole, 2-(2-furanyl)-1H-benzimidazole (DE 12 09 799); flutolanil, α,α,α-trifluoro-3′-isopropoxy-o-toluanilide (JP 1104514); furametpyr, 5-chloro-N-(1,3-dihydro-1,1,3-trimethyl-4-isobenzofuranyl)-1,3-dimethyl-1H-pyrazole-4-carboxamide [CAS RN 123572-88-3]; isoprothiolane, diisopropyl 1,3-dithiolan-2-ylidene-malonate (Proc. Insectic. Fungic. Conf. 8. Vol. 2, p. 715 (1975)); mepronil, 3′-isoprop-oxy-o-toluanilide (U.S. Pat. No. 3,937,840); nuarimol, α-(2-chlorophenyl)-α-(4-fluorophenyl)-5-pyrimidinemethanol (GB 12 18 623); fluopicolide (picobenzamid), 2,6-dichloro-N-(3-chloro-5-trifluoromethylpyridin-2-ylmethyl)benzamide (WO 99/42447); probenazole, 3-allyl-oxy-1,2-benzothiazole 1,1-dioxide (Agric. Biol. Chem. 37, p. 737 (1973)); proquinazid, 6-iodo-2-propoxy-3-propylquinazolin-4(3H)-one (WO 97/48684); pyrifenox, 2′,4′-di-chloro-2-(3-pyridyl)acetophenone (EZ)-O-methyloxime (EP 49 854); pyroquilon, 1,2,5,6-tetrahydropyrrolo[3,2,1-ij]quinolin-4-one (GB 139 43 373) quinoxyfen, 5,7-di-chloro-4-(4-fluorophenoxyl)quinoline (U.S. Pat. No. 5,240,940); silthiofam, N-allyl-4,5-dimethyl-2-(trimethylsilyl)thiophene-3-carboxamide [CAS RN 175217-20-6]; thiabendazole, 2-(1,3-thiazol-4-yl)benzimidazole (U.S. Pat. No. 3,017,415); thifluzamide, 2′,6′-dibromo-2-methyl-4′-tri-fluormethoxy-4-trifluormethyl-1,3-thiazole-5-carboxanilide [CAS RN 130000-40-7]; thiophanate-methyl, 1,2-phenylenebis(iminocarbonothioyl)bis(dimethylcarbamate) (DE-A 19 30 540); tiadinil, 3′-chloro-4,4′-dimethyl-1,2,3-thiadiazole-5-carboxanilide [CAS RN 223580-51-6]; tricyclazole, 5-methyl-1,2,4-triazolo[3,4-b][1,3]benzothiazole [CAS RN 41814-78-2]; triforine, N,N′-{piperazine-1,4-diylbis[(trichlormethyl)methylene]})diformamide (DE 19 01 421); Bordeaux mixture, mixture of CuSO₄×3Cu(OH)₂×3CaSO₄ [CAS RN 8011-63-0]; copper acetate, Cu(OCOCH₃)₂ [CAS RN 8011-63-0]; copper oxychloride, Cu₂Cl(OH)₃ [CAS RN 1332-40-7]; basic copper sulfate, CuSO₄ [CAS RN 1344-73-6]; binapacryl, (RS)-2-sec-butyl-4,6-dinitrophenyl 3-methylcrotonate [CAS RN 485-31-4]; dinocap, mixture of 2,6-dinitro-4-octylphenylcrotonate and 2,4-dinitro-6-octylphenylcrotonate, where “octyl” is a mixture of 1-methylheptyl, 1-ethylhexyl and 1-propylpentyl (U.S. Pat. No. 2,526,660); dinobuton, (RS)-2-sec-butyl-4,6-dinitrophenyl isopropyl carbonate [CAS RN 973-21-7]; nitrothal-isopropyl, diisopropyl 5-nitroisophthalate (Proc. Br. Insectic. Fungic. Conf. 7., Vol. 2, p. 673 (1973)); fenpiclonil, 4-(2,3-dichloro-phenyl)-1H-pyrrole-3-carbonitrile (Proc. 1988 Br. Crop Prot. Conf.-Pests Dis., Vol. 1, p. 65); fludioxonil, 4-(2,2-difluorobenzo[1,3]dioxol-4-yl)-1H-pyrrole-3-carbonitrile (The Pesticide Manual, publ. The British Crop Protection Council, 10th ed. (1995), p. 482); acibenzolar-S-methyl, methyl 1,2,3-benzothiadiazol-7-carbothioate [CAS RN 135158-54-2]; flubenthiavalicarb (benthiavalicarb), isopropyl {(S)-1-[(1R)-1-(6-fluorobenzo-thiazol-2-yl)-ethylcarbamoyl]-2-methylpropyl}carbamate (JP-A 09/323 984); carpropamid, 2,2-dichloro-N-[1-(4-chlorophenyl)ethyl]-1-ethyl-3-methylcyclopropanecarbox-amide [CAS RN 104030-54-8]; chlorothalonil, 2,4,5,6-tetrachloroisophthalonitrile (U.S. Pat. No. 3,290,353); cyflufenamid, (Z)-N-[α-(cyciopropylmethoxyimino)-2,3-difluoro-6-(trifluoro-methyl)benzyl]-2-phenylacetamide (WO 96/19442); cymoxanil, 1-(2-cyano-2-methoxy-iminoacetyl)-3-ethylurea (U.S. Pat. No. 3,957,847); diclomezine, 6-(3,5-dichlorophenyl-p-tolyl)-pyridazin-3(2H)-one (U.S. Pat. No. 4,052,395)diclocymet, (RS)-2-cyano-N-[(R)-1-(2,4-dichloro-phenyl)ethyl]-3,3-dimethylbutyramide [CAS RN 139920-32-4]; diethofencarb, isopropyl 3,4-diethoxycarbanilate (EP 78 663); edifenphos, O-ethyl S,S-diphenyl phosphoro-dithioate (DE 14 93 736) ethaboxam, N-(cyano-2-thienylmethyl)-4-ethyl-2-(ethylamino)-5-thiazolecarboxamide (EP-A 639 574); fenhexamid, N-(2,3-dichloro-4-hydroxyphenyl)-1-methylcyclohexanecarboxamide (Proc. Br. Crop Prot. Conf.-Pests Dis., 1998, Vol. 2, p. 327); fentin acetate, triphenytin (U.S. Pat. No. 3,499,086); fenoxanil, N-(1-cyano-1,2-di-methylpropyl)-2-(2,4-dichlorophenoxyl)propanamide (EP 262 393); ferimzone, mepanipyrim, (Z)-2′-methylacetophenone-4,6-dimethylpyrimidin-2-ylhydrazone [CAS RN 89269-64-7]; fluazinam, 3-chloro-N-[3-chloro-2,6-dinitro-4-(trifluoromethyl)phenyl]-5-(trifluoromethyl)-2-pyridinamine (The Pesticide Manual, publ. The British Crop Protection Council, 10th ed. (1995), p. 474); fosetyl, fosetyl-aluminum, ethylphosphonate (FR 22 54 276); iprovalicarb, isopropyl [(1S)-2-methyl-1-(1-p-tolylethylcarbamoyl)propyl]-carbamate (EP-A 472 996); hexachlorbenzene (C. R. Seances Acad. Agric. Fr. 31, p. 24, 1945); metrafenon, 3′-bromo-2,3,4,6′-tetramethoxy-2′,6-dimethylbenzophenone (U.S. Pat. No. 5,945,567); pencycuron, 1-(4-chlorobenzyl)-1-cyclopentyl-3-phenylurea (DE 27 32 257); penthiopyrad, (RS)-N-[2-(1,3-dimethylbutyl)-3-thienyl]-1-methyl-3-(trifluoromethyl)-1H-pyrazole-4-carboxamide (JP 10130268); propamocarb, propyl 3-(dimethyl-amino)propylcarbamate (DE 15 67 169); phthalide (DE 16 43 347); tolociofos-methyl, O-2,6-dichloro-p-tolyl O,O-dimethyl phosphorothioate (GB 14 67 561); quintozene, pentachlomitrobenzene (DE 682 048); zoxamide, (RS)-3,5-dichloro-N-(3-chloro-1-ethyl-1-methyl-2-oxopropyl)-p-toluamide [CAS RN 156052-68-5]; azoxystrobin, methyl 2-{2-[6-(2-cyano-1-vinylpenta-1,3-dienyloxy)pyrimidin-4-yloxy]phenyl}-3-methoxyacrylate (EP 382 375), dimoxystrobin, (E)-2-(methoxyimino)-N-methyl-2-[α-(2,5-xylyl-oxy)-o-tolyl]acetamide (EP 477 631); enestroburin, methyl 2-{2-[3-(4-chlorophenyl)-1-methylallylideneaminooxymethyl]phenyl}-3-methoxyacrylate (EP 936 213); fluoxastrobin, (E)-{2-[6-(2-chlorophenoxy)-5-fluoropyrimidin-4-yloxy]phenyl}(5,6-dihydro-1,4,2-dioxazin-3-yl)methanone O-methyloxime (WO 97/27189); kresoxim-methyl, methyl (E)-methoxyimino[α-(o-tolyloxy)-o-tolyl]acetate (EP 253 213); metominostrobin, (E)-2-(methoxyimino)-N-methyl-2-(2-phenoxyphenyl)acetamide (EP 398 692); orysastrobin, (2E)-2-(methoxyimino)-2-{2-[(3E,5E,6E)-5-(methoxyimino)-4,6-di-methyl-2,8-dioxa-3,7-diazanona-3,6-dien-1-yl]phenyl}-N-methylacetamide (WO 97/15552); picoxystrobin, methyl 3-methoxy-2-[2-(6-trifluoromethylpyridin-2-yloxy-methyl)phenyl]acrylate (EP 278 595); pyraclostrobin, methyl N-{2-[1-(4-chlorophenyl)-1H-pyrazol-3-yloxymethyl]phenyl}(N-methoxy)carbamate (WO 96/01256); trifloxystrobin, methyl (E)-methoxyimino-{(E)-α-[1-(α,α,α-trifluoro-m-tolyl)ethylideneaminooxy]-o-tolyl}acetate (EP 460 575); captafol, N-(1,1,2,2-tetrachloroethylthio)cyclohex-4-ene-1,2-dicarboximide (Phytopathology, Vol. 52, p. 754 (1962)); captan, N-(trichloromethyl-thio)cyclohex-4-ene-1,2-dicarboximide (U.S. Pat. No. 2,553,770); dichlofluanid, N-dichlorofluoro-methylthio-N′,N′-dimethyl-N-phenylsulfamide (DE 11 93 498); folpet, N-(trichlormethyl-thio)phthalimide (U.S. Pat. No. 2,553,770); tolylfluanid, N-dichlorofluoromethytthio-N′,N′-dimethyl-N-p-tolylsulfamide (DE 11 93 498); dimethomorph, 3-(4-chlorophenyl)-3-(3,4-dimethoxyphenyl)-1-morpholin-4-yl-propenone (EP 120 321); flumetover, 2-(3,4-dimethoxy-phenyl)-N-ethyl-α, α,α-trifluoro-N-methyl-p-toluamide [AGROW no. 243, 22 (1995)]; flumorph, 3-(4-fluorophenyl)-3-(3,4-dimethoxyphenyl)-1-morpholin-4-ylpropenone (EP 860 438); 5-Amino-2-isopropyl-3-oxo-4-o-tolyl-2,3-dihydro-pyrazole-1-carbothioic acid S-allyl ester (CN1939128).

The pesticides described by IUPAC nomenclature, their preparation and their fungicidal activity are also known (cf. Can. J. Plant Sci. 48(6), 587-94, 1968; EP-A 141 317; EP-A 152 031; EP-A 226 917; EP-A 243 970; EP-A 256 503; EP-A 428 941; EP-A 532 022; EP-A 1 028 125; EP-A 1 035 122; EP-A 1 201 648; EP-A 1 122 244, JP 2002316902; DE 19650197; DE 10021412; DE 102005009458; U.S. Pat. No. 3,296,272; U.S. Pat. No. 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 11/028657, WO2012/168188, WO 2007/006670, WO 2011/77514; WO13/047749, WO 10/069882, WO 13/047441, WO 03/16303, WO 09/90181, WO 13/007767, WO 13/010862, PCT/EP2012/065650 and PCT/EP2012/065651).

The biopesticides from group L) of pesticides II, their preparation and their pesticidal activity e.g. against harmful fungi or insects are known (e-Pesticide Manual V 5.2 (ISBN 978 1 901396 85 0) (2008-2011); http://www.epa.gov/opp00001/biopesticides/, see product lists therein; http://www.omd.org/omri-lists, see lists therein; Bio-Pesticides Database BPDB http://sitem.herts.ac.uklaeru/bpdb/, see A to Z link therein).

The biopesticides from group L1) and/or L2) may also have insecticidal, acaricidal, molluscidal, pheromone, nematicidal, plant stress reducing, plant growth regulator, plant growth promoting and/or yield enhancing activity. The biopesticides from group L3) and/or L4) may also have fungicidal, bactericidal, viricidal, plant defense activator, plant stress reducing, plant growth regulator, plant growth promoting and/or yield enhancing activity. The biopesticides from group L5) and/or L6) may also have fungicidal, bactericidal, viricidal, plant defense activator, insecticidal, acaricidal, molluscidal, pheromone and/or nematicidal activity.

Many of these biopesticides are registered and/or are commercially available: aluminium silicate (Screen™ Duo from Certis LLC, USA), Agrobacterium radiobacter K1026 (e.g. NoGall® from Becker Underwood Pty Ltd., Australia), A. radiobacter K84 (Nature 280, 697-699, 1979; e.g. GallTroll® from AG Biochem, Inc., C, USA), Ampelomyces quisqualis M-10 (e.g. AQ 10® from Intrachem Bio GmbH & Co. KG, Germany), Ascophyllum nodosum (Norwegian kelp, Brown kelp) extract or filtrate (e.g. ORKA GOLD from Becker Underwood, South Africa; or Goemar® from Laboratoires Goemar, France), Aspergillus flavus NRRL 21882 isolated from a peanut in Georgia in 1991 by the USDA, National Peanut Research Laboratory (e.g. in Afla-Guard® from Syngenta, CH), mixtures of Aureobasidium pullulans DSM14940 and DSM 14941 (e.g. blastospores in BlossomProtect® from bio-ferm GmbH, Germany), Azospirillum brasilense XOH (e.g. AZOS from Xtreme Gardening, USA or RTI Reforestation Technologies International; USA), Bacillus amyloliquefaciens FZB42 (e.g. in RhizoVital® 42 from AbiTEP GmbH, Berlin, Germany), B. amyloliquefaciens IN937a (J. Microbiol. Biotechnol. 17(2), 280-286, 2007; e.g. in BioYield® from Gustafson LLC, TX, USA), B. amyloliquefaciens IT-45 (CNCM 1-3800) (e.g. Rhizocell C from ITHEC, France), B. amyloliquefaciens subsp. plantarum MBI600 (NRRL B-50595, deposited at United States Department of Agriculture) (e.g. Integral®, Subtilex® NG from Becker Underwood, USA), B. cereus CNCM 1-1562 (U.S. Pat. No. 6,406,690), B. firmus CNCM 1-1582 (WO 2009/126473, WO 2009/124707, U.S. Pat. No. 6,406,690; Votivo® from Bayer Crop Science LP, USA), B. pumilus GB34 (ATCC 700814; e.g. in YieldShield® from Gustafson LLC, TX, USA), and Bacillus pumilus KFP9F (NRRL B-50754) (e.g. in BAC-UP or FUSION-P from Becker Underwood South Africa), B. pumilus QST 2808 (NRRL B-30087) (e.g. Sonata® and Ballad® Plus from AgraQuest Inc., USA), B. subtilis GB03 (e.g. Kodiak® or BioYield® from Gustafson, Inc., USA; or Companion® from Growth Products, Ltd., White Plains, N.Y. 10603, USA), B. subtilis GB07 (Epic® from Gustafson, Inc., USA), B. subtilis QST-713 (NRRL B-21661 in Rhapsody®, Serenade® MAX and Serenade® ASO from AgraQuest Inc., USA), B. subtilis var. amyloliquefaciens FZB24 (e.g. Taegro® from Novozyme Biologicals, Inc., USA), B. subtilis var. amyloliquefaciens D747 (e.g. Double Nickel 55 from Certis LLC, USA), B. thuringiensis ssp. aizawai ABTS-1857 (e.g. in XenTari® from BioFa AG, Münsingen, Germany), B. t. ssp. aizawai SAN 401 I, ABG-6305 and ABG-6346, Bacillus t. ssp. israelensis AM65-52 (e.g. in VectoBac® from Valent BioSciences, IL, USA), Bacillus thuringiensis ssp. kurstaki SB4 (NRRL B-50753; e.g. Beta Pro® from Becker Underwood, South Africa), B. t. ssp. kurstaki ABTS-351 identical to HD-1 (ATCC SD-1275; e.g. in Dipel® DF from Valent BioSciences, IL, USA), B. t. ssp. kurstaki EG 2348 (e.g. in Lepinox® or Rapax® from CBC (Europe) S.r.l., Italy), B. t. ssp. tenebrionis DSM 2803 (EP 0 585 215 B1; identical to NRRL B-15939; Mycogen Corp.), B. t. ssp. tenebrionis NB-125 (DSM 5526; EP 0 585 215 B1; also referred to as SAN 418 I or ABG-6479; former production strain of Novo-Nordisk), B. t. ssp. tenebrionis NB-176 (or NB-176-1) a gamma-irridated, induced high-yielding mutant of strain NB-125 (DSM 5480; EP 585 215 B1; Novodor® from Valent BioSciences, Switzerland), Beauveria bassiana ATCC 74040 (e.g. in Naturalis® from CBC (Europe) S.r.l., Italy), B. bassiana DSM 12256 (US 200020031495; e.g. BioExpert® SC from Live Systems Technology S.A., Colombia), B. bassiana GHA (BotaniGard® 22WGP from Laverlam Int. Corp., USA), B. bassiana PPRI 5339 (ARSEF number 5339 in the USDA ARS collection of entomopathogenic fungal cultures; NRRL 50757) (e.g. BroadBand® from Becker Underwood, South Africa), B. brongniartii (e.g. in Melocont® from Agrifutur, Agrianello, Italy, for control of cockchafer; J. Appl. Microbiol. 100(5),1063-72, 2006), Bradyrhizobium sp. (e.g. Vault® from Becker Underwood, USA), B. japonicum (e.g. VAULT® from Becker Underwood, USA), Candida oleophila 1-182 (NRRL Y-18846; e.g. Aspire® from Ecogen Inc., USA, Phytoparasitica 23(3), 231-234, 1995), C. oleophila strain O (NRRL Y-2317; Biological Control 51, 403-408, 2009), Candida saitoana (e.g. Biocure® (in mixture with lysozyme) and BioCoat® from Micro Flo Company, USA (BASF SE) and Arysta), Chitosan (e.g. Armour-Zen® from BotriZen Ltd., NZ), Clonostachys rosea f. catenulata, also named Gliocladium catenulatum (e.g. isolate J 1446: Prestop® from Verdera Oy, Finland), Chromobacterium subtsugae PRAA4-1 isolated from soil under an eastern hemlock (Tsuga canadensis) in the Catoctin Mountain region of central Maryland (e.g. in GRANDEVO from Marrone Bio Innovations, USA), Coniothyrium minitans CON/M/91-08 (e.g. Contans® WG from Prophyta, Germany), Cryphonectria parasitica (e.g. Endothia parasitica from CNICM, France), Cryptococcus albidus (e.g. YIELD PLUS® from Anchor Bio-Technologies, South Africa), Cryptophlebia leucotreta granulovirus (CrleGV) (e.g. in CRYPTEX from Adermatt Biocontrol, Switzerland), Cydia pomonella granulovirus (CpGV) V03 (DSM GV-0006; e.g. in MADEX Max from Andermatt Biocontrol, Switzerland), CpGV V22 (DSM GV-0014; e.g. in MADEX Twin from Adermatt Biocontrol, Switzerland), Delftia acidovorans RAY209 (ATCC PTA-4249; WO 2003/57861; e.g. in BIOBOOST from Brett Young, Winnipeg, Canada), Dilophosphora alopecuri (Twist Fungus from Becker Underwood, Australia), Ecklonia maxima (kelp) extract (e.g. KELPAK SL from Kelp Products Ltd, South Africa), formononetin (e.g. in MYCONATE from Plant Health Care plc, U.K.), Fusarium oxysporum (e.g. BIOFOX® from S.I.A.P.A., Italy, FUSACLEAN® from Natural Plant Protection, France), Glomus intraradices (e.g. MYC 4000 from ITHEC, France), Glomus intraradices RTI-801 (e.g. MYKOS from Xtreme Gardening, USA or RTI Reforestation Technologies International; USA), grapefruit seeds and pulp extract (e.g. BC-1000 from Chemie S.A., Chile), harpin (alpha-beta) protein (e.g. MESSENGER or HARP-N-Tek from Plant Health Care plc, U.K.; Science 257, 1-132, 1992), Heterorhabditis bacteriophaga (e.g. Nemasys® G from Becker Underwood Ltd., UK), Isaria fumosorosea Apopka-97 (ATCC 20874) (PFR-97™ from Certis LLC, USA), cis-jasmone (U.S. Pat. No. 8,221,736), laminarin (e.g. in VACCIPLANT from Laboratoires Goemar, St. Malo, France or Stähler SA, Switzerland), Lecanicillium longisporum KV42 and KV71 (e.g. VERTALEC® from Koppert BV, Netherlands), L. muscarium KV01 (formerly Verticillium lecanii) (e.g. MYCOTAL from Koppert BV, Netherlands), Lysobacter antibioticus 13-1 (Biological Control 45, 288-296, 2008), L. antibioticus HS124 (Curr. Microbiol. 59(6), 608-615, 2009), 03.1T8 (Microbiol. Res. 158, 107-115; Biological Control 31(2), 145-154, 2004), Metarhizium anisopliae var. acridum IMI 330189 (isolated from Omithacris cavroisi in Niger; also NRRL 50758) (e.g. GREEN MUSCLE® from Becker Underwood, South Africa), M. a. var. acridum FI-985 (e.g. GREEN GUARD® SC from Becker Underwood Pty Ltd, Australia), M. anisopliae FI-1045 (e.g. BIOCANE® from Becker Underwood Pty Ltd, Australia), M. anisopliae F52 (DSM 3884, ATCC 90448; e.g. MET52® Novozymes Biologicals BioAg Group, Canada), M. anisopliae ICIPE 69 (e.g. METATHRIPOL from ICIPE, Nairobe, Kenya), Metschnikowia fructicola (NRRL Y-30752; e.g. SHEMER® from Agrogreen, Israel, now distributed by Bayer CropSciences, Germany; U.S. Pat. No. 6,994,849), Microdochium dimerum (e.g. ANTIBOT® from Agrauxine, France), Microsphaeropsis ochracea P130A (ATCC 74412 isolated from apple leaves from an abandoned orchard, St-Joseph-du-Lac, Quebec, Canada in 1993; Mycologia 94(2), 297-301, 2002), Muscodor albus QST 20799 originally isolated from the bark of a cinnamon tree in Honduras (e.g. in development products Muscudor™ or QRD300 from AgraQuest, USA), Neem oil (e.g. TRILOGY®, TRIACT® 70 EC from Certis LLC, USA), Nomuraea rileyi strains SA86101, GU87401, SR86151, CG128 and VA9101, Paecilomyces fumosoroseus FE 9901 (e.g. NO FLY™ from Natural Industries, Inc., USA), P. lilacinus 251 (e.g. in BioAct®MeloCon® from Prophyta, Germany; Crop Protection 27, 352-361, 2008; originally isolated from infected nematode eggs in the Philippines), P. lilacinus DSM 15169 (e.g. NEMATA® SC from Live Systems Technology S.A., Colombia), P. lilacinus BCP2 (NRRL 50756; e.g. PL GOLD from Becker Underwood BioAg SA Ltd, South Africa), mixture of Paenibacillus alvei NAS6G6 (NRRL B-50755), Pantoea vagans (formerly agglomerans) C9-1 (originally isolated in 1994 from apple stem tissue; BlightBan C9-1® from NuFrams America Inc., USA, for control of fire blight in apple; J. Bacteriol. 192(24) 6486-6487, 2010), Pasteuria spp. ATCC PTA-9643 (WO 2010/085795), Pasteuria spp. ATCC SD-5832 (WO 2012/064527), P. nishizawae (WO 2010/80169), P. penetrans (U.S. Pat. No. 5,248,500), P. ramose (WO 2010/80619), P. thomea (WO 2010/80169), P. usgae (WO 2010/80169), Penicillium bilaiae (e.g. Jump Start® from Novozymes Biologicals BioAg Group, Canada, originally isolated from soil in southern Alberta; Fertilizer Res. 39, 97-103, 1994), Phlebiopsis gigantea (e.g. RotStop® from Verdera Oy, Finland), Pichia anomala WRL-076 (NRRL Y-30842; U.S. Pat. No. 8,206,972), potassium bicarbonate (e.g. Amicarb® fromm Stähler SA, Switzerland), potassium silicate (e.g. SiI-MATRIX™ from Certis LLC, USA), Pseudozyma flocculosa PF-A22 UL (e.g. Sporodex® from Plant Products Co. Ltd., Canada), Pseudomonas sp. DSM 13134 (WO 2001/40441, e.g. in PRORADIX from Sourcon Padena GmbH & Co. KG, Hechinger Str. 262, 72072 Tübingen, Germany), P. chloraphis MA 342 (e.g. in CERALL or CEDEMON from BioAgri AB, Uppsala, Sweden), P. fluorescens CL 145A (e.g. in ZEQUANOX from Marrone BioInnovations, Davis, Calif., USA; J. Invertebr. Pathol. 113(1):104-14, 2013), Pythium oligandrum DV 74 (ATCC 38472; e.g. POLYVERSUM® from Remeslo SSRO, Biopreparaty, Czech Rep. and GOWAN, USA; US 2013/0035230), Reynoutria sachlinensis extract (e.g. REGALIA® SC from Marrone BioInnovations, Davis, Calif., USA), Rhizobium leguminosarum bv. phaseolii (e.g. RHIZO-STICK from Becker Underwood, USA), R. I. trifolii RP113-7 (e.g. DORMAL from Becker Underwood, USA; Appl. Environ. Microbiol. 44(5), 1096-1101), R. I. bv. viciae P1NP3Cst (also referred to as 1435; New Phytol 179(1), 224-235, 2008; e.g. in NODULATOR PL Peat Granule from Becker Underwood, USA; or in NODULATOR XL PL bfrom Becker Underwood, Canada), R. I. bv. viciae SU303 (e.g. NODULAID Group E from Becker Underwood, Australia), R. I. bv. viciae WSM1455 (e.g. NODULAID Group F from Becker Underwood, Australia), R. tropici SEMIA 4080 (identical to PRF 81; Soil Biology & Biochemistry 39, 867-876, 2007), Sinorhizobium meliloti MSDJ0848 (INRA, France) also referred to as strain 2011 or RCR2011 (Mol Gen Genomics (2004) 272: 1-17; e.g. DORMAL ALFALFA from Becker Underwood, USA; NITRAGIN® Gold from Novozymes Biologicals BioAg Group, Canada), Sphaerodes mycoparasitica IDAC 301008-01 (WO 2011/022809), Steinemema carpocapsae (e.g. MILLENIUM® from Becker Underwood Ltd., UK), S. feltiae (NEMASHIELD from BioWorks, Inc., USA; NEMASYS® from Becker Underwood Ltd., UK), S. kraussei L137 (NEMASYS® L from Becker Underwood Ltd., UK), Streptomyces griseoviridis K61 (e.g. MYCOSTOP® from Verdera Oy, Espoo, Finland; Crop Protection 25, 468-475, 2006), S. lydicus WYEC 108 (e.g. Actinovate® from Natural Industries, Inc., USA, U.S. Pat. No. 5,403,584), S. violaceusniger YCED-9 (e.g. DT-9® from Natural Industries, Inc., USA, U.S. Pat. No. 5,968,503), Talaromyces 15 flavus V1 17b (e.g. PROTUS® from Prophyta, Germany), Trichoderma asperellum SKT-1 (e.g. ECO-HOPE® from Kumiai Chemical Industry Co., Ltd., Japan), T. asperellum ICC 012 (e.g. in TENET WP, REMDIER WP, BIOTEN WP from Isagro NC, USA, BIO-TAM from AgraQuest, USA), T. atroviride LC52 (e.g. SENTINEL® from Agrimm Technologies Ltd, NZ), T. atroviride CNCM 1-1237 (e.g. in Esquive WG from Agrauxine S.A., France, e.g. against pruning wound diseases on vine and plant root pathogens), T. fertile JM41R (NRRL 50759; e.g. RICHPLUS™ from Becker Underwood Bio Ag SA Ltd, South Africa), T. gamsii ICC 080 (e.g. in TENET WP, REMDIER WP, BIOTEN WP from Isagro NC, USA, BIO-TAM from AgraQuest, USA), T. harzianum T-22 (e.g. PLANTSHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000 from Mycontrol Ltd., Israel and Makhteshim Ltd., Israel), T. harzianum and T. viride (e.g. TRICHOPEL from Agrimm Technologies Ltd, NZ), T. harzianum ICC012 and T. viride ICC080 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (also named Gliocladium virens) (e.g. SOILGARD® from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy) and Ulocladium oudemansii HRU3 (e.g. in BOTRY-ZEN® from Botry-Zen Ltd, NZ). Strains can be sourced from genetic resource and deposition centers: American Type Culture Collection, 10801 University Blvd., Manassas, Va. 20110-2209, USA (strains with ATCC prefic); CABI Europe—International Mycological Institute, Bakeham Lane, Egham, Surrey, TW20 9TYNRRL, UK (strains with prefices CABI and IMI); Centraalbureau voor Schimmelcultures, Fungal Biodiversity Centre, Uppsalaan 8, PO Box 85167, 3508 AD Utrecht, Netherlands (strains with prefic CBS); Division of Plant Industry, CSIRO, Canberra, Australia (strains with prefix CC); Collection Nationale de Cultures de Microorganismes, Institut Pasteur, 25 rue du Docteur Roux, F-75724 PARIS Cedex 15 (strains with prefix CNCM); Leibniz-lnstitut DSMZ-Deutsche Sammlung von Mikroorganismen und Zellkulturen GmbH, Inhoffenstraβe 7 B, 38124 Braunschweig, Germany (strains with prefix DSM); Intemational Depositary Authority of Canada Collection, Canada (strains with prefix IDAC); International Collection of Micro-organisms from Plants, Landcare Research, Private Bag 92170, Auckland Mail Centre, Auckland 1142, New Zealand (strans with prefix ICMP); IITA, PMB 5320, Ibadan, Nigeria (strains with prefix IITA); The National Collections of Industrial and Marine Bacteria Ltd., Torry Research Station, P.O. Box 31, 135 Abbey Road, Aberdeen, AB9 8DG, Scotland (strains with prefix NCIMB); ARS Culture Collection of the National Center for Agricultural Utilization Research, Agricultural Research Service, U.S. Department of Agriculture, 1815 North University Street, Peoria, Ill. 61604, USA (strains with prefix NRRL); Department of Scientific and Industrial Research Culture Collection, Applied Biochemistry Division, Palmerston North, New Zealand (strains with prefix NZP); FEPAGRO-Fundaçäo Estadual de Pesquisa Agropecuäria, Rua Gonçalves Dias, 570, Bairro Menino Deus, Porto Alegre/RS, Brazil (strains with prefix SEMIA); SARDI, Adelaide, South Australia (strains with prefix SRDI); U.S. Department of Agriculture, Agricultural Research Service, Soybean and Alfalfa Research Laboratory, BARC-West, 10300 Baltimore Boulevard, Building 011, Room 19-9, Beltsville, Md. 20705, USA (strains with prefix USDA: Beltsville Rhizobium Culture Collection Catalog March 1987 USDA-ARS ARS-30: http://pdf.usaid.gov/pdf_docs/PNAAW89i .pdf); and Murdoch University, Perth, Western Australia (strains with prefix WSM). Further strains may be found at the Global catalogue of Microorganisms: http://gcm.wfcc.info/ and http://www.landcareresearch.co.nz/resources/collectionsicmp and further references to strain collections and their prefixes at http://refs.wdcm.org/collections.htm. Bacillus amyloliquefaciens subsp. plantarum MBI600 (NRRL B-50595) is deposited under accession number NRRL B-50595 with the strain designation Bacillus subtilis 1430 (and identical to NCIMB 1237). Recently, MBI 600 has been re-classified as Bacillus amyloliquefaciens subsp. plantarum based on polyphasic testing which combines classical microbiological methods relying on a mixture of traditional tools (such as culture-based methods) and molecular tools (such as genotyping and fatty acids analysis). Thus, Bacillus subtilis MBI600 (or MBI 600 or MBI-600) is identical to Bacillus amyloliquefaciens subsp. plantarum MBI600, formerly Bacillus subtilis MBI600. Bacillus amyloliquefaciens MBI600 is known as plant growth-promoting rice seed treatment from Int. J. Microbiol. Res. 3(2) (2011), 120-130 and further described e.g. in US 2012/0149571 A1. This strain MBI600 is e.g. commercially available as liquid formulation product INTEGRAL® (Becker-Underwood Inc., USA). Bacillus subtilis strain FB17 was originally isolated from red beet roots in North America (System Appl. Microbiol 27 (2004) 372-379). This B. subtilis strain promotes plant health (US 2010/0260735 A1; WO 2011/109395 A2). B. subtilis FB17 has also been deposited at ATCC under number PTA-11857 on Apr. 26, 2011. Bacillus subtilis strain FB17 may be referred elsewhere to as UD1022 or UD10-22.

Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. japonicum SEMIA 5079 (e.g. Gelfix 5 or Adhere 60 from Nitral Urbana Laoboratories, Brazil, a BASF Company), B. japonicum SEMIA 5080 (e.g. GELFIX 5 or ADHERE 60 from Nitral Urbana Laoboratories, Brazil, a BASF Company), B. mojavensis AP-209 (NRRL B-50616), B. solisalsi AP-217 (NRRL B-50617), B. pumilus strain INR-7 (otherwise referred to as BU-F22 (NRRL B-50153) and BU-F33 (NRRL B-50185)), B. simplex ABU 288 (NRRL B-50340) and B. amyloliquefaciens subsp. plantarum MBI600 (NRRL B-50595) have been mentioned i.a. in US patent appl. 20120149571, U.S. Pat. No. 8,445,255, WO 2012/079073. Bradyrhizobium japonicum USDA 3 is known from U.S. Pat. No. 7,262,151. Jasmonic acid or salts (jasmonates) or derivatives include without limitation potassium jasmonate, sodium jasmonate, lithium jasmonate, ammonium jasmonate, dimethyl-ammonium jasmonate, isopropylammonium jasmonate, diolammonium jasmonate, diethtriethanolammonium jasmonate, jasmonic acid methyl ester, jasmonic acid amide, jasmonic acid methylamide, jasmonic acid-L-amino acid (amide-linked) conjugates (e.g., conjugates with L-isoleucine, L-valine, L-leucine, or L-phenylalanine), 12-oxo-phytodienoic acid, coronatine, coronafacoyl-L-serine, coronafacoyl-L-threonine, methyl esters of 1-oxo-indanoyl-isoleucine, methyl esters of 1-oxo-indanoyl-leucine, coronalon (2-[(6-ethyl-1-oxo-indane-4-carbonyl)-amino]-3-methyl-pentanoic acid methyl ester), linoleic acid or derivatives thereof and cis-jasmone, or combinations of any of the above.

Humates are humic and fulvic acids extracted from a form of lignite coal and clay, known as leonardite. Humic acids are organic acids that occur in humus and other organically derived materials such as peat and certain soft coal. They have been shown to increase fertilizer efficiency in phosphate and micro-nutrient uptake by plants as well as aiding in the development of plant root systems.

According to one embodiment of the inventive mixtures, the at least one pesticide II is selected from the groups L1) to L6):

L1) Microbial pesticides with fungicidal, bactericidal, viricidal and/or plant defense activator activity: Ampelomyces quisqualis M-10, Aspergillus flavus NRRL 21882, Aureobasidium pullulans DSM 14940, A. pullulans DSM 14941, Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. amyloliquefaciens FZB42, B. amyloliquefaciens IN937a, B. amyloliquefaciens IT-45 (CNCM 1-3800), B. amyloliquefaciens subsp. plantarum MBI600 (NRRL B-50595), B. mojavensis AP-209 (NRRL B-50616), B. pumilus INR-7 (otherwise referred to as BU-F22 (NRRL B-50153) and BU-F33 (NRRL B-50185)), B. pumilus KFP9F, B. pumilus QST 2808 (NRRL B-30087), B. pumilus GHA 181, B. simplex ABU 288 (NRRL B-50340), B. solisalsi AP-217 (NRRL B-50617), B. subtilis CX-9060, B. subtilis GB03, B. subtilis GB07, B. subtilis QST-713 (NRRL B-21661), B. subtilis var. amyloliquefaciens FZB24, B. subtilis var. amyloliquefaciens D747, Candida oleophila 1-82, C. oleophila O, C. saitoana, Clavibacter michiganensis (bacteriophages), Coniothyrium minitans CON/M/91-08, Cryphonectria parasitica, Cryptococcus albidus, Dilophosphora alopecuri, Fusarium oxysporum, Clonostachys rosea f. catenulata J1446 (also named Gliocladium catenulatum), Gliocladium roseum 321U, Metschnikowia fructicola NRRL Y-30752, Microdochium dimerum, Microsphaeropsis ochracea P130A, Muscodor albus QST 20799, Paenibacillus polymyxa PKB1 (ATCC 202127), Pantoea vagans C9-1, Phlebiopsis gigantea, Pichia anomala WRL-76, Pseudozyma flocculosa PF-A22 UL, Pythium oligandrum DV 74, Sphaerodes mycoparasitica IDAC 301008-01, Streptomyces griseovirids K61, S. lydicus WYEC 108, S. violaceusniger XL-2, S. violaceusniger YCED-9, Talaromyces flavus V1 17b, Trichoderma asperellum T34, T. asperellum SKT-1, T. asperellum ICC 012, T. atroviride LC52, T. atroviride CNCM I-1237, T. fertile JM41R, T. gamsii ICC 080, T. harmatum TH 382, T. harzianum TH-35, T. harzianum T-22, T. harzianum T-39; mixture of T. harzianum ICC012 and T. viride ICC080; mixture of T. polysporum and T. harzianum; T. stromaticum, T. virens (also named Gliocladium virens) GL-21, T. virens G41, T. viride TV1, Typhula phacorrhiza 94671, Ulocladium oudemansii HRU3, Verticillium dahlia, zucchini yellow mosaic virus (avirulent strain);
L2) Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium bicarbonate, Reynoutria sachlinensis extract, salicylic acid, sodium bicarbonate, tea tree oil;
L3) Microbial pesticides with insecticidal, acaricidal, molluscidal and/or nematicidal activity: Agrobacterium radiobacter K1026, A radiobacter K84, Bacillus firmus 1-1582, B. thuringiensis ssp. aizawai strains ABTS-1857, SAN 401 I, ABG-6305 and ABG-6346, B. t. ssp. israelensis AM65-52, B. t. ssp. israelensis SUM-6218, B. t. ssp. galleriae SDS-502, B. t. ssp. kurstaki EG 2348, B. t. ssp. kurstaki SB4, B. t. ssp. kurstaki ABTS-351 (HD-1), Beauveria bassiana ATCC 74040, B. bassiana GHA, B. bassiana H123, B. bassiana DSM 12256, B. bassiana PPRI 5339, B. brongniartii, Burkholderia sp. A396, Chromobacterium subtsugae PRAA4-1, Cydia pomonella granulosis virus V22, Cydia pomonella granulosis virus V1, Isaria fumosorosea Apopka-97, Lecanicillium longisporum KV42, L. longisporum KV71, L. muscarium (formerly Verticillium lecanii) KV01, Metarhizium anisopliae FI-985, M. anisopliae FI-1045, M. anisopliae F52, M. anisopliae ICIPE 69, M. anisopliae var. acridum IMI 330189, Nomuraea rileyi strains SA86101, GU87401, SR86151, CG128 and VA9101, Paecilomyces fumosoroseus FE 9901, P. lilacinus 251, P. lilacinus DSM 15169, P. lilacinus BCP2, Paenibacillus popilliae Dutky-1940 (NRRL B-2309=ATCC 14706), P. popilliae KLN 3, P. popilliae Dutky 1, Pasteuria spp. Ph3, Pasteuria spp. ATCC PTA-9643, Pasteuria spp. ATCC SD-5832, P. nishizawae PN-1, P. penetrans, P. ramose, P. reneformis Pr-3, P. thomea, P. usgae, Pseudomonas fluorescens CL 145A, Steinemema carpocapsae, S. feltiae, S. kraussei L137;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, cis-jasmone, lavanulyl senecioate, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-11-tetradecenal, Z-11-tetradecen-1-ol, Acacia negra extract, extract of grapefruit seeds and pulp, extract of Chenopodium ambrosiodae, Catnip oil, Neem oil, Quillay extract, Tagetes oil;

L5) Microbial pesticides with plant stress reducing, plant growth regulator, plant growth promoting and/or yield enhancing activity: Azospirillum amazonense BR 11140(SpY2T), A. brasilense AZ39, A. brasilense XOH, A. brasilense BR 11005 (Sp245), A. brasilense BR 11002, A. lipoferum BR 11646 (Sp31), A. irakense, A. halopraeferens, Bradyrhizobium sp. PNL01, B. sp. (Arachis) CB1015, B. sp. (Arachis) USDA 3446, B. sp. (Arachis) SEMIA 6144, B. sp. (Arachis) SEMIA 6462, B. sp. (Arachis) SEMIA 6464, B. sp. (Vigna), B. elkanii SEMIA 587, B. elkanii SEMIA 5019, B. elkanii U-1301, B. elkanii U-1302, B. elkanii USDA 74, B. elkanii USDA 76, B. elkanii USDA 94, B. elkanii USDA 3254, B. japonicum 532c, B. japonicum CPAC 15, B. japonicum E-109, B. japonicum G49, B. japonicum TA-11, B. japonicum USDA 3, B. japonicum USDA 31, B. japonicum USDA 76, B. japonicum USDA 110, B. japonicum USDA 121, B. japonicum USDA 123, B. japonicum USDA 136, B. japonicum SEMIA 566, B. japonicum SEMIA 5079, B. japonicum SEMIA 5080, B. japonicum WB74, B. liaoningense, B. lupini LL13, B. lupini WU425, B. lupini WSM471, B. lupini WSM4024, Glomus intraradices RTI-801, Mesorhizobium sp. WSM1271, M. sp. WSM1497, M. cicen CC1192, M. huakii, M. loti CC829, M. loti SU343, Paenibacillus alvei NAS6G6, Penicillium bilaiae, Rhizobium leguminosarum bv. phaseolii, R. I. trifolii RP113-7, R. I. bv. viciae SU303, R. I. bv. viciae WSM1455, R. I. bv. viciae P1NP3Cst, R. tropici SEMIA 4088, Sinorhizobium meliloti MSDJ0848;

L6) Biochemical pesticides with plant stress reducing, plant growth regulator and/or plant yield enhancing activity: abscisic acid, aluminium silicate (kaolin), 3-decen-2-one, formononectin, genistein, hesperetin, homobrassinlide, humates, methyl jasmonate, cis-jasmone, lysophosphatidyl ethanlamine, naringenin, polymeric polyhydroxy acid, salicylic acid, Ascophyllum nodosum (Norwegian kelp, Brown kelp) extract and Ecklonia maxima (kelp) extract.

The present invention furthermore relates to agrochemical mixtures comprising a mixture of an oligomer formed from a monomer of formula I (component 1) and at least one biopesticide selected from the group L) (component 2), in particular at least one further fungicidal biopesticide selected from the groups L1) and L2), as described above, and if desired at least one suitable auxiliary.

Preference is also given to mixtures comprising as pesticide II (component 2) a biopesticide from group L1), preferably selected from Bacillus amyloliquefaciens AP-136 (NRRL B-50614 and B-50330), B. amyloliquefaciens AP-188 (NRRL B-50615 and B-50331), B. amyloliquefaciens AP-218 (NRRL B-50618), B. amyloliquefaciens AP-219 (NRRL B-50619 and B-50332), B. amyloliquefaciens AP-295 (NRRL B-50620 and B-50333), B. amyloliquefaciens IT-45 (CNCM 1-3800), B. amyloliquefaciens subsp. plantarum MBI600 (NRRL B-50595), B. mojavensis AP-209 (NRRL B-50616), B. pumilus INR-7 (otherwise referred to as BU-F22 (NRRL B-50153) and BU-F33 (NRRL B-50185)), B. pumilus KFP9F, B. pumilus QST 2808 (NRRL B-30087), B. pumilus GHA 181, B. simplex ABU 288 (NRRL B-50340), B. solisalsi AP-217 (NRRL B-50617), B. subtilis CX-9060, B. subtilis GB03, B. subtilis GB07, B. subtilis QST-713 (NRRL B-21661), B. subtilis var. amyloliquefaciens FZB24, B. subtilis var. amyloliquefaciens D747, Paenibacillus alvei NAS6G6, Paenibacillus polymyxa PKB1 (ATCC 202127), Sphaerodes mycoparasitica IDAC 301008-01 and Trichoderma fertile JM41R, even more preferably from Bacillus amyloliquefaciens AP-136 (NRRL B-50614), B. amyloliquefaciens AP-188 (NRRL B-50615), B. amyloliquefaciens AP-218 (NRRL B-50618), B. amyloliquefaciens AP-219 (NRRL B-50619), B. amyloliquefaciens AP-295 (NRRL B-50620), B. amyloliquefaciens IT-45 (CNCM 1-3800), B. mojavensis AP-209 (NRRL B-50616), B. pumilus INR-7 (otherwise referred to as BU-F22 (NRRL B-50153) and BU-F33 (NRRL B-50185)), B. pumilus QST 2808 (NRRL B-30087), B. simplex ABU 288 (NRRL B-50340), B. subtilis QST-713 (NRRL B-21661), B. subtilis MBI600 (NRRL B-50595), Paenibacillus alvei NAS6G6, Sphaerodes mycoparasitica IDAC 301008-01 and Trichoderma fertile JM41R.

According to one embodiment of the inventive mixtures, the at least one pesticide II is Bacillus amyloliquefaciens subsp. plantarum MBI600. These mixtures are particularly suitable in soybean.

According to another embodiment of the inventive mixtures, the at least one pesticide II is B. pumilus strain INR-7. These mixtures are particularly suitable in soybean and corn.

According to a further embodiment, the at least one pesticide II is Bacillus simplex, preferably B. simplex strain ABU 288. These mixtures are particularly suitable in soybean and corn.

According to one embodiment of the inventive mixtures, the at least one pesticide II is selected from Bacillus amyloliquefaciens AP-136, B. amyloliquefaciens AP-188, B. amyloliquefaciens AP-218, B. amyloliquefaciens AP-219, B. amyloliquefaciens AP-295, B. amyloliquefaciens FZB42, B. amyloliquefaciens IN937a, B. amyloliquefaciens IT-45, B. amyloliquefaciens subsp. plantarum MBI600, B. mojavensis AP-209, B. pumilus GB34, B. pumilus INR-7, B. pumilus KFP9F, B. pumilus QST 2808, B. pumilus GHA 181, B. simplex ABU 288, B. solisalsi AP-217, B. subtilis CX-9060, B. subtilis GBO03, B. subtilis GBO7, B. subtilis QST-713, B. subtilis var. amyloliquefaciens FZB24 and B. subtilis var. amyloliquefaciens D747. These mixtures are particularly suitable in soybean and corn, in particular for seed treatment.

According to a further embodiment, the at least one pesticide II is selected from Streptomyces spp. Preferably from S. griseoviridis, S. lydicus and S. violaceusniger, in particular from strains S. griseoviridis K61, S. lydicus WYEC 108, S. violaceusniger XL-2 and S. violaceusniger YCED-9.

According to a further embodiment, the at least one pesticide II is Sphaerodes mycoparasitica, preferably Sphaerodes mycoparasitica strain IDAC 301008-01 (also referred to as strain SMCD2220-01). These mixtures are particularly suitable in soybean, cereals and corn, in particular corn especially to combat Fusarium head blight.

The present invention also relates to mixtures wherein the at least one pesticide II is selected from the following yests and fungi: Ampelomyces quisqualis, in particular strain AQ 10, Aureobasidium pullulans, in particular blastospores of strain DSM14940 or blastospores of strain DSM 14941 or mixtures thereof; Candida oleophila, in particular strains 1-182 and O, Coniothyrium minitans, in particular strain CON/M/91-8; Dilophosphora alopecuri which reduces annual ryegrass toxicity (ARGT), a disease of livestock resulting from the ingestion of annual ryegrass seed-heads that have been infected by the toxin producing bacterium Rathayibacter toxicus; Gliocladium catenulatum, in particular strain J 1446; Metschnikovia fructicola, in particular strain NRRL Y-30752, Microsphaeropsis ochracea, in particular strain P130A for control of apple scab; (2.13) Muscodor albus, in particular strain QST 20799, Pichia anomala, in particular strain WRL-076, Pseudozyma flocculosa, in particular strain PF-A22 UL; Pythium oligandrum, in particular strain DV74;

The present invention also relates to mixtures wherein the at least one pesticide II is selected from the fungal genus Trichoderma, preferably from the strains Trichoderma asperellum T34, T. asperellum SKT-1, T. asperellum ICC 012, T. atroviride LC52, T. atroviride CNCM 1-1237, T. fertile JM41R, T. gamsii ICC 080, T. harmatum TH 382, T. harzianum TH-35, T. harzianum T-22, T. harzianum T-39; mixture of T. harzianum ICC012 and T. viride ICC080; mixture of T. polysporum and T. harzianum; T. stromaticum, T. virens GL-21, T. virens G41 and T. viride TV1; in particular T. fertile JM41R.

The present invention also relates to mixtures wherein the at least one pesticide II is selected from the fungal genus Ulocladium, in particular U. oudemansii HRU3. Preference is also given to mixtures comprising as pesticide II (component 2) a biopesticide from group L2), preferably selected from chitosan (hydrolysate), methyl-jasmonate, cis-jasmone, laminarin, Reynoutria sachlinensis extract and tea tree oil; even more preferable from methyl jasmonate and laminarin.

Preference is also given to mixtures comprising as pesticide II (component 2) a biopesticide from group L3), preferably selected from Agrobacterium radiobacter K1026, Bacillus firmus 1-1582, Bacillus thuringiensis ssp. kurstaki SB4, Beauveria bassiana GHA, B. bassiana H123, B. bassiana DSM 12256, B. bassiana PPRI 5339, Metarhizium anisopliae var. acridum IMI 330189, M. anisopliae FI-985, M. anisopliae FI-1045, M. anisopliae F52, M. anisopliae ICIPE 69, Paecilomyces lilacinus DSM 15169, P. lilacinus BCP2, Paenibacillus popilliae Dutky-1940 (NRRL B-2309=ATCC 14706), P. popilliae KLN 3 and P. popilliae Dutky 1, even more preferably from Bacillus thuringiensis ssp. kurstaki SB4, B. bassiana DSM 12256, B. bassiana PPRI 5339, Metarhizium anisopliae var. acridum IMI 330189, M. anisopliae FI-985, M. anisopliae FI-1045, Paecilomyces lilacinus DSM 15169, P. lilacinus BCP2, Paenibacillus popilliae Dutky-1940 (NRRL B-2309=ATCC 14706), P. popilliae KLN 3 and P. popilliae Dutky 1.

According to a further embodiment, the at least one pesticide II is Beauveria bassiana, preferably selected from Beauveria bassiana ATCC 74040, B. bassiana GHA, B. bassiana H123, B. bassiana DSM 12256 and B. bassiana PPRI 5339, in particular Beauveria bassiana strain PPRI 5339. These mixtures are particularly suitable for wide range of arthropod pests, such as white flies, thrips, mites, aphids, tingids and all their developmental stages (eggs, immature stages, and adults) infesting numerous crops (vegetables, cucurbits, solanaceous fruits, strawberry, flowers and ornmentals, grapevine, citrus, pome, stone fruits, etc.). Recent studies have shown that these antagonistic fungal strains can effectively control also nut-weevils, wireworms (Agriotes spp.), and Tephritid flies, such as the Mediterranean fruit fly, Ceratitis capitata, the cherry fruit fly, Rhagoletis cerasi, and the olive fly, Bactrocera oleae. They are also useful in soybean and corn.

According to a further embodiment, the at least one pesticide II is Beauveria brongniartii.

According to a further embodiment, the at least one pesticide II is Metarhizium anisopliae or M. anisopliae var. acridium, preferably selected from M. anisopliae FI-1045, M. anisopliae F52, M. anisopliae var. acridum strains FI-985 and IMI 330189, in particular strain IMI 330189. These mixtures are particularly suitable for control of arthropod pests in soybean and corn.

According to a further embodiment, the at least one pesticide II is Lecanicillium sp., preferably selected from Lecanicillium longisporum KV42, L. longisporum KV71 and L. muscarium (formerly Verticillium lecanii) KV01.

According to a further embodiment, the at least one pesticide II is Paecilomyces fumosoroseus, preferably strain FE 9901 especially for white fly control.

According to a further embodiment, the at least one pesticide II is selected from Nomuraea rileyi, preferably strains SA86101, GU87401, SR86151, CG128 and VA9101; and P. lilacinus, preferably strains 251, DSM 15169 or BCP2, in particular BCP2, which strains especially control the growth of plant-pathogenic nematodes.

According to a further embodiment, the at least one pesticide II is Bacillus firmus, preferably spores of strain CNCM 1-1582, preferable for seed treatment of soybean and corn against nematodes and insects.

According to a further embodiment, the at least one pesticide II is B. cereus preferably spores of CNCM 1-1562, preferable for seed treatment of soybean and corn against nematodes and insects.

According to a further embodiment, the at least one pesticide II is a mixture of spores of B. firmus and B. cereus, preferably mixtures spores of strains CNCM 1-1582 and CNCM 1-1562, preferable for seed treatment of soybean and corn against nematodes and insects.

According to a further embodiment, the at least one pesticide II is selected from Bacillus thuringiensis, preferably B. thuringiensis ssp. aizawai, in particular B. t. ssp. aizawai strains ABTS-18, SAN 401 I, ABG-6305 and ABG-6346, which are effective against different lepidopteran species including also noctuidae.

According to a further embodiment, the at least one pesticide II is selected from Bacillus t. ssp. israelensis, preferably AM65-52, SAN 402 I and ABG-6164, which are applied against larvae of various dipteran pests, e.g. mosquitoes and nematoceres.

According to a further embodiment, the at least one pesticide II is selected from Bacillus t. ssp. kurstaki preferably from strains EG 2348, SB4 and ABTS-351 (HD-1), in particular B. thuringiensis ssp. kurstaki SB4. These strains are used for control of lepidopteran larvae, but without noctuidae.

According to a further embodiment, the at least one pesticide II is selected from Bacillus thuringiensis subsp. tenebrionis, preferably the strains DSM 2803, NB-125 and NB-176, in particular NB-176, which all protect plants e.g. against leaf beetle larvae.

Preference is also given to mixtures comprising as pesticide II (component 2) a biopesticide from group L4), preferably selected from methyl jasmonate, Acacia negra extract, extract of grapefruit seeds and pulp, Catnip oil, Neem oil, Quillay extract and Tagetes oil, in particular methyl jasmonate or water-based Quillay extract.

Preference is also given to mixtures comprising as pesticide II (component 2) a biopesticide from group L5), preferably selected from Azospirillum amazonense BR 11140 (SpY2T), A. brasilense XOH, A. brasilense BR 11005 (Sp245), A. brasilense BR 11002, A. lipoferum BR 11646 (Sp31), A. irakense, A. halopraeferens, Bacillus amyloliquefaciens AP-136 (NRRL B-50614), Bradyrhizobium sp. (Vigna), B. japonicum USDA 3, B. japonicum USDA 31, B. japonicum USDA 76, B. japonicum USDA 110, B. japonicum USDA 121, Glomus intraradices RTI-801, Paenibacillus alvei NAS6G6, Penicillium bilaiae, Rhizobium leguminosarum bv. phaseolii, R. I. trifolii, R. I. bv. viciae, and Sinorhizobium meliloti, more preferably selected from Azospirillum brasilense BR 11005 (Sp245), Bradyrhizobium sp. (Vigna), B. japonicum USDA 3, B. japonicum USDA 31, B. japonicum USDA 76, B. japonicum USDA 110, B. japonicum USDA 121, Rhizobium leguminosarum bv. phaseolii, R. I. trifolii, R. I. bv. viciae SU303, R. I. bv. viciae WSM1455, and Sinorhizobium meliloti MSDJ0848.

According to another embodiment of the inventive mixtures, Bradyrhizobium sp. (meaning any Bradyrhizobium species and/or strain) as pesticide II is Bradyrhizobium japonicum (B. japonicum). These mixtures are particularly suitable in soybean. B. japonicum strains were cultivated using media and fermentation techniques known in the art, e.g. in yeast extract-mannitol broth (YEM) at 27° C. for about 5 days.

The present invention also relates to mixtures, wherein the at least one pesticide II is selected from Bradyrhizobium japonicum (B. japonicum) and further comprises a pesticide III, wherein pesticide III is selected from jasmonic acid or salts or derivatives thereof including cis-jasmone, preferably methyl-jasmonate or cis-jasmone.

References for various B. japonicum strains are given e.g. in U.S. Pat. No. 7,262,151 (B. japonicum strains USDA 110 (=IITA 2121, SEMIA 5032, RCR 3427, ARS 1-110, Nitragin 61A89; isolated from Glycine max in Florida in 1959, Serogroup 110; Appl Environ Microbiol 60, 940-94, 1994), USDA 31 (=Nitragin 61A164; isolated from Glycine max in Wisoconsin in 1941, USA, Serogroup 31), USDA 76 (plant passage of strain USDA 74 which has been isolated from Glycine max in California, USA, in 1956, Serogroup 76), USDA 121 (isolated from Glycine max in Ohio, USA, in 1965), USDA 3 (isolated from Glycine max in Virginia, USA, in 1914, Serogroup 6), USDA 121 (Crop Science 26(5), 911-916, 1986) and USDA 136 (=CB 1809, SEMIA 586, Nitragin 61A136, RCR 3407; isolated from Glycine max in Beltsville, Md. in 1961; Appl Environ Microbiol 60, 940-94, 1994). Further suitable B. japonicum strain G49 (INRA, Angers, France) is described in Fernandez-Flouret, D. & Cleyet-Marel, J. C. (1987) C R Acad Agric Fr 73, 163-171), especially for soybean grown in Europe, in particular in France. Further suitable B. japonicum strain TA-11 (TA11 NOD⁺) (NRRL B-18466) is i.a. described in U.S. Pat. No. 5,021,076; Appl Environ Microbiol (1990) 56, 2399-2403 and commercially available as liquid inoculant for soybean (VAULT® NP, Becker Underwood, USA). Further B. japonicum strains as example for pesticide II are described in US2012/0252672A. Further suitable and especially in Canada commercially available strain 532c (The Nitragin Company, Milwaukee, Wis., USA, field isolate from Wisconsin; Nitragin strain collection No. 61A152; Can J Plant Sci 70 (1990), 661-666) (e.g. in RHIZOFLO, HISTICK, HICOAT Super from Becker Underwood, Canada). Preferably, B. japonicum is selected from strains TA-11 and 532c, more preferably a mixture of B. japonicum strains TA-11 and 532c.

Other suitable and commercially available B. japonicum strains (see e.g. Appl Environ Microbiol 2007, 73(8), 2635) are SEMIA 566 (isolated from North American inoculant in 1966 and used in Brazilian commercial inoculants from 1966 to 1978), SEMIA 586 (=CB 1809; originally isolated in Maryland, USA but received from Australia in 1966 and used in Brazilian inoculants in 1977), CPAC 15 (=SEMIA 5079; a natural variant of SEMIA 566 used in commercial inoculants since 1992) and CPAC 7 (=SEMIA 5080; a natural variant of SEMIA 586 used in commercial inoculants since 1992). These strains are especially suitable for soybean grown in Australia or South America, in particular in Brazil. In particular, mixtures of B. japonicum SEMIA 5079 and SEMIA 5080 are suitable. Some of the abovementioned strains have been re-classified as a novel species Bradyrhizobium elkanii, e.g. strain USDA 76 (Can. J. Microbiol., 1992, 38, 501-505).

Another suitable and commercially available B. japonicum strain is E-109 (variant of strain USDA 138, see e.g. Eur. J. Soil Biol. 45 (2009) 28-35; Biol Fertil Soils (2011) 47:81-89, deposited at Agriculture Collection Laboratory of the Instituto de Microbiologia y Zoologia Agncola (IMYZA), Instituto Nacional de Tecnologi'a Agropecuaria (INTA), Castelar, Argentina). This strain is especially suitable for soybean grown in South America, in particular in Argentina.

Another suitable and commercially available B. japonicum strain are WB74 or WB74-1 (e.g. from Stimuplant CC, South Africa or from SoyGro Bio-Fertilizer Ltd, South Africa). These strains are especially suitable for soybean grown in South America and Africa, in particular in South Africa.

The present invention also relates to mixtures, wherein the at least one pesticide II is selected from Bradyrhizobium elkanii and Bradyrhizobium liaoningense (B. elkanii and B. liaoningense), more preferably from B. elkanii. These mixtures are particularly suitable in soybean. B. elkanii and liaoningense were cultivated using media and fermentation techniques known in the art, e.g. in yeast extract-mannitol broth (YEM) at 27° C. for about 5 days.

The present invention also relates to mixtures wherein the at least one pesticide II is selected from selected from B. elkanii and B. liaoningense and further comprises a pesticide III, wherein pesticide III is selected from jasmonic acid or salts or derivatives thereof including cis-jasmone, preferably methyl-jasmonate or cis-jasmone. Suitable and commercially available B. elkanii strains are SEMIA 587 and SEMIA 5019 (=29W) (see e.g. Appl Environ Microbiol 2007, 73(8), 2635) and USDA 3254 and USDA 76 and USDA 94. Preferably, mixtures of B. elkanii strains SEMIA 587 and SEMIA 5019 are useful (e.g. in Gelfix 5 from Nitral Urbana Laboratories, Brazil, a BASF Company). Further commercially available B. elkanii strains are U-1301 and U-1302 (e.g. product Nitroagin® Optimize from Novozymes Bio As S.A., Brazil or NITRASEC for soybean from LAGE y Cia, Brazil). These strains are especially suitable for soybean grown in Australia or South America, in particular in Brazil.

The present invention also relates to mixtures, wherein pesticide II is selected from Bradyrhizobium sp. (Arachis) (B. sp. Arachis) which shall describe the cowpea miscellany cross-inoculation group which includes inter alia indigenous cowpea bradyrhizobia on cowpea (Vigna unguiculata), siratro (Macroptilium atropurpureum), lima bean (Phaseolus lunatus), and peanut (Arachis hypogaea). This mixture comprising as pesticide II B. sp. Arachis is especially suitable for use in peanut, Cowpea, Mung bean, Moth bean, Dune bean, Rice bean, Snake bean and Creeping vigna, in particular peanut.

The present invention also relates to mixtures wherein the at least one pesticide II is selected from B. sp. (Arachis) and further comprises a pesticide III, wherein pesticide III is selected from jasmonic acid or salts or derivatives thereof including cis-jasmone, preferably methyl-jasmonate or cis-jasmone.

Suitable and commercially available B. sp. (Arachis) strain is CB1015 (=IITA 1006, USDA 3446 presumably originally collected in India; from Australian Inoculants Research Group; see e.g. http://www.qaseeds.com.au/inoculant_applic.php). These strains are especially suitable for peanut grown in Australia, North America or South America, in particular in Brazil. Further suitable strain is Bradyrhizobium sp. PNL01 (Becker Underwood; Bisson and Mason, Apr. 29, 2010, Project report, Worcester Polytechnic Institute, Worcester, Mass., USA: http://www.wpi.edu/Pubs/E-project/Available/E-project-042810-163614/).

Suitable and commercially available Bradyrhizobium sp. (Arachis) strains especially for cowpea and peanut but also for soybean are Bradyrhizobium SEMIA 6144, SEMIA 6462 (=BR 3267) and SEMIA 6464 (=BR 3262; see e.g. FEMS Microbiology Letters (2010) 303(2), 123-131; Revista Brasileira de Ciencia do Solo (2011) 35(3); 739-742, ISSN 0100-0683).

The present invention also relates to mixtures, wherein the at least one pesticide II is selected from Bradyrhizobium sp. (Lupine) (also called B. lupini, B. lupines or Rhizobium lupini). This mixture is especially suitable for use in dry beans and lupins.

The present invention also relates to mixtures wherein the at least one pesticide II is selected from Bradyrhizobium sp. (Lupine) (B. lupini) and further comprises a pesticide III, wherein pesticide III is selected from jasmonic acid or salts or derivatives thereof including cis-jasmone, preferably methyl-jasmonate or cis-jasmone.

Suitable and commercially available B. lupini strain is LL13 (isolated from Lupinus iuteus nodules from French soils; deposited at INRA, Dijon and Angers, France; http://agriculture.gouv.fr/IMG/pdf/ch20060216.pdf). This strain is especially suitable for lupins grown in Australia, North America or Europe, in particular in Europe.

Further suitable and commercially available B. lupini strains WU425 (isolated in Esperance, Western Australia from a non-Australian legume Omthopus compressus), WSM4024 (isolated from lupins in Australia by CRS during a 2005 survey) and WSM471 (isolated from Omithopus pinnatus in Oyster Harbour, Western Australia) are described e.g. in Palta J. A. and Berger J. B. (eds), 2008, Proceedings 12^{th} International Lupin Conference, 14-18 Sept. 2008, Fremantle, Westem Australia. International Lupin Association, Canterbury, New Zealand, 47-50, ISBN 0-86476-153-8: http://www.lupins.org/pdf/conference/2008/Agronomy %20and %20Production/John %20 Howieson %20and %20G %20OHara.pdf; Appl. Environ. Microbiol. 71, 7041-7052, 2005; Australian J. Exp. Agricult. 36(1), 63-70, 1996.

The present invention also relates to mixtures, wherein the at least one pesticide II is selected from Mesorhizobium sp. (meaning any Mesorhizobium species and/or strain), more preferably Mesorhizobium ciceri. These mixtures are particularly suitable in cowpea.

The present invention also relates to mixtures wherein the at least one pesticide II is selected from Mesorhizobium sp. and further comprises a pesticide III, wherein pesticide III is selected from jasmonic acid or salts or derivatives thereof including cis-jasmone, preferably methyl-jasmonate or cis-jasmone.

Suitable and commercially available Mesorhizobium sp. strains are e.g. M. ciceri CC1192 (=UPM 848, CECT 5549; from Horticultural Research Station, Gosford, Australia; collected in Israel from Cicer arietinum nodules; Can J Microbial (2002) 48, 279-284) and Mesorhizobium sp. strains WSM1271 (collected in Sardinia, Italy, from plant host Biserrula pelecinus), WSM 1497 (collected in Mykonos, Greece, from plant host Biserrula pelecinus), M. loti strains CC829 (commercial inoculant for Lotus pedunculatus and L. ulginosus in Australia, isolated from L. ulginosus nodules in USA; NZP 2012), M. loti SU343 (a commercial inoculant for Lotus comiculatus in Australia; isolated from host nodules in USA). For references see e.g. Soil Biol Biochem (2004) 36(8), 1309-1317; Plant and Soil (2011) 348(1-2), 231-243).

Suitable and commercially available M. loti strains are e.g. M. loti CC829 for Lotus pedunculatus.

The present invention also relates to mixtures wherein the at least one pesticide II is selected from Mesorhizobium huakuii, also referred to as Rhizobium huakuii (see e.g. Appl. Environ. Microbiol. 2011, 77(15), 5513-5516). These mixtures are particularly suitable in Astralagus, e.g. Astalagus sinicus (Chinese milkwetch), Thermopsis, e.g. Thermopsis luinoides (Goldenbanner) and alike.

The present invention also relates to mixtures wherein the at least one pesticide II is selected from Mesorhizobium huakuii and further comprises a pesticide III, wherein pesticide III is selected from jasmonic acid or salts or derivatives thereof including cis-jasmone, preferably methyl-jasmonate or cis-jasmone.

Suitable and commercially available M. huakuii strain is HN3015 which was isolated from Astralagus sinicus in a rice-growing field of Southern China (see e.g. World J. Microbiol. Biotechn. (2007) 23(6), 845-851, ISSN 0959-3993).

The present invention also relates to mixtures, wherein the at least one pesticide II is selected from Azospirillum amazonense, A. brasilense, A. lipoferum, A. irakense and A. halopraeferens, more preferably from A. brasilense, in particular selected from A. brasilense strains BR 11005 (Sp245) and AZ39 which are both commercially used in Brazil and are obtainable from EMBRAPA-Agribiologia, Brazil. These mixtures are particularly suitable in soybean.

The present invention also relates to mixtures wherein the at least one pesticide II is selected from A. amazonense, A. brasilense, A. lipoferum, A. irakense and A. halopraeferens, more preferably A. brasilense, and further comprises a pesticide III, wherein pesticide III is selected from jasmonic acid or salts or derivatives thereof including cis-jasmone, preferably methyl-jasmonate or cis-jasmone.

The present invention also relates to mixtures wherein the at least one pesticide II is selected from Rhizobium leguminosarum bv. phaseolii; R. I. trifolii, especially strain RP113-7 thereof, R. I. bv. viciae, in particular strains SU303, WSM1455 and P1NP3Cst thereof; R. tropici, especially strain SEMIA 4088 thereof; and Sinorhizobium meliloti, especially strain MSDJ0848 thereof. Sinorhizobium meliloti is commercially available from Becker Underwood as product Dormal® Alfalfa & Luzerne. Rhizobium leguminosarum bv. phaseoli is commercially available from Becker Underwood as product Rhizo Stick. These strains are particularly suitable as inoculants for various legumes such as alfalfa, clover, peas, beans, lentils, soybeans, peanuts and others.

The present invention also relates to mixtures wherein the at least one pesticide II is selected from R. leguminosarum bv. phaseolii, R. I. trifolii, R. I. bv. viciae, R. tropici and Sinorhizobium meliloti, and further comprises a pesticide III, wherein pesticide III is selected from jasmonic acid or salts or derivatives thereof including cis-jasmone, preferably methyl-jasmonate or cis-jasmone.

According to a further embodiment, the at least one pesticide II is selected from Delftia acidovorans, in particular strain RAY209, especially in soybean and canola.

According to a further embodiment, the at least one pesticide II is selected from Lysobacter spp., preferably selected from L.antibioticus, in particular strains 13-1 and HS124, preferably in rice or pepper for control of Phytophthora or bacterial leaf blight.

According to a further embodiment, the at least one pesticide II is selected from L. enzymogenes, in particular strain 3.1T8.

According to a further embodiment, the at least one pesticide II is selected from Lysobacter spp., preferably selected from Pseudomonas spp., in particular strain MA 342 and Pseudomonas sp. DSM 13134.

According to a further embodiment, the at least one pesticide II is selected from Penicillium bilaiae.

Preference is also given to mixtures comprise as pesticide II (component 2) a biopesticide from group L6), preferably selected from abscisic acid, aluminium silicate (kaolin), humates, Ascophyllum nodosum (Norwegian kelp, Brown kelp) extract and Ecklonia maxima (kelp) extract.

Preference is also given to mixtures comprise as pesticide II a biopesticide selected from the isoflavones formonennitin, hesperetin and naringenin.

The term “cultivated plants” is to be understood as including plants which have been modified by breeding, mutagenesis or genetic engineering including but not limiting to agricultural biotech products on the market or in development (cf. http://www.bio.org/speeches/pubs/er/egri_products.asp). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e. g. by glycosylation or polymer additions such as prenylated, acetylated or famesylated moieties or PEG moieties.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

Preferably, treatment of plant propagation materials with oligomers according to the invention and agrochemical compositions thereof, respectively, is used for controlling a multitude of fungi on cereals, such as wheat, rye, barley and oats; rice, corn, cotton and soybeans.

Plants that have been modified by breeding, mutagenesis or genetic engineering, e. g. have been rendered tolerant to applications of specific classes of herbicides, such as auxin herbicides such as dicamba or 2,4-D; bleacher herbicides such as hydroxyl-phenylpyruvate dioxygenase (HPPD) inhibitors or phytoene desaturase (PDS) inhibit-tors; acetolactate synthase (ALS) inhibitors such as sulfonyl ureas or imidazolinones; enolpyruvylshikimate-3-phosphate synthase (EPSPS) inhibitors, such as glyphosate; glutamine synthetase (GS) inhibitors such as glufosinate; protoporphyrinogen-IX oxidase inhibitors; lipid biosynthesis inhibitors such as acetyl CoA carboxylase (ACCase) inhibitors; or oxynil (i. e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are e. g. described in Pest Managem. Sci. 61, 2005, 246; 61, 2005, 258; 61, 2005, 277; 61, 2005, 269; 61, 2005, 286; 64, 2008, 326; 64, 2008, 332; Weed Sci. 57, 2009, 108; Austral. J. Agricult. Res. 58, 2007, 708; Science 316, 2007, 1185; and references quoted therein. Several cultivated plants have been rendered tolerant to herbicides by conventional methods of breeding (mutagenesis), e. g. Clearfield® summer rape (Canola, BASF SE, Germany) being tolerant to imidazolinones, e. g. imazamox, or ExpressSun® sunflowers (DuPont, USA) being tolerant to suffonyl ureas, e. g. tribenuron. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.), Cultivance® (imidazolinone tolerant, BASF SE, Germany) and LibertyLink® (glufosinate-tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thunngiensis, such as δ-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, e. g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e. g. WO 02/015701). Further examples of such toxins or genetically modified plants capable of synthesizing such toxins are disclosed, e. g., in EP-A 374 753, WO 93/007278, WO 95/34656, EP-A 427 529, EP-A 451 878, WO 03/18810 und WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e. g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyttransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e. g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme). Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e. g. EP-A 392 225), plant disease resistance genes (e. g. potato cultivars, which express resistance genes acting against Phytophthora infestans derived from the mexican wild potato Solanum bulbocastanum) or T4-lysozym (e. g. potato cultivars capable of synthesizing these proteins with increased resistance against bacteria such as Erwinia amylvora). The methods for producing such genetically modified plants are generally known to the person skilled in the art and are described, e. g. in the publications mentioned above.

Furthermore, plants are also covered that are by the use of recombinant DNA techniques capable to synthesize one or more proteins to increase the productivity (e. g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e. g. oil crops that produce health-promoting long-chain omega-3 fatty acids or unsaturated omega-9 fatty acids (e. g. Nexera® rape, DOW Agro Sciences, Canada).

Furthermore, plants are also covered that contain by the use of recombinant DNA techniques a modified amount of substances of content or new substances of content, specifically to improve raw material production, e. g. potatoes that produce increased amounts of amylopectin (e. g. Amflora® potato, BASF SE, Germany).

One embodiment of the present invention relates to a method for improving plant health comprising applying an effective amount of an oligomer according to the invention and agrochemical compositions thereof to a cultivated plant or its propagation material.

In another aspect the present invention relates to the use of an oligomer formed from a monomer of formula I or mixtures comprising them and agrochemical compositions thereof to a cultivated plant or its propagation material for improving plant health. The term “plant health” is to be understood to denote a condition of the plant and/or its products which is determined by several indicators alone or in combination with each other such as yield (e. g. increased biomass and/or increased content of valuable ingredients), plant vigor (e. g. improved plant growth and/or greener leaves (“greening effect”)), quality (e. g. improved content or composition of certain ingredients) and tolerance to abiotic and/or biotic stress. The above identified indicators for the health condition of a plant may be interdependent or may result from each other.

The oligomers according to the invention or mixtures comprising them are employed as such or in form of compositions by treating the fungi or the plants, plant propagation materials, such as seeds, soil, surfaces, materials or rooms to be protected from fungal attack with a fungicidally effective amount of the active substances. The application can be carried out both before and after the infection of the plants, plant propagation materials, such as seeds, soil, surfaces, materials or rooms by the fungi. Plant propagation materials may be treated with oligomers according to the invention as such or a composition comprising at least one oligomer prophylactically either at or before planting or transplanting.

The invention also relates to agrochemical compositions comprising a solvent or solid carrier and at least one oligomer according to the invention and to their use for controlling harmful fungi.

An “agrochemical composition” comprises a fungicidally effective amount of at least one oligomer according to the invention or binary, ternary or higher mixtures comprising them.

The term “effective amount” denotes an amount of the composition or of the oligomer or mixtures comprising them, which is sufficient for controlling harmful fungi on cultivated plants or in the protection of materials and which does not result in a substantial damage to the treated plants. Such an amount can vary in a broad range and is dependent on various factors, such as the fungal species to be controlled, the treated cultivated plant or material, the climatic conditions and the specific oligomer formed from a monomer of formula I used.

The oligomer according to the invention and their salts or mixtures comprising them can be converted into customary types of agrochemical compositions, e. g. solutions, emulsions, suspensions, dusts, powders, pastes and granules. The composition type depends on the particular intended purpose; in each case, it should ensure a fine and uniform distribution of the compound according to the invention.

Examples for composition types are suspensions (SC, OD, FS), emulsifiable concentrates (EC), emulsions (EW, EO, ES), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the composition types (e. g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 und ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively.

Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e. g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e. g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e. g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Neka® types, BASF, Germany), and fatty acids, alkylsulfonates, alkyl-arylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesufonic acid with phenol and formal-dehyde, polyoxy-ethylene octylphenyl ether, ethoxylated isooctylphenol, octylphenol, nonylphenol, alkylphenyl polyglycol ethers, tributylphenyl polyglycol ether, tristearyl-phenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e. g. methylcellulose), hydrophobically modified starches, polyvinyl alcohols (Mowio® types, Clariant, Switzerland), polycarboxylates (Sokolan® types, BASF, Germany), polyalkoxylates, polyvinyl-amines (Lupasol® types, BASF, Germany), polyvinylpyrrolidone and the copolymers therof.

Examples for thickeners (i. e. compounds that impart a modified flowability to compositions, i. e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R. T. Vanderbilt, U.S.A.) or Attaclay® (Engelhard Corp., NJ, USA).

Bactericides may be added for preservation and stabilization of the composition. Examples for suitable bactericides are those based on dichlorophene and benzyl-alcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e. g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned und the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or conco-mitantly grinding the oligomers according to the invention and, if appropriate, further active substances, with at least one solid carrier.

Granules, e. g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas, and products of vegetable origin, such as cereal meal, tree bark meal, wood meal and nutshell meal, cellulose powders and other solid carriers.

When living microorganisms, such as pesticides II from groups L1), L3) and L5), form part of the compositions, such compositions can be prepared as compositions comprising besides the active ingredients at least one auxiliary (inert ingredient) by usual means (see e.g. H. D. Burges: Formulation of Micobial Biopestcides, Springer, 1998). Suitable customary types of such compositions are suspensions, dusts, powders, pastes, granules, pressings, capsules, and mixtures thereof. Examples for composition types are suspensions (e.g. SC, OD, FS), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). Herein, it has to be taken into account that each formulation type or choice of auxiliary should not influence the viability of the microorganism during storage of the composition and when finally applied to the soil, plant or plant propagation material. Suitable formulations are e.g. mentioned in WO 2008/002371, U.S. Pat. No. 6,955,912, U.S. Pat. No. 5,422,107.

Examples for suitable auxiliaries are those mentioned earlier herein, wherein it must be taken care that choice and amounts of such auxiliaries should not influence the viability of the microbial pesticides in the composition. Especially for bactericides and solvents, compatibility with the respective microorganism of the respective microbial pesticide has to be taken into account. In addition, compositions with microbial pesticides may further contain stabilizers or nutrients and UV protectants. Suitable stabilzers or nutrients are e.g. alpha-tocopherol, trehalose, glutamate, potassium sorbate, various sugars like glucose, sucrose, lactose and maltodextrine (H. D. Burges: Formulation of Micobial Biopestcides, Springer, 1998). Suitable UV protectants are e.g. inorganic compounds like titan dioxide, zinc oxide and iron oxide pigments or organic compounds like benzophenones, benzotriazoles and phenyltriazines. The compositions may in addition to auxiliaries mentioned for compositions comprising oligomers formed from a monomer of formula I herein optionally comprise 0.1-80% stabilizers or nutrients and 0.1-10% UV protectants.

Examples for composition types are:
1. Composition Types for Dilution with Water
i) Water-soluble concentrates (SL, LS)

10 parts by weight of an oligomer formed from a monomer of formula I or mixtures comprising them are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.

ii) Dispersible concentrates (DC)

20 parts by weight of an oligomer formed from a monomer of formula I or mixtures comprising them are dissolved in 70 parts by weight of cyclohexanone with addition of 10 parts by weight of a dispersant, e. g. polyvinylpyrrolidone. Dilution with water gives a dispersion. The active substance content is 20% by weight.

iii) Emulsifiable concentrates (EC)

15 parts by weight of an oligomer formed from a monomer of formula I or mixtures comprising them are dissolved in 75 parts by weight of xylene with addition of calcium dodecylbenzenesuffonate and castor oil ethoxylate (in each case 5 parts by weight). Dilution with water gives an emulsion. The composition has an active substance content of 15% by weight.

### iv) Emulsions (EW, EO, ES)

25 parts by weight of an oligomer formed from a monomer of formula I or mixtures comprising them are dissolved in 35 parts by weight of xylene with addition of calcium dodecylbenzenesuffonate and castor oil ethoxylate (in each case 5 parts by weight).

This mixture is introduced into 30 parts by weight of water by means of an emulsifying machine (Ultraturrax) and made into a homogeneous emulsion. Dilution with water gives an emulsion. The composition has an active substance content of 25% by weight.

### v) Suspensions (SC, OD, FS)

In an agitated ball mill, 20 parts by weight an oligomer formed from a monomer of formula I or mixtures comprising them are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

vi) Water-dispersible granules and water-soluble granules (WG, SG)

50 parts by weight of an oligomer formed from a monomer of formula I or mixtures comprising them are ground finely with addition of 50 parts by weight of dispersants and wetting agents and prepared as water-dispersible or water-soluble granules by means of technical appliances (e. g. extrusion, spray tower, fluidized bed). Dilution with water gives a stable dispersion or solution of the active substance. The composition has an active substance content of 50% by weight.

vii) Water-dispersible powders and water-soluble powders (WP, SP, SS, WS)

75 parts by weight of an oligomer formed from a monomer of formula I or mixtures comprising them are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of an oligomer formed from a monomer of formula I or mixtures comprising them are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

### 2. Composition Types to be Applied Undiluted

ix) Dustable powders (DP, DS)

5 parts by weight an oligomer formed from a monomer of formula I or mixtures comprising them are ground finely and mixed intimately with 95 parts by weight of finely divided kaolin. This gives a dustable composition having an active substance content of 5% by weight.

### x) Granules (GR, FG, GG, MG)

0.5 parts by weight of an oligomer formed from a monomer of formula I or mixtures comprising them is ground finely and associated with 99.5 parts by weight of carriers.

Current methods are extrusion, spray-drying or the fluidized bed. This gives granules to be applied undiluted having an active substance content of 0.5% by weight.

xi) ULV solutions (UL)

10 parts by weight of an oligomer formed from a monomer of formula I or mixtures comprising them are dissolved in 90 parts by weight of an organic solvent, e. g. xylene. This gives a composition to be applied undiluted having an active substance content of 10% by weight.

The agrochemical compositions generally comprise between 0.01 and 95%, preferably between 0.1 and 90%, and in particular between 0.5 and 75%, by weight of active substances. The active substances are employed in a purity of from 90% to 100%, preferably from 95% to 100% (according to NMR spectrum).

Solutions for seed treatmenr (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40%, in the ready-to-use preparations. Application can be carried out before or during sowing. Methods for applying or treating an oligomer formed from a monomer of formula I or mixtures comprising them and compositions thereof, respectively, on to plant propagation material, especially seeds include dressing, coating, pelleting, dusting, soaking and in-furrow application methods of the propagation material. Preferably, an oligomer formed from a monomer of formula I or mixtures comprising them or the compositions thereof, respectively, are applied on to the plant propagation material by a method such that germination is not induced, e. g. by seed dressing, pelleting, coating and dusting.

The mixtures comprising an oligomer formed from a monomer of formula I or mixtures comprising them and at least one biochemical pesticide selected from groups L2), L4) and L6) as defined herein can be prepared as compositions comprising besides the active ingredients at least one inert ingredient (auxiliary) by usual means, e. g. by the means given for the compositions of oligomers formed from a monomer of formula I. Concerning usual ingredients of such compositions reference is made to the explanations given for the compositions containing oligomers formed from a monomer of formula I.

The mixtures comprising cell-free extracts and/or metabolites of microbial pesticides selected from groups L1), L3) and L5) as defined herein can be prepared as compositions comprising besides the active ingredients at least one inert ingredient by usual means, e. g. by the means given for the compositions of oligomers formed from a monomer of formula I. Concerning usual ingredients of such compositions reference is made to the explanations given for the compositions containing oligomers formed from a monomer of formula I.

The mixtures comprising an oligomer formed from a monomer of formula I and cells, spores and/or whole broth culture of at least one microbial pesticide selected from groups L1), L3) and L5) as defined herein can be prepared as compositions comprising besides the active ingredients at least one inert ingredient (auxiliary) by usual means (see e.g. H. D. Burges: Formulation of Micobial Biopestcides, Springer, 1998,), e. g. by the means given for the compositions of oligomers formed from a monomer of formula I. Suitable customary types of such compositions are suspensions, dusts, powders, pastes, granules, pressings, capsules, and mixtures thereof. Examples for composition types are suspensions (e.g. SC, OD, FS), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). Examples for suitable auxiliaries are those mentioned earlier herein, wherein it must be taken care that choice and amounts of such auxiliaries should not influence the viability of the microbial pesticides in the composition. Especially for bactericides and solvents, compatibility with the respective microbial pesticide has to be taken into account. In addition, compositions with microbial pesticides may further contain stabilizers or nutrients and UV protectants. Suitable stabilzers or nutrients are e.g. alpha-tocopherol, trehalose, glutamate, potassium sorbate, various sugars like glucose, sucrose, lactose and maltodextrine (H. D. Burges: Formulation of Micobial Biopestcides, Springer, 1998). Suitable UV protectants are e.g. inorganic compouns like titan dioxide, zinc oxide and iron oxide pigments or organic compounds like benzophenones, benzotriazoles and phenyltriazines. The compositions may in addition to auxiliaries mentioned for compositions comprising oligomers formed from a monomer of formula I herein optionally comprise 0.1-80% stabilizers or nutrients and 0.1-10% UV protectants.[TJ1]

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In the case of microbial pesticides II, the application rates preferably range from about 1×10⁶ to 5×10¹⁵ (or more) CFU/ha. Preferably, the spore concentration is about 1×10⁷ to about 1×10¹¹ CFU/ha. In the case of (entomopathogenic) nematodes as microbial pesticides (e.g. Steinemema feltiae), the application rates preferably range inform about 1×10⁵ to 1×10¹² (or more), more preferably from 1×10⁸ to 1×10¹¹, even more preferably from 5×10⁸ to 1×10¹⁰ individuals (e.g. in the form of eggs, juvenile or any other live stages, preferably in an infetive juvenile stage) per ha.

In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required. In the case of microbial pesticides III selected from groups L1), L3) and L5), the application rates with respect to plant propagation material preferably range from about 1×10⁶ to 1×10¹² (or more) CFU/seed. Preferably, the concentration is about 1×10⁶ to about 1×10¹¹ CFU/seed. In the case of microbial pesticides III selected from groups L1), L3) and L5), the application rates with respect to plant propagation material also preferably range from about 1×107 to 1×10¹⁴ (or more) CFU per 100 kg of seed, preferably from 1×10⁹ to about 1×10¹¹ CFU per 100 kg of seed.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material. Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

In the mixtures and compositions, the compound ratios are advantageously chosen so as to produce a synergistic effect.

The term “synergstic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Netherl. J. Plant Pathol. 70, 1964).

According to the invention, the solid material (dry matter) of the biopesticides (with the exception of oils such as Neem oil, Tagetes oil, etc.) are considered as active components (e.g. to be obtained after drying or evaporation of the extraction medium or the suspension medium in case of liquid formulations of the microbial pesticides). In accordance with the present invention, the weight ratios and percentages used herein for a biological extract such as Quillay extract are based on the total weight of the dry content (solid material) of the respective extract(s).

The total weight ratios of compositions comprising at least one microbial pesticide in the form of viable microbial cells including dormant forms, can be determined using the amount of CFU of the respective microorganism to calculate the total weight of the respective active component with the following equation that 1×10⁹ CFU equals one gram of total weight of the respective active component. Colony forming unit is measure of viable microbial cells, in particular fungal and bacterial cells. In addition, here “CFU” may also be understood as the number of (juvenile) individual nematodes in case of (entomopathogenic) nematode biopesticides, such as Steinemema feltiae. In the binary mixtures and compositions according to the invention, the weight ratio of an oligomer formed from a monomer of formula I or mixtures comprising them and a pesticide II generally depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1, even more preferably in the range of from 1:4 to 4:1 and in particular in the range of from 1:2 to 2:1.

According to further embodiments of the binary mixtures and compositions according to the invention, the weight ratio of an oligomer formed from a monomer of formula I versus a pesticide II usually is in the range of from 1000:1 to 1:1, often in the range of from 100:1 to 1:1, regularly in the range of from 50:1 to 1:1, preferably in the range of from 20:1 to 1:1, more preferably in the range of from 10:1 to 1:1, even more preferably in the range of from 4:1 to 1:1 and in particular in the range of from 2:1 to 1:1.

According to further embodiments of the binary mixtures and compositions according to the invention, the weight ratio of an oligomer formed from a monomer of formula I versus a pesticide II usually is in the range of from 1:1 to 1000, often in the range of from 1:1 to 1:100, regularly in the range of from 1:1 to 1:50, preferably in the range of from 1:1 to 1:20, more preferably in the range of from 1:1 to 1:10, even more preferably in the range of from 1:1 to 1:4 and in particular in the range of from 1:1 to 1:2.

In the ternary mixtures, i.e. compositions according to the invention comprising one oligomer formed from a monomer of formula (component 1) and a pesticide II (component 2) and a pesticide III (component 3), the weight ratio of component 1) and component 2) depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1, and the weight ratio of component 1) and component 3) usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1.

Any further active components are, if desired, added in a ratio of from 20:1 to 1:20 to the oligomer formed from a monomer of formula I.

In the mixtures and compositions, the compound ratios (e. g. oligomer formed from a monomer of formula I/pesticide II/pesticide III ratio) are advantageously chosen so as to produce a synergistic effect.

The fungicidal action of the compositions according to the invention can be shown by the tests described below.

The active compounds, separately or jointly, are prepared as a stock solution comprising 25 mg of active compound which is made up to 10 ml using a mixture of acetone and/or DMSO and the emulsifier Uniperol® EL (wetting agent having an emulsifying and dispersing action based on ethoxylated alkylphenols) in a ratio by volume of solvent/emulsifier of 99:1. The mixture is then made up to 100 ml with water. This stock solution is diluted with the solvent/emulsifier/water mixture described to give the concentration of active compound stated below.

The visually determined percentages of infected leaf areas are converted into efficacies in % of the untreated control.

The efficacy (E) is calculated as follows using Abbot's formula:

E=(1−α/β)100

α corresponds to the fungicidal infection of the treated plants in % and
βcorresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of active compound combinations were determined using Colby's formula (Colby, S. R. “Calculating synergistic and antagonistic responses of herbicide combinations”, Weeds, 15, pp. 20-22, 1967) and compared with the observed efficacies.

E=x+y−x*y/100 Colby's formula
E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b.

### EXAMPLES OF PREPARATION

### Example 1

### Synthesis of tBAEMA Oligomers

Into a 50 mL three neck round bottom flask reactor are charged 0.1549 g (0.1 mMole) of CuBr, 0.075 g (0.02 mMole) of CuBr₂, 0.342 g of tris[2-(dimethylamino)ethyl]amine (Me₆TREN) and 5.50 g of dimethyl sulfoxide (DMSO). The reactor content is mixed and sparged with nitrogen for about 10 minutes. At the same time, 18.28 g (0.1 mole) of t-butylaminoethyl methacrylate (tBAEMA) and 1.93 g (0.01 mole) Ethyl 2-bromoisobutyrate (EBiB) are mixed and sparged with nitrogen in a drop funnel for 10 minutes. The reactant content in the drop funnel is added to the reactor under nitrogen sparging to start polymerization. After polymerization under nitrogen for about 2 hours, the reactor content is precipitated in 300 mL of hexane and stirred overnight. The residual catalysts are removed from bottom DMSO phase and the polymer is recovered from the hexane phase through rotary evaporation. The polymer is re-dissolved in 10 g of DMSO and precipitated in fresh boiling hexane again to further remove residual monomer and catalysts. The polymer was recovered again by rotary evaporation and then dried in a vacuum oven at

50° C. overnight. The purified polymer product is analyzed with gel permeation chromatography (GPC) to have a number average molecular weight (Mₙ) of 2,700 and a weight average molecular weight (M_{w}) of 4,500 using poly(methyl methacrylate) monodisperse molecular weight standards from Polymer Labs. The molecular weight polydispersity index (PDI=M_{w}/Mₙ) is 1.67.

### Comparison Example A

### Preparation of tBAEMA Polymer

Following the procedure described in Example 1 of U.S. Pat. No. 6,096,800 A using azobisisobutyronitrile (AIBN) initiator and tetrahydrofuran (THF) solvent, a tBAEMA homopolymer was prepared and characterized by GPC to have a weight average molecular weight (M_{w}) of 174,000 and a number average molecular weight of 63,000 (polydispersity index M_{w}/Mₙ=2.75).

### Comparison Example B

### Preparation of tBAEMA polymer

Following the same procedure of Comparison Example 1 except double the amount of the THF solvent to lower the initial monomer concentration, a lower molecular weight tBAEMA homopolymer was prepared and characterized by GPC to have a weight average molecular weight (M_{w}) of 91,000 a number average molecular weight of 12,000 (polydispersity index M_{w}/Mₙ=7.40).

### Example 8a

### Preparation of tBAEMA Homopolymers by Conventional Radical Polymerization Process

480 g of tetrahydrofuran (THF) solvent are charged to a 1 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., 120 g of t-butylaminoethyl methacrylate (tBAEMA) monomer (M) and an initiator solution (I) comprising 10 g of AIBN (azobisisobutyronitrile) and 100 g of THF are added to the reactor slowly over about 180 minutes. The reactor is maintained at reflux temperature under nitrogen blanket and agitation during the (I) feed and for additional 3 hours after the feeds. The reactor content is cooled down to room temperature. The reactor content is precipitated in 2 L of heptane. The polymer product is removed by filtration, washed with 500 mL of fresh heptane and dried in a vacuum oven at 50° C. for overnight. The polymer product is analyzed with gel permeation chromatography (GPC) to have a number average molecular weight (Mₙ) of 13,400 g/mole and a weight average molecular weight (M_{w}) of 37,500 g/mole using poly(methyl methacrylate) monodisperse molecular weight standards from Polymer Labs. The molecular weight polydispersity index (PDI=M_{w}/Mₙ) is 2.80

### Example 8b

### Preparation of tBAEMA Homopolymers by Conventional Radical Polymerization Process

480 g of tetrahydrofuran (THF) solvent are charged to a 1 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., 120 g of t-butylaminoethyl methacrylate (tBAEMA) monomer (M) and an initiator solution (I) comprising 6 g of AIBN (azobisisobutyronitrile) and 60 g of THF are added to the reactor slowly over about 60 minutes. The reactor is maintained at reflux temperature under nitrogen blanket and agitation during the (I) feed and for additional 3 hours after the feeds. The reactor content is cooled down to room temperature. The reactor content is precipitated in 2 L of heptane. The polymer product is removed by filtration, washed with 500 mL of fresh heptane and dried in a vacuum oven at 50° C. for overnight. The polymer product is analyzed with gel permeation chromatography (GPC) to have a number average molecular weight (Mₙ) of 4,500 g/mole and a weight average molecular weight (M_{w}) of 11,000 g/mole using poly(methyl methacrylate) monodisperse molecular weight standards from Polymer Labs. The molecular weight polydispersity index (PDI=M_{w}/Mₙ) is 2.47

### Example 8c

### Preparation of tBAEMA Homopolymers by Conventional Radical Polymerization Process

160 g of tetrahydrofuran (THF) solvent and 40 g of t-butylaminoethyl methacrylate (tBAEMA) monomer (M) are charged to a 1 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., an initiator solution (I) comprising 0.4 g of AIBN (azobisisobutyronitrile) and 40 g of THF are added to the reactor slowly over about 60 minutes. The reactor is maintained at reflux temperature under nitrogen blanket and agitation during the (I) feed and for additional 3 hours after the feeds. The reactor content is cooled down to room temperature. The reactor content is precipitated in 1 L of heptane. The polymer product is removed by filtration, washed with 300 mL of fresh heptane and dried in a vacuum oven at 50° C. for overnight. The polymer product is analyzed with gel permeation chromatography (GPC) to have a number average molecular weight (Mₙ) of 54,500 g/mole and a weight average molecular weight (M_{w}) of 135,000 g/mole using poly(methyl methacrylate) monodisperse molecular weight standards from Polymer Labs. The molecular weight polydispersity index (PDI=M_{w}/Mₙ) is 2.62

### Example 10

### Preparation of Low Molecular Weight tBAEMA Homopolymer with Narrow Molecular Weight Distribution by Conventional Radical Polymerization Process

4800 g of tetrahydrofuran (THF) solvent is charged to a 10 L reactor equipped with overhead condenser and agitator. The reactor content with overhead condenser is heated to 65° C. under agitation and nitrogen sparging for 1 hour. After 1 hour nitrogen sparging and the reaction temperature reaches 65° C., 1200 g of t-butylaminoethyl methacrylate (tBAEMA) monomer (M) and an initiator solution (I) comprising 150 g of AIBN (azobisisobutyronitrile) and 1500 g of THF are added to the reactor slowly over about 180 minutes. The reactor is maintained at reflux temperature under nitrogen blanket and agitation during the M and I feeds and for additional 3 hours after the feeds. Monomer conversion is more than 95% after the polymerization reaction. The reactor content is heated to distill out about 5000 g of solvent. Fresh THF solvent (2000 g) is added to the reactor and distillation of solvent out of the reactor is repeated until residual monomer is less than 1%. The reactor content is cooled down to room temperature. The final solution polymer product contains 75% polymer solids. The polymer product is analyzed with gel permeation chromatography (GPC) to have a number average molecular weight (Mₙ) of 2,850 g/mole and a weight average molecular weight (M_{w}) of 6,900 g/mole using poly(methyl methacrylate) monodisperse molecular weight standards from Polymer Labs. The molecular weight polydispersity index (PDI=M_{w}/Mₙ) is 2.42.

### Synergistic Mixtures

### Microtests

The active compounds were formulated separately as a stock solution having a concentration of 10000 ppm in dimethyl sulfoxide.

The product orysastrobin was used as commercial finished formulation and diluted with water to the stated concentration of the active compound.

The stock solutions were mixed according to the ratio, pipetted onto a micro titer plate (MTP) and diluted with water to the stated concentrations. A spore suspension of the respective pathogen in the respective nutrient medium was then added. The plates were placed in a water vapor-saturated chamber at a temperature of 18° C. Using an absorption photometer, the MTPs were measured at 405 nm 7 days after the inoculation.

The measured parameters were compared to the growth of the active compound-free control variant (100%) and the fungus-free and active compound-free blank value to determine the relative growth in % of the pathogens in the respective active compounds. These percentages were converted into efficacies.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

### Use Example 1

### Activity Against the Late Blight Pathogen Phytophthora infestans

A spore suspension of Phytophtora infestans containing a pea juice-based aqueous nutrient medium was used.

### Comparative Examples

A sample of the polymer was prepared following the procedure for example 3 and 3a as disclosed in both, WO02/17724 A1 and WO02/17725 A1.

### Example 3

50 mL of tert-butyl aminoethyl methacrylate (from Aldrich) and 250 mL of ethanol are placed in a three-necked flask and heated under a stream of argon at 75° C. Then, 4 g of azobisisobutyronitrile dissolved in 20 mL of ethyl methyl ketone is slowly added (45 minutes) dropwise under stirring. The mixture is heated to 78° C. and stirred for 6 hours at this temperature. After this time the solvent is removed from the reaction mixture (3A) by distillation. Then the product is dried for 24 hours at 50° C. in vacuum (3B). The molecular weight determination gives a value of 75,000 g/mol.

### Example 3a

The reaction product 3B is mortared and leached for 24 hours with 200 mL of 50° C. warm water. The supernatant is then filtered through a 0.2 micron pore filters providing filtrate 3aA.

2 mL of the solution 3aA are mixed with 20 mL of a suspension of test bacteria Pseudomonas aeruginosa and shaken. After a contact time of 4 hours, 1 mL of the test organism suspension is removed and the number of bacteria in this experimental set-up is determined. After this time, no germs of Pseudomonas aeruginosa are detectable. The oligomers in this solution have a molecular weight of 4,300 g/mol. Samples of polymers and products were taken for analysis as identified in the above description of Example 3 and 3a.

The dried reaction product (3B, 47.5 g) was mortared and subjected to leach in 200 mL of deionized water at 50° C. for 24 hours. The water extraction product was filtered through a 0.2 micron nitrocellulose membrane filter and identified as 3aA. The polymer product after the water leaching process was dried in vacuum at 50° C. overnight to yield 45.39 g of a brittle solid product identified as 3aB. Half of the 3aA solution (100 g) was concentrated in vacuum at 50° C. to give 0.13 g of a brown viscous resin (3aB). It is thus determined that 3aA has a solid content of about 0.13 wt %. The total water-soluble leachable of the polymer product (3B) is about 0.26 g or 0.5 wt %. The reaction products and sample ID for analysis are summarized in Table 1.

TABLE 1
Summary of the reaction products and sample ID for analysis

| Sample ID | Reaction step | yield | | Solids |
|---|---|---|---|---|
| 3A | Final solution product | 325 | mL | ~16% |
| 3B | Solid product after solvent | 47.5 | g | >95% |
| | stripping of 3A | | | |
| 3aA | Leached Water-soluble solution | 200 | mL | ~0.14% |
| | product | | | |
| 3aB | Solid product after stripping | 0.28 | g | >90% |
| | off water from 3aA | | | |
| 3aC | Solid product after water | 43.1 | g | >95% |
| | extraction of 3B | | | |

### Analytical Methods

### GPC Analysis

WO 02/177725 A1 does not specify the method used to determine the reported M, values and does not mention the average M_{w} (e.g., weight average, M_{w}, or number average, Mₙ).

Herein a GPC method developed specific for tBAEMA polymer was used to determine M_{w} and Mₙ distribution or polydispersity index (PDI=M_{w}/Mₙ) for the obtained polymer and oligomer products.

### GPC Instrument Parameters.

Column: (2) PLgel Polypore, 5 um, 300×7.5 mm with PLgel guard, 5 um, 50×7.5 mm

### Detector Refractive Index

Column temperature: ambient
Mobile phase: THF (unstabilized) containing 1% diethanolamine
Elution rate: 1 mL/min
Injection volume: 100 uL
Run time: 30 min

### Standards: EasyCal PMMA PM-1 (PolymerLabs), M_{w} 500 to 2,000,000

### ATR-FTIR Experimental

A Thermo Scientific Nicolet 8700 FT-IR instrument was used to obtain FTIR spectra. The solid samples were placed onto the ATR assembly to measure internal reflectance.

### Charge Titration

A Mutec PCD 03 instrument was used for charge charge density determination. PVSK (polyvinysulfate potassium salt) and pDADMAC (polydiallyldimethylammonium chloride) solutions with known charge strength were used for titration.

### Result and Discussion

Following the water leaching of the obtained solid polymer (3B) as specified by Example 3a of WO 02/17725 A1 (50° C. for 24 hours), a water solution product (3aA) with very low solids (˜0.13%) was obtained. Most solid polymer product (3aC) remained insoluble (>99%). A rough estimation by mass balance gave a water extractable of the tBAEMA homopolymer product of <0.5%. Dry solid product (3aB) was obtained by removal of solvent in vacuum for analysis of the water soluble oligomers in 3aA solution.

Results of the GPC analysis for molecular weights (M_{w}) and M_{w} distribution are summarized in Table 2. The weight average molecular weight M, and polydispersity index (PDI=M_{w}/Mₙ) for the obtained polymer and oligomer products are shown. The GPC using a THF mobile phase containing 1% diethanolamine (DEA) is developed specifically for analyzing tBAEMA polymers containing amino functional groups or cationic polymers. The tBAEMA homopolymer (3B) produced according to Example 3 of WO 02/17725 A1 was determined by GPC to have a high molecular weight (M_{w} about 34,000 g/mol) with a very broad M_{w} distribution indicated by the high value of PDI (M_{w}/Mₙ=7.3). In comparison, example 10 of the ptBAEMA oligomer according to the invention has a Mw of 5,300 and a PDI of 1.3.

TABLE 2
GPC analysis of the TBAEMA homopolymers
and the water-soluble extraction products

| | Reaction step of Example 3 | | |
|---|---|---|---|
| Sample ID | of WO 02/17725 A1 | Mw | Mw/Mn |
| 3A | Final solution product | 35,500 | 7.62 |
| 3B | Solid product after solvent | 34,200 | 7.27 |
| | stripping of 13A | | |
| 3aA | Leached Water-soluble solution | N/A | N/A |
| | product | | |
| 3aB | Solid product after stripping | N/D* | N/D* |
| | off water from 16A | | |
| 3aC | Solid product after water | 36,300 | 7.21 |
| | extraction of 13B | | |
| | Oligomer of present invention | | |
| Example 8b | ptBAEMA prepared as described | 11,000 | 2.47 |
| | herein | | |
| Example 10 | ptBAEMA prepared as described | 6,900 | 2.42 |
| | herein | | |

*No significant quantity of polymer was detected by the GPC for sample 3aB.

The water-soluble extraction product 3aB could not be detected by the GPC (no polymer peak in the GPC chromatogram) and its M, could not be determined by the GPC used for tBAEMA polymers. The 3aB resin either has a M, lower than 500 g/mole (the lower limit of M, standard for GPC calibration) and, supposedly, contains acid or anionic functional groups and is absorbed by the GPC column used for amine polymers. This assumption is confirmed by the high pH value and FTIR data as described below.

The leached water solution containing the described oligomer has a high pH value of 10.7. Mutek charge titration of 3aA solution surprisingly revealed that the claimed oligomer is negatively charged with an initial potential of about −800 mV and the charge density was determined to be about −11.5 meq/g solids. This suggests that a hydrolysis product of tBAEMA homopolymer resulting from the water-leaching at relatively high temperature (50° C.) has been claimed by WO 0217725 A1. For reference, the theoretical potential charge density for poly(methacrylic acid) (PMMA) is about −12 meq/g. The PMAA salt may result from hydrolysis of ptBAEMA.

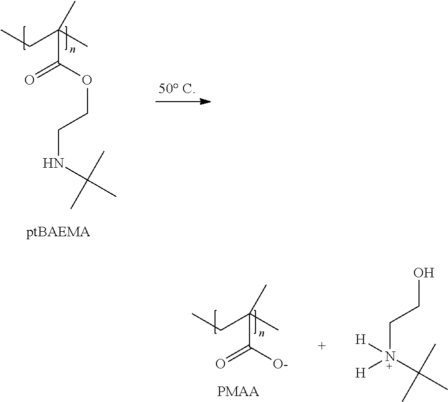

In contrast, the oligmer tBAEMA according to the invention is water-insoluble with a low M, ptBAEMA and is positively charged when solubilized in water by neutralization with an acid. Even without addition of acid for neutralization, a water dispersion of the ptBAEMA oligomer according to the present invention (example 10) is also positively charged (initial potential +150 mV) although the charge density is low (0.3 meg/g). A water dispersion was prepared by first dissolving example ptBAEMA of present invention (example 10) in ethanol to give a 1.9% solution and then adding deionized water (DIW) to obtain an aqueous dispersion of 0.1% ptBAEMA solid. The milky white dispersion is stable at room temperature. Thus the oligomer tBAEMA according to the invention is fundamentally different from the oligomer material of the reference patent WO 0217725 A1 which is likely to be PMAA.

TABLE 3
Properties of leached water-soluble product solution (3aA)

| | | | Initial potential | Charge density, |
|---|---|---|---|---|
| Sample ID | Solids | pH | of the solution | meq/g solids |
| 3aA | 0.13% | 10.7 | −800 mV | −11.6 |
| Example 10* | 0.10% | 7.9 | +150 mV | +0.3 |

*Water dispersion of the pTBAEMA oligomer of the present invention (example 10)

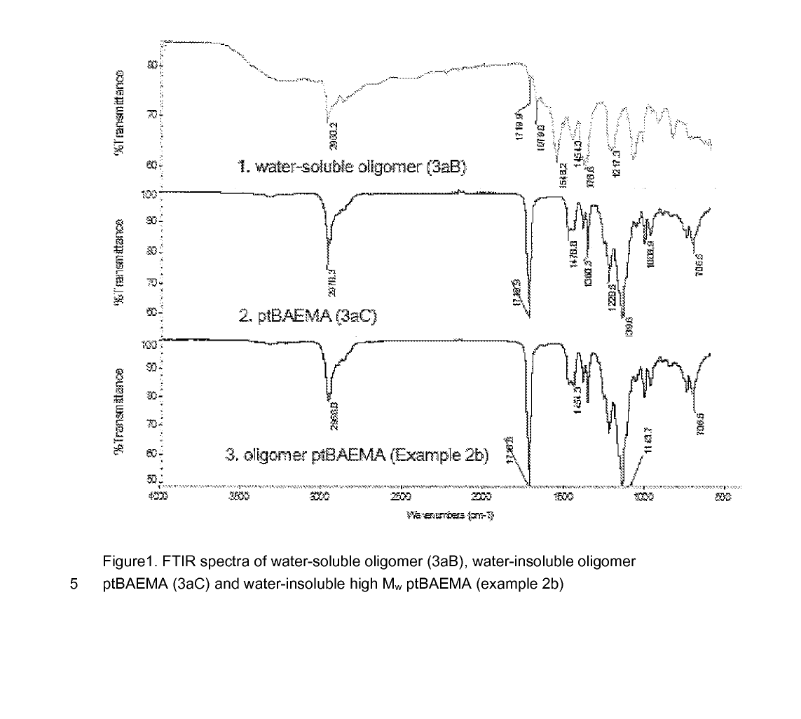

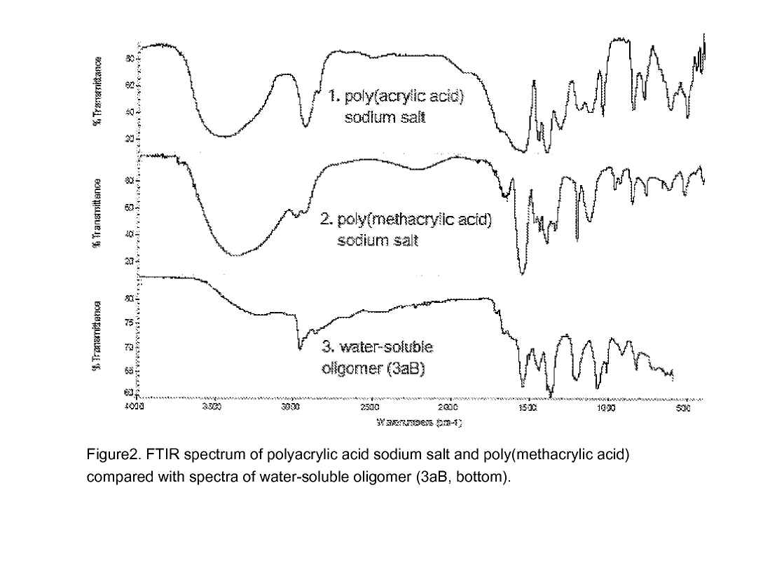

The FTIR spectra further confirm that the water-soluble oligomer described in WO 0217725 A1 is mostly poly(methacrylic acid, PMAA) instead of ptBAEMA. As shown in FIG. 1, the FTIR spectrum of sample 3aB (brown viscous) of the water-soluble oligomer is significantly different from spectra of 3aC (water-insoluble high M, ptBAEMA) of WO 0217725 A1 and example 2b (oligomer ptBAEMA of the present invention). The ester carbonyl stretching band at 1719 cm⁻¹ is diminished and new COO— acid/anionic carbonyl stretching bands at 1679 and 1548 cm⁻¹ appear. The FTIR spectrum of 3aB is in fact quite similar to that of poly(methacrylic acid, sodium salt) as shown in FIG. 2. Both known poly(methacrylic acid) and polyacrylic acid give COO-acid/anionic carbonyl stretching bands at 1680 and 1550 cm⁻¹.

In conclusion, an oligomeric hydrolysis product of essential polymethacrylate resulting from the water extraction of high M_{w} pTBAEMA at relatively high temperature (50° C.) has been described in WO 0217725 A1 rather than oligomers according to the invention. FTIR spectra, charge titration and GPC analysis dearly demonstrate that our inventive water-insoluble oligomers are chemically different from the water-soluble oligomer of the reference patent WO 0217725 A1.

### I. Biological Examples for Fungicidal Activity

### A. Glasshouse Trials

The spray solutions were prepared in several steps:

The stock solution were prepared: a mixture of acetone and/or dimethylsulfoxide and the wetting agent/emulsifier Wettol, which is based on ethoxylated alkylphenoles, in a relation (volume) solvent-emulsifier of 99 to 1 was added to 25 mg of the compound to give a total of 5 ml.
Water was then added to total volume of 100 ml.

This stock solution was diluted with the described solvent-emulsifier-water mixture to the given concentration.

1. Preventative Control of Leaf Blotch on Wheat Caused by Septoria tritici (Septtr P1)

Leaves of pot-grown wheat seedling were sprayed to run-off with an aqueous suspension of the active compound or their mixture, prepared as described. The plants were allowed to air-dry. At the following day the plants were inoculated with an aqueous spore suspension of Septoria tritici. Then the trial plants were immediately transferred to a humid chamber at 18-22° C. and a relative humidity close to 100%. After 4 days the plants were transferred to a chamber with 18-22° C. and a relative humidity close to 70%. After 4 weeks the extent of fungal attack on the leaves was visually assessed as % diseased leaf area.

2. Preventative Control of Leaf Blotch on Wheat Caused by Septoria tritici (Septtr P7)

Leaves of pot-grown wheat seedling were sprayed to run-off with an aqueous suspension of the active compound or their mixture, prepared as described. The plants were allowed to air-dry. Seven days later the plants were inoculated with an aqueous spore suspension of Septoria tritici. Then the trial plants were immediately transferred to a humid chamber at 18-22° C. and a relative humidity close to 100%. After 4 days the plants were transferred to a chamber with 18-22° C. and a relative humidity close to 70%. After 4 weeks the extent of fungal attack on the leaves was visually assessed as % diseased leaf area.

3. Protective Control of Soy Bean Rust on Soy Beans Caused by Phakopsora pachyrhizi (Phakpa P1)

Leaves of pot-grown soy bean seedlings were sprayed to run-off with an aqueous suspension, containing the concentration of active ingredient or their mixture as described below. The plants were allowed to air-dry. The trial plants were cultivated for 1 day in a greenhouse chamber at 23-27° C. and a relative humidity between 60 and 80%. Then the plants were inoculated with spores of Phakopsora pachyrhizi. To ensure the success the artificial inoculation, the plants were transferred to a humid chamber with a relative humidity of about 95% and 20 to 24° C. for 24 h. The trial plants were cultivated for fourteen days in a greenhouse chamber at 23-27° C. and a relative humidity between 60 and 80%. The extent of fungal attack on the leaves was visually assessed as % diseased leaf area.

4. Preventative Control of Brown Rust on Wheat Caused by Puccinia recondita (Puccrt P1)

The first two developed leaves of pot-grown wheat seedling were sprayed to run-off with an aqueous suspension, containing the concentration of active ingredient or their mixture as described below. The next day the plants were inoculated with spores of Puccinia recondita. To ensure the success the artificial inoculation, the plants were transferred to a humid chamber without light and a relative humidity of 95 to 99% and 20 to 24° C. for 24 h. Then the trial plants were cultivated for 6 days in a greenhouse chamber at 20-24° C. and a relative humidity between 65 and 70%. The extent of fungal attack on the leaves was visually assessed as % diseased leaf area.

The results of the biological testing for fungicidal activity of ptBAEMA homooligomers according to the invention are summarized in table 4.

TABLE 4

| | Molecular | | Disease | Disease | Disease | Disease |
|---|---|---|---|---|---|---|
| | weight, M_{w} | | (%) at | (%) at | (%) at | (%) at |
| | (measured | | 500 ppm | 500 ppm | 500 ppm | 500 ppm |
| Compound | by GPC) | PDI | Septtr P1 | Septtr P7 | Phakpa P1 | Puccrt P1 |
| 1 | 135,000 | 3.51 | 80 | 80 | 70 | 80 |
| comparative | | | | | | |
| example | | | | | | |
| 2 | 6,900 | 2.85 | 10 | 10 | 30 | not tested |
| 3 | 11,000 | 2.29 | 15 | 5 | not tested | not tested |
| 4 | 5,000 | 1.31 | 3 | 3 | not tested | not tested |
| 5 | 3,000 | 1.66 | 5 | 5 | 10 | not tested |
| 6 | 7,000 | 2.85 | 7 | 10 | 10 | 40 |
| Untreated | | | 80 | 80 | 90 | 80 |
| control | | | | | | |

### II. Biological Examples for Microbicidal Activity

To determine the efficacy of the oligomers according to the invention against various plant pathogenic microbes, tests were conducted in 96 wells plate using Alamar blue (AB) dye as an indicator for inhibition of spore germination or death. To prepare the plates for the right concentration of oligomer, following steps were taken keeping in mind that the final volume of liquid in each well is 100 μl. Alamar blue (AB), or resazurin, is an oxidation-reduction dye used as an indicator of microbial respiration. In presence of actively growing cells, the dye changes from an oxidized non-fluorescent blue form to a reduced, fluorescent pink form.

Step 1: Fifty micro liters of water was dispensed in each well on the whole plate.
Step 2: Depending on the concentration of oligomers provided (% active w/w in water or ethanol), 4× amount of the product (which would amount to 4000 ppm of oligomers in 100 μl) was dispensed in well A1.
Step 3: Add water in well A1 to bring up the volume to 100 μl.
Step 4: Preform a serial dilution for column 1 going down wards from A1 to B1 all the way to H1 using 50 μl of solution and discarding the last 50 μl form well H1.
Step 5: Add 50 μl on water in all wells in column 1, so that all wells in this column have 100 μl of solution.
Step 6: Using an 8 channel pipette, preform a serial dilution (Left to Right) dispense 50 μl from column 1 to column 2 all the way to column 11 and discard. Note that column 12 is used as a check.
Step 7: Prepare bacterial (10⁷ cfu ml⁻¹) or fungal (10⁵ spores ml⁻¹) suspension using a hemacytometer.
Step 8: Dispense 45 μl of spore suspension in all wells using an 8 channel pipette starting from column 12 to column 1 (Right to Left) from lower concentration to higher concentration to avoid contamination.
Step 9: Add 5 μl of Alamar blue in all wells using an 8 channel pipette starting from column 12 to column 1 (Right to Left) from lower concentration to higher concentration to avoid contamination. The final volume in all plates should be 100 μl. Table 5 shows

TABLE 5
Number in squares indicates final concentration (ppm) of oligomers in wells.

| | 1 | 2 | 3 | 4 | 5 | 6 | 7 | 8 | 9 | 10 | 11 | 12 |
|---|---|---|---|---|---|---|---|---|---|---|---|---|
| A | 1000 | 500 | 250 | 125 | 64 | 32 | 16 | 8 | 4 | 2 | 1 | 0 |
| B | 500 | 250 | 125 | 64 | 32 | 16 | 8 | 4 | 2 | 1 | 0.5 | 0 |
| C | 250 | 125 | 64 | 32 | 16 | 8 | 4 | 2 | 1 | 0.5 | 0.25 | 0 |
| D | 125 | 64 | 32 | 16 | 8 | 4 | 2 | 1 | 0.5 | 0.25 | 0.13 | 0 |
| E | 64 | 32 | 16 | 8 | 4 | 2 | 1 | 0.5 | 0.25 | 0.13 | 0.06 | 0 |
| F | 32 | 16 | 8 | 4 | 2 | 1 | 0.5 | 0.25 | 0.13 | 0.06 | 0.03 | 0 |
| G | 16 | 8 | 4 | 2 | 1 | 0.5 | 0.25 | 0.13 | 0.06 | 0.03 | 0.02 | 0 |
| H | 8 | 4 | 2 | 1 | 0.5 | 0.25 | 0.13 | 0.06 | 0.03 | 0.02 | 0.01 | 0 |

Step 10: Seal the plate with Parafilm™ to prevent evaporation.
Step 11: Place the plates is an incubator (25° C.) for 24 hrs.
Step 12: Observe the plates for color change. Alamar blue plate indicating color change from blue to pink, where blue indicates inhibition of bacterial growth or fungal spore germination.

To determine if the oligomers according to the invention at higher rates inhibit the germination of the fungal spores or bacteria in the wells, the spores can be observed under a microscope and their germination recorded. To further confirm the viability of these fungal spores or bacteria, 5 μl of suspension from the wells can be plated on a PDA (potato dextrose agar) plate and mycelial germination or bacterial colony formation can be observed after 3 to 4 days. For example, germination of Bipolaris maydis spores was observed 3 days later from a 96 well Alamar blue plate, under a microscope and the non-viability of spores at higher oligomer concentrations (>8 ppm) when plated on PDA.

Using the above methodology, a group of organisms, (4 bacterial species) Erwinia amylovora (causal agent of Fire blight in apples), Ralstonia solanacearum (causal agent of tomato blight), Xanthomonas arboricola pv. pruni (causing bacterial spots in peaches), X. euvesicatoria (causing bacterial spots on pepper), (2 fungi) Bipolaris maydis (causing Southern leaf blight in corn), Botrytis cineria (Grey mold of strawberries), and (1 yeast) Sacchammyces spp. (sour rot complex) were tested for their activity against ptBAEMA homooligomers samples of varying molecular weights.

The inhibition of the spore activity at various ppm is reported in Table 6.

TABLE 6

| | Molecular | | Inhibition Range (ppm) | | | | | | |
|---|---|---|---|---|---|---|---|---|---|
| | weight, M_{w} | | | | Xanthomonas | | | | |
| | (measured | | Ralstonia | Erwinia | arboricola | Xanthomonas | Bipolaris | Saccharomyces | Botrytis |
| Compound | by GPC) | PDI | solanacearum | amylovora | pv. pruni | euvesicatoria | maydis | spp. | cinerea |
| 7 | 2.5K | 2.6 | 1 | 1-2 | 2 | 1-4 | 8-16 | 2-4 | 8-16 |
| 8 | 6K | 2.3 | 1-2 | 2-4 | 1-4 | 1-2 | 16 | 4 | 32 |
| 9 | 9K | 2.4 | 2 | 4 | 4 | 2-4 | 16-32 | 4 | 32 |
| 10 | 11K | 2.3 | 2 | 4-8 | 2-4 | 2-4 | 16 | 4-8 | 16-32 |
| 11 | 17K | 2.8 | 2 | 4-8 | 2-4 | 2-4 | 32 | 8-16 | 16-32 |
| 12 | 22K | 2.8 | 2-4 | 4-8 | 2-4 | 4-8 | 64 | 8 | 32 |
| 13 | 31K | 2.7 | 2-8 | 4 | 4 | 8 | 32-64 | 8 | 16-64 |
| 14 | 60K | 2.6 | 4 | 4-8 | 4 | 8-16 | 64 | 16-32 | 32-64 |
| 15 | 300K | 5.2 | 8 | 4-8 | 4-8 | 8 | 125 | 32-64 | 64 |

1-13. (canceled)

14. A method for combating phytopathogenic harmful microbes on cultivated plants or plant propagation material comprising applying an oligomer formed from a monomer of formula I 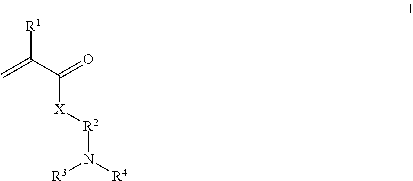
wherein
R¹ is H or CH₃,
R² is a divalent C₁-C₅-alkylene group,
X is a divalent radical of —O—, —NH— or —NR⁵, wherein R⁵ is C₁-C₆-alkyl,
R³ and R⁴ independently of each other are H or C₁-C₅-alkyl radical which can be linear or branched,
or its agrochemically acceptable salts, wherein the oligomer has a weight average molecular weight of 400 to 20,000 g/mole and a number average molecular weight from 400 to 10,000 g/mole, molecular weights being determined according to gel permeation chromatography (GPC) calibrated with poly methyl methacrylate narrow molecular weight standards, characterized in that the oligomers have a molecular weight polydispersity index of 1.0 to 3.0.

15. A method according to claim 14, wherein the oligomer has a weight average molecular weight of 400 to 15,000 g/mole and a number average molecular weight ranging from 400 to 15,000 g/mole.

16. A method according to claim 14, wherein the oligomer of formula I has a polydispersity index of 1.0 to 2.0.

17. The method according to claim 14 wherein the oligomer, or its agrochemically acceptable salt, is in an agrochemical composition which further comprises an auxiliary.

18. A method for the suppression of biological infestation in harvested produce comprising applying an oligomer formed from a monomer of formula I 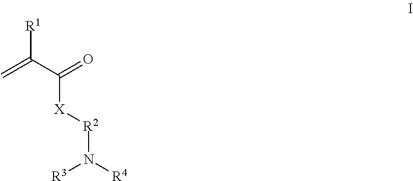
wherein
R¹ is H or CH₃,
R² is a divalent C₁-C₅-alkylene group,
X is a divalent radical of —O—, —NH— or —NR⁵, wherein R⁵ is C₁-C₆-alkyl,
R³ and R⁴ independently of each other are H or C₁-C₅-alkyl radical which can be linear or branched,
or its agrochemically acceptable salts, wherein the oligomer has a weight average molecular weight of 400 to 20,000 g/mole and a number average molecular weight from 400 to 10,000 g/mole, molecular weights being determined according to gel permeation chromatography (GPC) calibrated with poly methyl methacrylate narrow molecular weight standards, characterized in that the oligomers have a molecular weight polydispersity index of 1.0 to 3.0.

19. A mixture comprising, as active components,
1) an oligomer formed from a monomer of formula I 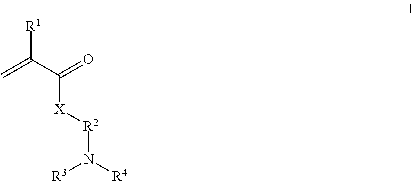
wherein
R¹ is H or CH₃,
R² is a divalent C₁-C₅-alkylene group,
X is a divalent radical of —O—, —NH— or —NR⁵, wherein R⁵ is C₁-C₆-alkyl,
R³ and R¹ independently of each other are H or C₁-C₅-alkyl radical which can be linear or branched,
or its agrochemically acceptable salts, wherein the oligomer has a weight average molecular weight (M_{w}) of 400 to 20,000 g/mole and a number average molecular weight (Mₙ) from 400 to 10,000 g/mole (determined according to GPC calibrated with poly methyl methacrylate narrow molecular weight standards), characterized in that the oligomers have a molecular weight polydispersity index of 1.0 to 3.0;
and
2) at least one pesticide II selected from the groups A) to O):
A) Respiration inhibitors
Inhibitors of complex III at Qₒ site (e.g. strobilurins): azoxystrobin, coumethoxy-strobin, coumoxystrobin, dimoxystrobin, enestroburin, fenaminstrobin, fenoxy-strobin/flufenoxystrobin, fluoxastrobin, kresoxim-methyl, mandestrobine, metominostrobin, orysastrobin, picoxystrobin, pyraclostrobin, pyrametostrobin, pyraoxystrobin, trifloxystrobin and 2-(2-(3-(2,6-dichlorophenyl)-1-methyl-allylideneaminooxmethyl)-phenyl)-2-methoxyimino-N-methyl-acetamide, pyribencarb, triclopyricarb/chlorodincarb, famoxadone, fenamidone;
inhibitors of complex III at Qᵢ site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl]2-methylpropanoate, [(3 S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl]2-methylpropanoate; (3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate
inhibitors of complex II (e. g. carboxamides): benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 1,3,5-trimethyl-N-(1,1,3-trimethylindan-4-yl)pyrazole-4-carboxamide, N-(7-fluoro-1,1,3-trimethyl-indan-4-yl)-1,3-dimethyl-pyrazole-4-carboxamide, N-[2-(2,4-dichlorophenyl)-2-methoxy-1-methyl-ethyl]-3-(difluoromethyl)-1-methyl-pyrazole-4-carboxamide;
other respiration inhibitors (e.g. complex I, uncouplers): diflumetorim, (5,8-difluoro-quinazolin-4-yl)-{2-[2-fluoro-4-(4-trifluoromethylpyridin-2-yloxy)-phenyl]-ethyl}-amine; nitrophenyl derivates: binapacryl, dinobuton, dinocap, fluazinam; ferimzone; organometal compounds: fentin salts, such as fentin-acetate, fentin chloride or fentin hydroxide; ametoctradin; and silthiofam;
B) Sterol biosynthesis inhibitors (SBI fungicides)
C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-[rel-(2S;3R)-3-(2-chlorophenyl)-2-(2,4-difluorophenyl)-oxiranylmethyl]-5-thiocyanato-1H-[1,2,4]triazole, 2-[rel-(2S;3R)-3-(2-chlorophenyl)-2-(2,4-difluorophenyl)-oxiranylmethyl]-2H-[1,2,4]triazole-3-thiol, 2-[2-chloro-4-(4-chlorophenoxy)phenyl]-1-(1,2,4-triazol-1-yl)pentan-2-ol, 1-[4-(4-chlorophenoxy)-2-(trifluoromethyl)phenyl]-1-cyclopropyl-2-(1,2,4-triazol-1-yl)ethanol, 2-[4-(4-chlorophenoxy)-2-(trifluoromethyl)phenyl]-1-(1,2,4-triazol-1-yl)butan-2-ol, 2-[2-chloro-4-(4-chlorophenoxy)phenyl]-1-(1,2,4-triazol-1-yl)butan-2-ol, 2-[4-(4-chlorophenoxy)-2-(trifluoromethyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)propan-2-ol, 2-[2-chloro-4-(4-chlorophenoxy)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)pentan-2-ol, 2-[4-(4-fluorophenoxy)-2-(trifluoromethyl)phnyl]-1-(1,2,4-triazol-1-yl)propan-2-ol; imidazoles: imazalil, pefurazoate, prochloraz, triflumizol; pyrimidines, pyridines and piperazines: fenarimol, nuarimol, pyrifenox, triforine, [3-(4-chloro-2-fluoro-phenyl)-5-(2,4-difluorophenyl)isoxazol-4-yl]-(3-pyridyl)methanol;
Delta 14-reductase inhibitors: aldimorph, dodemorph, dodemorph-acetate, fenpropimorph, tridemorph, fenpropidin, piperalin, spiroxamine;
Inhibitors of 3-keto reductase: fenhexamid;
C) Nucleic acid synthesis inhibitors
phenylamides or acyl amino acid fungicides: benalaxyl, benalaxyl-M, kiralaxyl, metalaxyl, metalaxyl-M (mefenoxam), ofurace, oxadixyl;
others: hymexazole, octhilinone, oxolinic acid, bupirimate, 5-fluorocytosine, 5-fluoro-2-(p-tolylmethoxy)pyrimidin-4-amine, 5-fluoro-2-(4-fluorophenylmethoxy)pyrimidin-4-amine;
D) Inhibitors of cell division and cytoskeleton
tubulin inhibitors, such as benzimidazoles, thiophanates: benomyl, carbendazim, fuberidazole, thiabendazole, thiophanate-methyl; triazolopyrimidines: 5-chloro-7-(4-methyl-piperidin-1-yl)-6-(2,4,6-trifluorophenyl)-[1,2,4]triazolo[1,5-a]pyrimidine
other cell division inhibitors: diethofencarb, ethaboxam, pencycuron, fluopicolide, zoxamide, metrafenone, pyriofenone;
E) Inhibitors of amino acid and protein synthesis
methionine synthesis inhibitors (anilino-pyrimidines): cyprodinil, mepanipyrim, pyrimethanil;
protein synthesis inhibitors: blasticidin-S, kasugamycin, kasugamycin hydrochloride-hydrate, mildiomycin, streptomycin, oxytetracyclin, polyoxine, validamycin A;
F) Signal transduction inhibitors
MAP/histidine kinase inhibitors: fluoroimid, iprodione, procymidone, vinclozolin, fenpiclonil, fludioxonil;
G protein inhibitors: quinoxyfen;
G) Lipid and membrane synthesis inhibitors
Phospholipid biosynthesis inhibitors: edifenphos, iprobenfos, pyrazophos, isoprothiolane;
lipid peroxidation: dicloran, quintozene, tecnazene, tolclofos-methyl, biphenyl, chloroneb, etridiazole;
phospholipid biosynthesis and cell wall deposition: dimethomorph, flumorph, mandipropamid, pyrimorph, benthiavalicarb, iprovalicarb, valifenalate and N-(1-(1-(4-cyano-phenyl)ethanesulfonyl)-but-2-yl) carbamic acid-(4-fluorophenyl) ester,
compounds affecting cell membrane permeability and fatty acids: propamocarb, propamocarb-hydrochlorid
fatty acid amide hydrolase inhibitors: oxathiapiprolin;
H) Inhibitors with Multi Site Action
inorganic active substances: Bordeaux mixture, copper acetate, copper hydroxide, copper oxychloride, basic copper sulfate, sulfur;
thio- and dithiocarbamates: ferbam, mancozeb, maneb, metam, metiram, propineb, thiram, zineb, ziram;
organochlorine compounds (e.g. phthalimides, sulfamides, chloronitriles): anilazine, chlorothalonil, captafol, captan, folpet, dichlofluanid, dichlorophen, hexachlorobenzene, pentachlorphenole and its salts, phthalide, tolylfluanid, N-(4-chloro-2-nitro-phenyl)-N-ethyl-4-methyl-benzenesulfonamide;
guanidines and others: guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]dithiino[2,3-c:5,6-c′]dipyrrole-1,3,5,7(2H,6H)-tetraone;
I) Cell wall synthesis inhibitors
inhibitors of glucan synthesis: validamycin, polyoxin B; melanin synthesis inhibitors: pyroquilon, tricyclazole, carpropamid, dicyclomet, fenoxanil;
J) Plant defence inducers
acibenzolar-S-methyl, probenazole, isotianil, tiadinil, prohexadione-calcium; phosphonates: fosetyl, fosetyl-aluminum, phosphorous acid and its salts;
K) Unknown mode of action
bronopol, chinomethionat, cyflufenanmid, cymoxanil, dazomet, debacarb, diclomezine, difenzoquat, difenzoquat-methylsulfate, diphenylamln, fenpyrazamine, flumetover, flusulfamnide, flutianil, methasulfocarb, nitrapyrin, nitrothal-isopropyl, oxathiapiprolin, tolprocarb, 2-[3,5-bis(difluoromethyl)-1H-pyrazol-1-yl]-1-[4-(4-(5-[2-(prop-2-yn-1-yloxy)phenyl]-4,5-dihydro-1,2-oxazol-3-yl)-1,3-thiazol-2-yl)piperidin-1-yl]ethanone, 2-[3,5-bis(difluoromethyl)-11H-pyrazol-1-yl]-1-[4-(4-(5-[2-fluoro-6-(prop-2-yn-1-yl-oxy)phenyl]-4,5-dihydro-1,2-oxazol-3-yl)-1,3-thiazol-2-yl)piperidin-1-yl]ethanone, 2-[3,5-bis(difluoromethyl)-11H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-prop-oxy)-phenyl)-N-ethyl-N-methyl formamidine, N′-(S-difluoromethyl-2-methyl-4-(3-tri-methylsilanyl-propoxy)-phenyl)-N-ethyl-N-methyl formamidine, methoxy-acetic acid 6-tert-butyl-&-fluoro-2,3-dimethyl-quinolin-4-yl ester, 3-[5-(4-methylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole),
N-(6-methoxy-pyridin-3-yl) cyclopropanecarboxylic acid amide, 5-chloro-1-(4,6-di-methoxy-pyrimidin-2-yl)-2-methyl-1H-benzoimidazole, 2-(4-chloro-phenyl)-N-[4-(3,4 dimethoxy-phenyl)-isoxazol-5-yl]-2-prop-2-ynyloxy-acetamide, ethyl (Z)-3-amino-2-cyano-3-phenyl-prop-2-enoate, tert-butyl N-[6-[[(Z)-[(1-methyltetrazol-5-yl)-phenyl-methylene]amino]oxymethyl]-2-pyridyl]carbamate, pentyl N-[6-[[(Z)-[(1-methyltetrazol-5-yl)-phenyl-methylene]amino]oxymethyl]-2-pyridyl]carbamate, 2-[2-[(7,8-difluoro-2-methyl-3-quinolyl)oxy]-6-fluoro-phenyl]propan-2-ol, 2-[2-fluoro-6-[(S-fluoro-2-methyl-3-quinolyl)oxy]phenyl]propan-2-ol, 3-(5-fluoro-3,3,4,4-tetramethyl-3,4-dihydroisoquinolin-1-yl)quinoline, 3-(4,4-difluoro-3,3-dimethyl-3,4-dihydroisoquinolin-1-yl)quinoline, 3-(4,4,5-trifluoro-3,3-dimethyl-3,4-dihydroisoquinolin-1-yl)quinoline;
L) Biopesticides
L1) Microbial pesticides with fungicidal, bactericidal, viricidal and/or plant defense activator activity: Ampelomyces quisqualis, Aspergillus flavus, Aureobasidium pullulans, Bacillus amyloliquefaciens, B. mojavensis, B. pumilus, B. simplex, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus polymyxa, Pantoea vagans, Phlebiopsis gigantea, Pseudomonas sp., Pseudomonas chloraphis, Pseudozyma flocculosa, Pichia anomala, Pythium oligandrum, Sphaerodes mycoparasitica, Streptomyces griseoviridis, S. lydicus, S. violaceusniger, Talaromyces flavus, Trichoderma asperellum, T. atroviride, T. fertile, T. gamsii, T. harmatum; mixture of T. harzianum and T. viride; mixture of T. polysporum and T. harzianum; T. stromaticum, T. virens (also named Gliocladium virens), T. viride, Typhula phacorrhiza, Ulocladium oudemansii, Verticillium dahlia, zucchini yellow mosaic virus (avirulent strain);
L2) Biochemical pesticides with fungicidal, bactericidal, viricidal and/or plant defense activator activity: chitosan (hydrolysate), harpin protein, laminarin, Menhaden fish oil, natamycin, Plum pox virus coat protein, potassium or sodium bicarbonate, Reynoutria sachlinensis extract, salicylic acid, tea tree oil;
L3) Microbial pesticides with insecticidal, acaricidal, molluscidal and/or nematicidal activity: Agrobacterium radiobacter, Bacillus cereus, B. firmus, B. thuringiensis, B. thuringiensis ssp. aizawai, B. t. ssp. israelensis, B. t. ssp. galleriac, B. t. ssp. kurstaki, B. t. ssp. tenebrionis, Beauveria bassiana, B. brongniartii, Burkholderia sp., Chromobacterium subtsugae, Cydia pomonella granulosis virus, Cryptophlebia leucotreta granulovirus (CrIeGV), Isaria fumosorosea, Heterorhabditis bacteriophora, Lecanicillium longisporum, L. muscarium (formerly Verticillium lecanii), Metarhizium anisopliae, M. anisopliac var. acridum, Nomuraea rileyi, Paecilomyces fumosoroseus, P. lilacinus, Pacnibacillus popilliac, Pasteuria spp., P. nishizawae, P. penetrans, P. ramose, P. reneformis, P. thornea, P. usgae, Pseudomonas fluorescens, Steinernema carpocapsae, S. feltiae, S. kraussei;
L4) Biochemical pesticides with insecticidal, acaricidal, molluscidal, pheromone and/or nematicidal activity: L-carvone, citral, (E,Z)-7,9-dodecadien-1-yl acetate, ethyl formate, (E,Z)-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,Z)-2,13-octadecadien-1-ol, (E,Z)-2,13-octadecadien-1-ol acetate, (E,Z)-3,13-octadecadien-1-ol, R-1-octen-3-ol, pentatermanone, potassium silicate, sorbitol actanoate, (E,Z,Z)-3,8,11-tetradecatrienyl acetate, (Z,E)-9,12-tetradecadien-1-yl acetate, Z-7-tetradecen-2-one, Z-9-tetradecen-1-yl acetate, Z-1 l-tetradecenal, Z-1 l-tetradecen-1-ol, Acacia negra extract, extract of grapefruit seeds and pulp, extract of Chenopodium ambrosiodae, Catnip oil, Neem oil, Quillay extract, Tagetes oil;
L5) Microbial pesticides with plant stress reducing, plant growth regulator, plant growth promoting and/or yield enhancing activity: Azospirillum amazonense A. brasilense, A. lipoferum, A. irakense, A. halopraeferens, Bradyrhizobium sp., B. elkanii, B. japonicum, B. liaoningense, B. lupini, Delftia acidovorans, Glomus intraradices, Mesorhizobium sp., Paenibacillus alvei, Penicillium bilaiae, Rhizobium leguminosarum bv. phaseolii, R. I. trifolii, R. I. bv. viciae, R. tropici, Simorhizobium melilot:
L6) Biochemical pesticides with plant stress reducing, plant growth regulator and/or plant yield enhancing activity: abscisic acid, aluminium silicate (kaolin), 3-decen-2-one, formononetin, genistein, hesperetin, homobrassinlide, humates, jasmonic acid or salts or derivatives thereof, lysophosphatidyl ethanolamine, naringenin, polymeric polyhydroxy acid, Ascophyllum nodosum (Norwegian kelp, Brown kelp) extract and Ecklonia maxima (kelp) extract;
M) Growth regulators
abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole;
N) Herbicides
acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
amino acid derivatives: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
Bipyridyls: diquat, paraquat;
(thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bomoxynil, dichlobenil, ioxynil;
imidazolinones: imazamethabcnz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
triazines: ametryn, atrazine, cyanazine, dimethametryn, ethiozin, hexazinone, metamitron, metribuzin, prometryn, simazine, terbuthylazine, terbutryn, triaziflam;
ureas: chlorotoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalid, pyriminobac-methyl, pyrimisulfan, pyrithiobac, pyroxasulfone, pyroxsulam;
others: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamonc, indanofan, isoxaben, isoxaflutole, lenacil, propanil, propyzamide, quinclorac, quinmerac, mesotrione, methyl arsonic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-3,6-dihydro-2H-pyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methyl-phenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.
O) Insecticides
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypennmethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c)juvenoids: pyriproxyfen, methoprene, fenoxycarb; d) lipid biosynthesis inhibitors: spirodiclofen, spiromesifen, spirotetramat;
nicotinic receptor agonists/antagonists compounds: clothianidin, dinotefuran, flupyradifurone, imidacloprid, thiamethoxam, nitenpyram, acetamiprid, thiacloprid, 1-2-chloro-thiazol-5-ylmethyl)-2-nitrimino-3,5-dimethyl-[1,3,5]triazinane;
GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioic acid amide;
macrocyclic lactone insecticides: abamectin, emamectin, milbemectin, lepimectin, spinosad, spinetoram;
mitochondrial electron transport inhibitor (METI) I acaricides: fenazaquin, pyridaben, tebufenpyrad, tolfenpyrad, flufenerim;
METI II and III compounds: acequinocyl, fluacyprim, hydramethylnon;
Uncouplers: chlorfenapyr,
oxidative phosphorylation inhibitors: cyhexatin, diafenthiuron, fenbutatin oxide, propargite;
moulting disruptor compounds: cryomazine;
mixed function oxidase inhibitors: piperonyl butoxide;
sodium channel blockers: indoxacarb, metaflumizone;
ryanodine receptor inhibitors: chlorantraniliprole, cyantraniliprole, flubendiamide, N-[4,6-dichloro-2-[(diethyl-lambda-4-sulfanylidene)carbamoyl]-phenyl]-2-(3-chloro-2-pyridyl)-5-(trifluoromethyl)pyrazole-3-carboxamide; N-[4-chloro-2-[(diethyl-lambda-4-sulfanylidene)carbamoyl]-6-methyl-phenyl]-2-(3-chloro-2-pyridyl)-5-(triflu-oromethyl)pyrazole-3-carboxamide; N-[4-chloro-2-[(di-2-propyl-lambda-4-sulfanyli-dene)carbamoyl]-6-methyl-phenyl]-2-(3-chloro-2-pyridyl)-5-(trifluoromethyl)pyrazole-3-carboxamide; N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-arboxamide; N-[4,6-dichloro-2-[(diethyl-lambda-4-sulfanylidene)carbamoyl]-phenyl]-2-(3-chloro-2-pyridyl)-5-(difluoromethyl)pyrazole-3-carboxamide; N-[4,6-dibromo-2-[(di-2-propyl-lambda-4-sulfanylidene)carbamoyl]-phenyl]-2-(3-chloro-2-pyridyl)-5-(trifluoromethyl)pyrazole-3-carboxamide; N-[4-chloro-2-[(di-2-propyl-lambda-4-sulfanylidene)carbamoyl]-6-cyano-phenyl]-2-(3-chloro-2-pyridyl)-5-(trifluoromethyl)pyrazole-3-carboxamide; N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide;
others: benclothiaz, bifenazate, cartap, flonicamid, pyridalyl, pymetrozine, sulfur, thiocyclam, cyenopyrafen, flupyrazofos, cyflumetofen, amidoflumet, imicyafos, bistrifluron, pyrifluquinazon and 1,1′-[(3S,4R,4aR,6S,6aS,12R, 12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]cyclopropaneacetic acid ester.

20. A mixture according to claim 19, comprising in addition a further pesticide III selected from the groups A) to O) as defined in claim 7.

21. A mixture according to claim 19, comprising an oligomer formed from a monomer of formula I and at least one pesticide II in a weight ratio of from 100:1 to 1:100, and wherein the weight ratio of the oligomer formed from a monomer of formula I and pesticide III is in the range of from 1:100 to 100:1.

22. An agrochemical composition, comprising a solvent or solid carrier and a mixture according to claim 19.

23. The composition according to claim 22 further comprising seed in an amount of from 1 g to 1000 g active components per 100 kg of seed.

24. A method for controlling phytopathogenic harmful fungi, comprising treating the fungi, their habitat or the seed, the soil or the plants to be protected against fungal attack with an effective amount of the mixture of claim 20.

25. The method according to claim 24, wherein the mixture comprises an oligomer formed from a monomer of formula I and at least one pesticide II in a weight ratio of from 100:1 to 1:100, and wherein the weight ratio of the oligomer formed from a monomer of formula I and pesticide III is in the range of from 1:100 to 100:1.

26. A method according to claim 24, wherein the oligomer has a weight average molecular weight of 400 to 15,000 g/mole and a number average molecular weight ranging from 400 to 15,000 g/mole.

27. A method according to claim 24, wherein the oligomer of formula I has a polydispersity index of 1.0 to 2.0.
